(19) United States
(12) Patent Application Publication
(10) Pub. No.: US 2023/0189355 A1
(43) Pub. Date: Jun. 15, 2023

(54) POWER HEADROOM REPORTING FOR SIDELINK COMMUNICATIONS

(71) Applicant: QUALCOMM INCORPORATED, San Diego, CA (US)

(72) Inventors: Jelena DAMNJANOVIC, Del Mar, CA (US); Tao LUO, San Diego, CA (US); Juan MONTOJO, San Diego, CA (US); Junyi LI, Fairless Hills, PA (US); Fang YUAN, Beijing (CN); Yan ZHOU, San Diego, CA (US); Aleksandar DAMNJANOVIC, Del Mar, CA (US)

(21) Appl. No.: 17/914,715

(22) PCT Filed: May 20, 2021
(86) PCT No.: PCT/CN2021/094815

§ 371 Date: Sep. 26, 2022

(30) Foreign Application Priority Data
May 20, 2020 (WO) PCT/CN2020/091285
May 20, 2020 (WO) PCT/CN2020/091286

(51) Int. Cl. H04W 76/10; H04W 52/36; H04W 76/20

(52) U.S. Cl. CPC H04W 76/10; H04W 52/365; H04W 76/20

(57) ABSTRACT

Methods, systems, and devices for wireless communications are described. A first user equipment (UE), which may be a relay device, may establish a sidelink communication link for communications between a base station and a second UE via the first UE. The first UE may receive control signaling from the base station indicating a configuration for transmitting a power headroom report for transmissions scheduled over the sidelink communication link. The first UE may determine a power headroom associated with transmissions from the first UE to the second UE, which may be based on a transmission power capability of the first UE, and the first UE may transmit a power headroom report to the base station. The base station may schedule communications with the second UE based on the received power headroom report from the first UE.

### CROSS REFERENCE

The present Application is a 371 national stage filing of International PCT Application No. PCT/CN2021/094815 by DAMNJANOVIC et al. entitled “POWER HEADROOM REPORTING FOR SIDELINK COMMUNICATIONS,” filed May 20, 2021; and claims priority to International Patent Application No. PCT/CN2020/091285 by DAMNJANOVIC et al. entitled “RELAY UE POWER HEADROOM REPORTING FOR SIDE LINK,” filed May 20, 2020, and International Patent Application No. PCT/CN2020/091286 by DAMNJANOVIC et al., entitled “POWER HEADROOM REPORTING FOR SIDELINK COMMUNICATIONS,” filed May 20, 2020, each of which is assigned to the assignee hereof, and each of which is hereby incorporated by reference in its entirety.

### BACKGROUND

The following relates to wireless communications and more specifically to techniques for power headroom reporting.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

A method for wireless communication is described. The method may include establishing, at a first UE, a communication link with a base station via a sidelink between the first UE and a second UE and conveying, to the base station, a power headroom report for the sidelink between the first UE and the second UE. In some examples, the power headroom report may be based on a power headroom associated with transmissions from the first UE to the second UE (e.g., using the sidelink between the first UE and the second UE). In some examples, the power headroom may be based on a transmission power capability of the first UE.

An apparatus for wireless communication is described. The apparatus may include a processor and memory coupled with the processor. The processor and memory may be configured to establish (e.g., at a first UE), a communication link with a base station via a sidelink with a UE (e.g., a sidelink between the first UE and the second UE) and convey, to the base station, a power headroom report for the sidelink. In some examples, the power headroom report may be based on a power headroom associated with transmissions from the first UE to the second UE (e.g., using the sidelink between the first UE and the second UE). In some examples, the power headroom may be based on a transmission power capability of the first UE.

Another apparatus for wireless communication is described. The apparatus may include means for establishing, at a first UE, a communication link with a base station via a sidelink between the first UE and a second UE and means for conveying, to the base station, a power headroom report for the sidelink between the first UE and the second UE. In some examples, the power headroom report may be based on a power headroom associated with transmissions from the first UE to the second UE (e.g., using the sidelink between the first UE and the second UE). In some examples, the power headroom may be based on a transmission power capability of the first UE.

A non-transitory computer-readable medium storing code for wireless communication is described. The code may include instructions executable by a processor to establish, at a first UE, a communication link with a base station via a sidelink between the first UE and a second UE and convey, to the base station, a power headroom report for the sidelink between the first UE and the second UE. In some examples, the power headroom report may be based on a power headroom associated with transmissions from the first UE to the second UE (e.g., using the sidelink between the first UE and the second UE). In some examples, the power headroom may be based on a transmission power capability of the first UE.

Some examples of the method, apparatuses, and non-transitory computer-readable medium described herein may further include operations, features, means, or instructions for establishing a direct communication link with the base station, and conveying the power headroom report for the sidelink between the first UE and the second UE may include transmitting the power headroom report to the base station using the direct communication link.

In some examples of the method, apparatuses, and non-transitory computer-readable medium described herein, conveying the power headroom report for the sidelink between the first UE and the second UE may include operations, features, means, or instructions for transmitting the power headroom report to the UE using the sidelink between the first UE and the second UE.

Some examples of the method, apparatuses, and non-transitory computer-readable medium described herein may further include operations, features, means, or instructions for receiving an RRC configuration allocating a field of a MAC CE to power headroom reporting for the sidelink between the first UE and the second UE. Some examples of the method, apparatuses, and non-transitory computer-readable medium described herein may further include operations, features, means, or instructions for identifying (e.g., based on the RRC configuration) a serving cell identifier associated with the sidelink between the first UE and the second UE. Some examples of the method, apparatuses, and non-transitory computer-readable medium described herein may further include operations, features, means, or instructions for conveying the power headroom report for the sidelink between the first UE and the second UE in the field of the MAC CE that is associated with the serving cell identifier.

Some examples of the method, apparatuses, and non-transitory computer-readable medium described herein may further include operations, features, means, or instructions for receiving an RRC configuration allocating a first field of a MAC CE to power headroom reporting for the sidelink between the first UE and the second UE and a second field of the MAC CE for identifying the sidelink between the first UE and the second UE. Some examples of the method, apparatuses, and non-transitory computer-readable medium described herein may further include operations, features, means, or instructions for conveying the power headroom report for the sidelink between the first UE and the second UE in the first field of the MAC CE and an indicator of the sidelink between the first UE and the second UE in the second field of the MAC CE.

Some examples of the method, apparatuses, and non-transitory computer-readable medium described herein may further include operations, features, means, or instructions for receiving an RRC configuration allocating a field of a MAC CE to power headroom reporting for the sidelink between the first UE and the second UE, where the MAC CE is dedicated for sidelink power headroom reporting. Some examples of the method, apparatuses, and non-transitory computer-readable medium described herein may further include operations, features, means, or instructions for conveying the power headroom report for the sidelink between the first UE and the second UE in the allocated field of the MAC CE.

Some examples of the method, apparatuses, and non-transitory computer-readable medium described herein may further include operations, features, means, or instructions for determining the power headroom based on a scheduled transmission to the second UE, or a previously transmitted transmission to the second UE, or a virtual reference transmission to the second UE.

Some examples of the method, apparatuses, and non-transitory computer-readable medium described herein may further include operations, features, means, or instructions for determining the power headroom associated with transmissions to the second UE over a first transmission beam of the sidelink between the first UE and the second UE. Some examples of the method, apparatuses, and non-transitory computer-readable medium described herein may further include operations, features, means, or instructions for determining a second power headroom associated with transmissions to the second UE over a second transmission beam of the sidelink between the first UE and the second UE. Some examples of the method, apparatuses, and non-transitory computer-readable medium described herein may further include operations, features, means, or instructions for conveying, to the base station, a second power headroom report for the sidelink between the first UE and the second UE, the second power headroom report based on the second power headroom.

Some examples of the method, apparatuses, and non-transitory computer-readable medium described herein may further include operations, features, means, or instructions for identifying an MCS associated with the transmissions from the first UE to the second UE using the sidelink between the first UE and the second UE. Some examples of the method, apparatuses, and non-transitory computer-readable medium described herein may further include operations, features, means, or instructions for conveying, to the base station, an indication of the identified MCS with the power headroom report for the sidelink between the first UE and the second UE.

A method for wireless communication is described. The method may include establishing, at a base station, a communication link with a first UE via a sidelink between a second UE and the first UE, and receiving a power headroom report for the sidelink between the second UE and the first UE. In some examples, the power headroom report may be associated with transmission from the first UE to the second UE (e.g., over the sidelink between the second UE and the first UE). In some examples, the method may include scheduling communications with the first UE based on receiving the power headroom report for the sidelink between the second UE and the first UE.

An apparatus for wireless communication is described. The apparatus may include a processor and memory coupled with the processor. The processor and memory may be configured to establish (e.g., at a base station) a communication link with a first UE via a sidelink between a second UE and the first UE, receive a power headroom report for the sidelink between the second UE and the first UE. In some examples, the power headroom report may be associated with transmission from the first UE to the second UE (e.g., over the sidelink between the second UE and the first UE). In some examples, the processor and memory may be configured to schedule communications with the first UE based on receiving the power headroom report for the sidelink between the second UE and the first UE.

Another apparatus for wireless communication is described. The apparatus may include means for establishing, at a base station, a communication link with a first UE via a sidelink between a second UE and the first UE, and means for receiving a power headroom report for the sidelink between the second UE and the first UE. In some examples, the power headroom report may be associated with transmission from the first UE to the second UE (e.g., over the sidelink between the second UE and the first UE). In some examples, the apparatus may include means for scheduling communications with the first UE based on receiving the power headroom report for the sidelink between the second UE and the first UE.

A non-transitory computer-readable medium storing code for wireless communication is described. The code may include instructions executable by a processor to establish, at a base station, a communication link with a first UE via a sidelink between a second UE and the first UE, and receive a power headroom report for the sidelink between the second UE and the first UE. In some examples, the power headroom report may be associated with transmission from the first UE to the second UE (e.g., over the sidelink between the second UE and the first UE). In some examples, the code may include instructions executable by the processor to schedule communications with the first UE based on receiving the power headroom report for the sidelink between the second UE and the first UE.

Some examples of the method, apparatuses, and non-transitory computer-readable medium described herein may further include operations, features, means, or instructions for establishing a direct communication link with the first UE. In some examples, receiving the power headroom report for the sidelink between the second UE and the first UE may include receiving the power headroom report using the direct communication link.

In some examples of the method, apparatuses, and non-transitory computer-readable medium described herein, receiving the power headroom report for the sidelink between the second UE and the first UE may include operations, features, means, or instructions for receiving the power headroom report from the second UE.

Some examples of the method, apparatuses, and non-transitory computer-readable medium described herein may further include operations, features, means, or instructions for identifying (e.g., based on establishing the communication link) an RRC configuration for configuring a MAC CE for the power headroom report for the sidelink between the second UE and the first UE. Some examples of the method, apparatuses, and non-transitory computer-readable medium described herein may further include operations, features, means, or instructions for allocating (e.g., based on identifying the RRC configuration) a field of the MAC CE for power headroom reporting for the sidelink between the second UE and the first UE. Some examples of the method, apparatuses, and non-transitory computer-readable medium described herein may further include operations, features, means, or instructions for transmitting an indication of the allocated field of the MAC CE based on allocating the field of the MAC CE. In some examples, receiving the power headroom report may be based on transmitting the indication of the allocated field of the MAC CE.

Some examples of the method, apparatuses, and non-transitory computer-readable medium described herein may further include operations, features, means, or instructions for identifying a threshold power headroom value for scheduling transmissions from the first UE to the second UE over the sidelink between the second UE and the first UE. Some examples of the method, apparatuses, and non-transitory computer-readable medium described herein may further include operations, features, means, or instructions for determining to schedule communications over the sidelink between the second UE and the first UE, or a direct communication link with the first UE, based on comparing the power headroom report to the threshold power headroom value.

In some examples of the method, apparatuses, and non-transitory computer-readable medium described herein, the power headroom report may be associated with transmission over a first transmission beam of the sidelink between the second UE and the first UE. In some examples, the method, apparatuses, and non-transitory computer-readable medium may include further operations, features, means, or instructions for receiving a second power headroom report associated with transmission over a second transmission beam of the sidelink between the second UE and the first UE. In some examples, scheduling the communications with the first UE may be based on receiving the power headroom report and the second power headroom report.

Some examples of the method, apparatuses, and non-transitory computer-readable medium described herein may further include operations, features, means, or instructions for receiving an indication of an MCS associated with the transmission from the first UE to the second UE over the sidelink between the second UE and the first UE. Some examples of the method, apparatuses, and non-transitory computer-readable medium described herein may further include operations, features, means, or instructions for scheduling the communications with the first UE may be based on receiving the indication of the MCS.

A method for wireless communication is described. The method may include establishing, at a first UE, a communication link for communications between a base station and a second UE via the first UE, the communication link including a sidelink between the first UE and the second UE. In some examples, the method may include and transmitting, to the base station, a power headroom report for the sidelink between the first UE and the second UE. In some examples, the power headroom report may be based on a power headroom associated with transmissions from the first UE to the second UE (e.g., using the sidelink between the first UE and the second UE). In some examples, the power headroom may be based on a transmission power capability of the first UE.

An apparatus for wireless communication is described. The apparatus may include a processor and memory coupled with the processor. The processor and memory may be configured to establish (e.g., at a first UE) a communication link for communications between a base station and a UE (e.g., between the base station and a second UE, via the first UE). In some examples, the communication link may include a sidelink between the first UE and the second UE. In some examples, the processor and memory may be configured to transmit, to the base station, a power headroom report for the sidelink between the first UE and the second UE. In some examples, the power headroom report may be based on a power headroom associated with transmissions from the first UE to the second UE (e.g., using the sidelink between the first UE and the second UE). In some examples, the power headroom may be based on a transmission power capability of the first UE.

Another apparatus for wireless communication is described. The apparatus may include means for establishing, at a first UE, a communication link for communications between a base station and a second UE via the first UE, the communication link including a sidelink between the first UE and the second UE. In some examples, the apparatus may include means for transmitting, to the base station, a power headroom report for the sidelink between the first UE and the second UE. In some examples, the power headroom report may be based on a power headroom associated with transmissions from the first UE to the second UE (e.g., using the sidelink between the first UE and the second UE). In some examples, the power headroom may be based on a transmission power capability of the first UE.

A non-transitory computer-readable medium storing code for wireless communication is described. The code may include instructions executable by a processor to establish, at a first UE, a communication link for communications between a base station and a second UE via the first UE, the communication link including a sidelink between the first UE and the second UE. In some examples, the code may include instructions executable by the processor to transmit, to the base station, a power headroom report for the sidelink between the first UE and the second UE. In some examples, the power headroom report may be based on a power headroom associated with transmissions from the first UE to the second UE (e.g., using the sidelink between the first UE and the second UE). In some examples, the power headroom may be based on a transmission power capability of the first UE.

Some examples of the method, apparatuses, and non-transitory computer-readable medium described herein may further include operations, features, means, or instructions for receiving an RRC configuration allocating a field of a MAC CE to power headroom reporting for the sidelink between the first UE and the second UE. Some examples of the method, apparatuses, and non-transitory computer-readable medium described herein may further include operations, features, means, or instructions for identifying (e.g., based on the RRC configuration) a serving cell identifier associated with the sidelink between the first UE and the second UE. Some examples of the method, apparatuses, and non-transitory computer-readable medium described herein may further include operations, features, means, or instructions for transmitting the power headroom report for the sidelink between the first UE and the second UE in the field of the MAC CE that may be associated with the serving cell identifier.

Some examples of the method, apparatuses, and non-transitory computer-readable medium described herein may further include operations, features, means, or instructions for receiving an RRC configuration allocating a first field of a MAC CE to power headroom reporting for the sidelink between the first UE and the second UE and a second field of the MAC CE for identifying the sidelink between the first UE and the second UE. Some examples of the method, apparatuses, and non-transitory computer-readable medium described herein may further include operations, features, means, or instructions for transmitting the power headroom report for the sidelink between the first UE and the second UE in the first field of the MAC CE and an indicator of the sidelink between the first UE and the second UE in the second field of the MAC CE.

Some examples of the method, apparatuses, and non-transitory computer-readable medium described herein may further include operations, features, means, or instructions for receiving an RRC configuration allocating a field of a MAC CE to power headroom reporting for the sidelink between the first UE and the second UE. Some examples of the method, apparatuses, and non-transitory computer-readable medium described herein may further include operations, features, means, or instructions for, transmitting the power headroom report for the sidelink between the first UE and the second UE in the allocated field of the MAC CE. Some examples of the method, apparatuses, and non-transitory computer-readable medium described herein may further include operations, features, means, or instructions for transmitting a power headroom report for a direct communication link between the first UE and the base station in the MAC CE.

In some examples of the method, apparatuses, and non-transitory computer-readable medium described herein, transmitting the power headroom report for the sidelink between the first UE and the second UE may include operations, features, means, or instructions for transmitting the power headroom report in a MAC CE that is dedicated for sidelink power headroom reporting.

Some examples of the method, apparatuses, and non-transitory computer-readable medium described herein may further include operations, features, means, or instructions for determining the power headroom based on a scheduled downlink transmission to the second UE, or a previously transmitted downlink transmission to the second UE, or a virtual reference downlink transmission to the second UE.

Some examples of the method, apparatuses, and non-transitory computer-readable medium described herein may further include operations, features, means, or instructions for determining the power headroom associated with transmissions over a first transmission beam of the sidelink between the first UE and the second UE. Some examples of the method, apparatuses, and non-transitory computer-readable medium described herein may further include operations, features, means, or instructions for determining a second power headroom associated with transmissions from the first UE to the UE over a second transmission beam of the sidelink between the first UE and the second UE. Some examples of the method, apparatuses, and non-transitory computer-readable medium described herein may further include operations, features, means, or instructions for, and transmitting, to the base station, a second power headroom report for the sidelink between the first UE and the second UE, the second power headroom report based on the second power headroom.

Some examples of the method, apparatuses, and non-transitory computer-readable medium described herein may further include operations, features, means, or instructions for identifying an MCS associated with the transmissions from the first UE to the second UE using the sidelink between the first UE and the second UE. Some examples of the method, apparatuses, and non-transitory computer-readable medium described herein may further include operations, features, means, or instructions for transmitting, to the base station, an indication of the identified MCS with the power headroom report for the sidelink between the first UE and the second UE.

A method for wireless communications is described. The method may include establishing, at a base station, a communication link with a first UE via a sidelink between a second UE and the first UE and receiving, from the second UE, a power headroom report for the sidelink between the second UE and the first UE. In some examples, the power headroom report may be associated with transmission from the second UE to the first UE (e.g., over the sidelink between the second UE and the first UE). In some examples, the method may include scheduling communications with the first UE based on receiving the power headroom report for the sidelink between the second UE and the first UE.

An apparatus for wireless communications is described. The apparatus may include a processor and memory coupled with the processor. The processor and memory may be configured to establish (e.g., at a base station) a communication link with a first UE via a sidelink between a second UE and the first UE and receive, from the second UE, a power headroom report for the sidelink between the second UE and the first UE. In some examples, the power headroom report may be associated with transmission from the second UE to the first UE (e.g., over the sidelink between the second UE and the first UE). In some examples, the processor and memory may be configured to schedule communications with the first UE based on receiving the power headroom report for the sidelink between the second UE and the first UE.

Another apparatus for wireless communications is described. The apparatus may include means for establishing, at a base station, a communication link with a first UE via a sidelink between a second UE and the first UE, means for receiving, from the second UE, a power headroom report for the sidelink between the second UE and the first UE. In some examples, the power headroom report may be associated with transmission from the second UE to the first UE (e.g., over the sidelink between the second UE and the first UE). In some examples, the apparatus may include means for scheduling communications with the first UE based on receiving the power headroom report for the sidelink between the second UE and the first UE.

A non-transitory computer-readable medium storing code for wireless communications is described. The code may include instructions executable by a processor to establish, at a base station, a communication link with a first UE via a sidelink between a second UE and the first UE and receive, from the second UE, a power headroom report for the sidelink between the second UE and the first UE. In some examples, the power headroom report may be associated with transmission from the second UE to the first UE (e.g., over the sidelink between the second UE and the first UE). In some examples, the code may include instructions executable by the processor to schedule communications with the first UE based on receiving the power headroom report for the sidelink between the second UE and the first UE.

Some examples of the method, apparatuses, and non-transitory computer-readable medium described herein may further include operations, features, means, or instructions for identifying (e.g., based on establishing the communication link) an RRC configuration for configuring a MAC CE for the power headroom report for the sidelink between the second UE and the first UE. Some examples of the method, apparatuses, and non-transitory computer-readable medium described herein may further include operations, features, means, or instructions for allocating (e.g., based on identifying the RRC configuration) a first field of the MAC CE for power headroom reporting for the sidelink between the second UE and the first UE, and a second field for identifying the sidelink between the second UE and the first UE. Some examples of the method, apparatuses, and non-transitory computer-readable medium described herein may further include operations, features, means, or instructions for transmitting an indication of the first field of the MAC CE and the second field of the MAC CE based on the allocating. In some examples, receiving the power headroom report may include receiving the power headroom report based on transmitting the indication of the first field of the MAC CE and the second field of the MAC CE.

Some examples of the method, apparatuses, and non-transitory computer-readable medium described herein may further include operations, features, means, or instructions for identifying (e.g., based on establishing the communication link) an RRC configuration for configuring a MAC CE for the power headroom report for the sidelink between the second UE and the first UE. Some examples of the method, apparatuses, and non-transitory computer-readable medium described herein may further include operations, features, means, or instructions for allocating (e.g., based on identifying the RRC configuration) a field of the MAC CE for power headroom reporting for the sidelink between the second UE and the first UE. Some examples of the method, apparatuses, and non-transitory computer-readable medium described herein may further include operations, features, means, or instructions for transmitting an indication of the allocated field of the MAC CE based on allocating the field of the MAC CE. In some examples, receiving the power headroom report for the sidelink between the second UE and the first UE may be based on transmitting the indication of the allocated field of the MAC CE. Some examples of the method, apparatuses, and non-transitory computer-readable medium described herein may further include operations, features, means, or instructions for receiving a power headroom report for a direct communication link with the second UE in the MAC CE based on transmitting the identified RRC configuration

Some examples of the method, apparatuses, and non-transitory computer-readable medium described herein may further include operations, features, means, or instructions for identifying a threshold power headroom value for scheduling transmissions from the second UE to the first UE over the sidelink between the second UE and the first UE. Some examples of the method, apparatuses, and non-transitory computer-readable medium described herein may further include operations, features, means, or instructions for determining to schedule communications over the sidelink between the second UE and the first UE, or a direct communication link between the apparatus and the first UE, based on comparing the power headroom report to the threshold power headroom value.

In some examples of the method, apparatuses, and non-transitory computer-readable medium described herein, the power headroom report may be associated with transmission over a first transmission beam of the sidelink between the second UE and the first UE. Some examples of the method, apparatuses, and non-transitory computer-readable medium described herein may further include operations, features, means, or instructions for receiving a second power headroom report associated with transmission over a second transmission beam of the sidelink between the second UE and the first UE. In some examples of the method, apparatuses, and non-transitory computer-readable medium described herein, scheduling the communications with the first UE may be based on receiving the power headroom report and the second power headroom report.

Some examples of the method, apparatuses, and non-transitory computer-readable medium described herein may further include operations, features, means, or instructions for receiving, from the second UE, an indication of an MCS associated with the transmission from the second UE to the first UE over the sidelink between the second UE and the first UE. Some examples of the method, apparatuses, and non-transitory computer-readable medium described herein may further include operations, features, means, or instructions for scheduling communications with the first UE based on receiving the indication of the MCS.

A method for wireless communication is described. The method may include establishing, at a first UE, a sidelink communication link with a base station via a second UE, and determining a power headroom associated with transmissions from the first UE to the second UE using the sidelink communication link. In some examples, determining the power headroom may be based on a transmission power capability of the first UE. The method may also include conveying, to the base station, a power headroom report for the sidelink communication link based on the determined power headroom associated with the transmissions from the first UE to the second UE over the sidelink communication link.

An apparatus for wireless communication is described. The apparatus may include a processor and memory coupled to the processor. The processor and memory may be configured to establish (e.g., at a first UE) a sidelink communication link with a base station via a second UE, and determine a power headroom associated with transmissions to the second UE using the sidelink communication link. In some examples, determining the power headroom may be based on a transmission power capability of the apparatus. The processor and memory may be configured to convey, to the base station, a power headroom report for the sidelink communication link based on the determined power headroom associated with the transmissions to the second UE over the sidelink communication link.

Another apparatus for wireless communication is described. The apparatus may include means for establishing (e.g., at a first UE) a sidelink communication link with a base station via a second UE, means for determining a power headroom associated with transmissions to the second UE using the sidelink communication link, and means for conveying, to the base station, a power headroom report for the sidelink communication link based on the determined power headroom associated with the transmissions to the second UE over the sidelink communication link. In some examples, the means for determining the power headroom may be operable based on a transmission power capability of the apparatus.

A non-transitory computer-readable medium storing code for wireless communication is described. The code may include instructions executable by a processor to establish, at a first UE, a sidelink communication link with a base station via a second UE, and determine a power headroom associated with transmissions from the first UE to the second UE using the sidelink communication link. In some examples, determining the power headroom may be based on a transmission power capability of the first UE. The instructions may be executable by the processor to convey, to the base station, a power headroom report for the sidelink communication link based on the determined power headroom associated with the transmissions from the first UE to the second UE over the sidelink communication link.

Some examples of the method, apparatuses, and non-transitory computer-readable medium described herein may further include operations, features, means, or instructions for establishing, at the first UE, a direct communication link with the base station. In some examples, conveying the power headroom report for the sidelink communication link includes transmitting the power headroom report for the sidelink communication link to the base station using the direct communication link.

In some examples of the method, apparatuses, and non-transitory computer-readable medium described herein, conveying the power headroom report for the sidelink communication link may include operations, features, means, or instructions for transmitting the power headroom report for the sidelink communication link to the second UE using the sidelink communication link.

In some examples of the method, apparatuses, and non-transitory computer-readable medium described herein, conveying the power headroom report for the sidelink communication link may include operations, features, means, or instructions for transmitting the power headroom report for the sidelink communication link in a medium access control (MAC) control element (CE).

Some examples of the method, apparatuses, and non-transitory computer-readable medium described herein may further include operations, features, means, or instructions for receiving a radio resource control (RRC) configuration allocating a field of the MAC CE to power headroom reporting for the sidelink communication link. In some examples, transmitting the power headroom report may include operations, features, means, or instructions for transmitting the power headroom report in the allocated field of the MAC CE.

Some examples of the method, apparatuses, and non-transitory computer-readable medium described herein may further include operations, features, means, or instructions for identifying, based on the RRC configuration, a serving cell identifier associated with the sidelink communication link. In some examples, transmitting the power headroom report in the MAC CE may include operations, features, means, or instructions for transmitting the power headroom report in the field of the MAC CE associated with the serving cell identifier.

Some examples of the method, apparatuses, and non-transitory computer-readable medium described herein may further include operations, features, means, or instructions for identifying, based on the RRC configuration, a second field of the MAC CE for identifying the sidelink communication link. In some examples, transmitting the power headroom report in the MAC CE may include operations, features, means, or instructions for transmitting an indicator of the sidelink communication link using the second field of the MAC CE.

In some examples of the method, apparatuses, and non-transitory computer-readable medium described herein, the MAC CE may be dedicated for sidelink power headroom reporting.

Some examples of the method, apparatuses, and non-transitory computer-readable medium described herein may further include operations, features, means, or instructions for transmitting a power headroom report for a direct communication link between the first UE and the base station in the MAC CE.

In some examples of the method, apparatuses, and non-transitory computer-readable medium described herein, determining the power headroom may include operations, features, means, or instructions for determining the power headroom based on a scheduled uplink transmission from the first UE to the second UE.

In some examples of the method, apparatuses, and non-transitory computer-readable medium described herein, determining the power headroom may include operations, features, means, or instructions for determining the power headroom based on a previously transmitted uplink transmission from the first UE to the second UE.

In some examples of the method, apparatuses, and non-transitory computer-readable medium described herein, determining the power headroom may include operations, features, means, or instructions for determining the power headroom based on a virtual reference uplink transmission from the first UE to the second UE.

In some examples of the method, apparatuses, and non-transitory computer-readable medium described herein, determining the power headroom may include operations, features, means, or instructions for determining a first power headroom associated with transmissions from the first UE to the second UE over a first transmission beam of the sidelink communication link and determining a second power headroom associated with transmissions from the first UE to the second UE over a second transmission beam of the sidelink communication link. Some examples of the method, apparatuses, and non-transitory computer-readable medium described herein may further include operations, features, means, or instructions for conveying, to the base station, a power headroom report for the sidelink communication link based on the determined first power headroom associated with the transmissions over the first transmission beam of the sidelink communication link and the determined second power headroom associated with the transmissions over the second transmission beam of the sidelink communication link.

Some examples of the method, apparatuses, and non-transitory computer-readable medium described herein may further include operations, features, means, or instructions for identifying a modulation and coding scheme (MCS) associated with the transmissions from the first UE to the second UE using the sidelink communication link, and conveying, to the base station, an indication of the identified MCS with the power headroom report for the sidelink communication link.

A method for wireless communication is described. The method may include establishing, at a base station, a sidelink communication link with a first UE via a second UE, and receiving, at the base station, a power headroom report for the sidelink communication link. The power headroom report may be associated with transmission from the first UE to the second UE over the sidelink communication link. The method may further include scheduling communications with the first UE based on receiving the power headroom report for the sidelink communication link.

An apparatus for wireless communication is described. The apparatus may include a processor and memory coupled to the processor. The processor and memory may be configured to establish (e.g., at a base station) a sidelink communication link with a first UE via a second UE, and receive a power headroom report for the sidelink communication link, the power headroom report associated with transmission from the first UE to the second UE over the sidelink communication link. The processor and memory may be configured to schedule communications with the first UE based on receiving the power headroom report for the sidelink communication link.

Another apparatus for wireless communication is described. The apparatus may include means for establishing (e.g., at a base station) a sidelink communication link with a first UE via a second UE, means for receiving a power headroom report for the sidelink communication link, and means for scheduling communications with the first UE based on receiving the power headroom report for the sidelink communication link. In some examples, the power headroom report may be associated with transmission from the first UE to the second UE over the sidelink communication link

A non-transitory computer-readable medium storing code for wireless communication is described. The code may include instructions executable by a processor to establish, at a base station, a sidelink communication link with a first UE via a second UE, and receive, at the base station, a power headroom report for the sidelink communication link, the power headroom report associated with transmission from the first UE to the second UE over the sidelink communication link. The instructions may be further executable to schedule communications with the first UE based on receiving the power headroom report for the sidelink communication link.

Some examples of the method, apparatuses, and non-transitory computer-readable medium described herein may further include operations, features, means, or instructions for establishing (e.g., at the base station) a direct communication link with the first UE. In some examples, receiving the power headroom report for the sidelink communication link may include receiving the power headroom report for the sidelink communication link using the direct communication link.

In some examples of the method, apparatuses, and non-transitory computer-readable medium described herein, receiving the power headroom report for the sidelink communication link may include operations, features, means, or instructions for receiving the power headroom report for the sidelink communication link from the second UE using the sidelink communication link.

Some examples of the method, apparatuses, and non-transitory computer-readable medium described herein may further include operations, features, means, or instructions for identifying, based on establishing the sidelink communication link, a RRC configuration for configuring a MAC CE for the power headroom report for the sidelink communication link, transmitting the identified RRC configuration to the first UE, and receiving the power headroom report for the sidelink communication link in the MAC CE based on transmitting the identified RRC configuration.

Some examples of the method, apparatuses, and non-transitory computer-readable medium described herein may further include operations, features, means, or instructions for allocating, based on identifying the RRC configuration, a field of the MAC CE for power headroom reporting for the sidelink communication link, and transmitting an indication of the allocated field of the MAC CE based on allocating the field of the MAC CE. In some examples, receiving the power headroom report for the sidelink communication link may be based on transmitting the indication of the allocated field of the MAC CE.

In some examples of the method, apparatuses, and non-transitory computer-readable medium described herein, transmitting the indication of the allocated field of the MAC CE may include operations, features, means, or instructions for transmitting a serving cell identifier associated with the sidelink communication link.

Some examples of the method, apparatuses, and non-transitory computer-readable medium described herein may further include operations, features, means, or instructions for transmitting an indication of a second field of the MAC CE allocated for identifying the sidelink communication link. In some examples, receiving the power headroom report for the sidelink communication link in the MAC CE may include operations, features, means, or instructions for receiving an indicator of the sidelink communication link using the second field of the MAC CE.

In some examples of the method, apparatuses, and non-transitory computer-readable medium described herein, identifying the RRC configuration may include operations, features, means, or instructions for identifying a configuration for configuring a MAC CE dedicated for sidelink power headroom reporting.

Some examples of the method, apparatuses, and non-transitory computer-readable medium described herein may further include operations, features, means, or instructions for receiving a power headroom report for a direct communication link with the first UE in the MAC CE based on transmitting the identified RRC configuration.

Some examples of the method, apparatuses, and non-transitory computer-readable medium described herein may further include operations, features, means, or instructions for identifying a threshold power headroom value for scheduling uplink transmissions from the first UE to the second UE over the sidelink communication link. In some examples, scheduling communications with the first UE may be based on comparing the received power headroom report to the threshold power headroom value.

In some examples of the method, apparatuses, and non-transitory computer-readable medium described herein, the scheduling communications with the first UE may include operations, features, means, or instructions for determining to schedule communications over the sidelink communication link or a direct communication link based on comparing the received power headroom report to the threshold power headroom value.

In some examples of the method, apparatuses, and non-transitory computer-readable medium described herein, the scheduling communications with the first UE may include operations, features, means, or instructions for determining an MCS for transmissions using the sidelink communication link based on the received power headroom report.

In some examples of the method, apparatuses, and non-transitory computer-readable medium described herein, the power headroom report may be associated with transmission over a first transmission beam of the sidelink communication link. Some examples of the method, apparatuses, and non-transitory computer-readable medium described herein may further include operations, features, means, or instructions for receiving (e.g., at the base station) a second power headroom report associated with transmission over a second transmission beam of the sidelink communication link. In some examples, scheduling communications with the first UE may be based on receiving the power headroom report and the second power headroom report.

Some examples of the method, apparatuses, and non-transitory computer-readable medium described herein may further include operations, features, means, or instructions for receiving (e.g., at the base station) an indication of an MCS associated with the transmission from the first UE to the second UE over the sidelink communication link. In some examples, scheduling communications with the first UE may be based on receiving the indication of the MCS.

A method for wireless communication is described. The method may include establishing, at a first UE, a sidelink communication link for communications between a base station and a second UE via the first UE, and determining a power headroom associated with transmissions from the first UE to the second UE using the sidelink communication link. In some examples, determining the power headroom may be based on a transmission power capability of the first UE. The method may further include transmitting, to the base station, a power headroom report for the sidelink communication link based on the determined power headroom associated with the transmissions from the first UE to the second UE over the sidelink communication link.

An apparatus for wireless communication is described. The apparatus may include a processor and memory coupled to the processor. The processor and memory may be configured to establish (e.g., at a first UE) a sidelink communication link for communications between a base station and a second UE via the apparatus, and determine a power headroom associated with transmissions to the second UE using the sidelink communication link. In some examples, the configuration to determine the power headroom may be based on a transmission power capability of the apparatus. The processor and memory may be further configured to transmit, to the base station, a power headroom report for the sidelink communication link based on the determined power headroom associated with the transmissions to the second UE over the sidelink communication link.

Another apparatus for wireless communication is described. The apparatus may include means for establishing a sidelink communication link for communications between a base station and a second UE via the apparatus, and means for determining a power headroom associated with transmissions to the second UE using the sidelink communication link. In some examples, the means for determining the power headroom may be operable based on a transmission power capability of the apparatus. In some examples, the apparatus may further include means for transmitting, to the base station, a power headroom report for the sidelink communication link based on the determined power headroom associated with the transmissions to the second UE over the sidelink communication link.

A non-transitory computer-readable medium storing code for wireless communication is described. The code may include instructions executable by a processor to establish, at a first UE, a sidelink communication link for communications between a base station and a second UE via the first UE, determine a power headroom associated with transmissions from the first UE to the second UE using the sidelink communication link, where determining the power headroom is based on a transmission power capability of the first UE, and transmit, to the base station, a power headroom report for the sidelink communication link based on the determined power headroom associated with the transmissions from the first UE to the second UE over the sidelink communication link.

In some examples of the method, apparatuses, and non-transitory computer-readable medium described herein, transmitting the power headroom report for the sidelink communication link may include operations, features, means, or instructions for transmitting the power headroom report for the sidelink communication link in a MAC CE.

Some examples of the method, apparatuses, and non-transitory computer-readable medium described herein may further include operations, features, means, or instructions for receiving an RRC configuration allocating a field of the MAC CE to power headroom reporting for the sidelink communication link. In some examples, transmitting the power headroom report may include transmitting the power headroom report in the allocated field of the MAC CE.

Some examples of the method, apparatuses, and non-transitory computer-readable medium described herein may further include operations, features, means, or instructions for identifying, based on the RRC configuration, a serving cell identifier associated with the sidelink communication link. In some examples, transmitting the power headroom report in the MAC CE may include transmitting the power headroom report in the field of the MAC CE associated with the serving cell identifier.

Some examples of the method, apparatuses, and non-transitory computer-readable medium described herein may further include operations, features, means, or instructions for identifying, based on the RRC configuration, a second field of the MAC CE for identifying the sidelink communication link. In some examples, transmitting the power headroom report in the MAC CE may include transmitting an indicator of the sidelink communication link using the second field of the MAC CE.

In some examples of the method, apparatuses, and non-transitory computer-readable medium described herein, the MAC CE may be dedicated for sidelink power headroom reporting.

Some examples of the method, apparatuses, and non-transitory computer-readable medium described herein may further include operations, features, means, or instructions for transmitting a power headroom report for a direct communication link between the first UE and the base station in the MAC CE.

In some examples of the method, apparatuses, and non-transitory computer-readable medium described herein, determining the power headroom may include operations, features, means, or instructions for determining the power headroom based on a scheduled downlink transmission to the second UE.

In some examples of the method, apparatuses, and non-transitory computer-readable medium described herein, determining the power headroom may include operations, features, means, or instructions for determining the power headroom based on a previously transmitted downlink transmission to the second UE.

In some examples of the method, apparatuses, and non-transitory computer-readable medium described herein, determining the power headroom may include operations, features, means, or instructions for determining the power headroom based on a virtual reference downlink transmission to the second UE.

In some examples of the method, apparatuses, and non-transitory computer-readable medium described herein, determining the power headroom may include operations, features, means, or instructions for determining a first power headroom associated with transmissions from the first UE to the second UE over a first transmission beam of the sidelink communication link, and determining a second power headroom associated with transmissions from the first UE to the second UE over a second transmission beam of the sidelink communication link. Some examples of the method, apparatuses, and non-transitory computer-readable medium described herein may further include operations, features, means, or instructions for transmitting, to the base station, a first power headroom report for the sidelink communication link based on the determined first power headroom associated with the transmissions over the first transmission beam of the sidelink communication link, and a second power headroom report for the sidelink communication link based on the determined second power headroom associated with the transmissions over the second transmission beam of the sidelink communication link.

Some examples of the method, apparatuses, and non-transitory computer-readable medium described herein may further include operations, features, means, or instructions for identifying an MCS associated with the transmissions to the second UE using the sidelink communication link, and transmitting, to the base station, an indication of the identified MCS with the power headroom report for the sidelink communication link.

A method for wireless communication is described. The method may include establishing, at a base station, a sidelink communication link for communications with a first UE via a second UE, and receiving, from the second UE, a power headroom report for the sidelink communication link. In some examples, the power headroom report may be associated with transmission from the second UE to the first UE over the sidelink communication link. The method may further include scheduling communications with the first UE based on receiving the power headroom report for the sidelink communication link.

An apparatus for wireless communication is described. The apparatus may include a processor and memory coupled to the processor. The processor and memory may be configured to establish (e.g., at a base station) a sidelink communication link for communications with a first UE via a second UE, and receive, from the second UE, a power headroom report for the sidelink communication link. In some examples, the power headroom report may be associated with transmission from the second UE to the first UE over the sidelink communication link. The processor and memory may be further configured to schedule communications with the first UE based on receiving the power headroom report for the sidelink communication link.

Another apparatus for wireless communication is described. The apparatus may include means for establishing (e.g., at a base station) a sidelink communication link for communications with a first UE via a second UE, and means for receiving, from the second UE, a power headroom report for the sidelink communication link. In some examples, the power headroom report may be associated with transmission from the second UE to the first UE over the sidelink communication link. The apparatus may further include means for scheduling communications with the first UE based on receiving the power headroom report for the sidelink communication link.

A non-transitory computer-readable medium storing code for wireless communication is described. The code may include instructions executable by a processor to establish, at a base station, a sidelink communication link for communications with a first UE via a second UE, and receive, from the second UE, a power headroom report for the sidelink communication link. In some examples, the power headroom report may be associated with transmission from the second UE to the first UE over the sidelink communication link. The instructions may be further executable by the processor to schedule communications with the first UE based on receiving the power headroom report for the sidelink communication link.

Some examples of the method, apparatuses, and non-transitory computer-readable medium described herein may further include operations, features, means, or instructions for identifying, based on establishing the sidelink communication link, an RRC configuration for configuring a MAC CE for the power headroom report for the sidelink communication link, and transmitting the identified RRC configuration to the second UE. Some examples of the method, apparatuses, and non-transitory computer-readable medium described herein may further include operations, features, means, or instructions for receiving the power headroom report for the sidelink communication link in the MAC CE based on transmitting the identified RRC configuration.

Some examples of the method, apparatuses, and non-transitory computer-readable medium described herein may further include operations, features, means, or instructions for allocating, based on identifying the RRC configuration, a field of the MAC CE for power headroom reporting for the sidelink communication link, and transmitting an indication of the allocated field of the MAC CE based on allocating the field of the MAC CE. In some examples, receiving the power headroom report for the sidelink communication link may be based on the transmission of the indication of the allocated field of the MAC CE.

In some examples of the method, apparatuses, and non-transitory computer-readable medium described herein, transmitting the indication of the allocated field of the MAC CE may include operations, features, means, or instructions for transmitting a serving cell identifier associated with the sidelink communication link.

Some examples of the method, apparatuses, and non-transitory computer-readable medium described herein may further include operations, features, means, or instructions for transmitting an indication of a second field of the MAC CE allocated for identifying the sidelink communication link. In some examples, receiving the power headroom report for the sidelink communication link in the MAC CE may include operations, features, means, or instructions for receiving an indicator of the sidelink communication link using the second field of the MAC CE.

In some examples of the method, apparatuses, and non-transitory computer-readable medium described herein, identifying the RRC configuration may include operations, features, means, or instructions for identifying a configuration for configuring a MAC CE dedicated for sidelink power headroom reporting.

Some examples of the method, apparatuses, and non-transitory computer-readable medium described herein may further include operations, features, means, or instructions for receiving a power headroom report for a direct communication link with the second UE in the MAC CE (e.g., based on transmitting the identified RRC configuration).

Some examples of the method, apparatuses, and non-transitory computer-readable medium described herein may further include operations, features, means, or instructions for identifying a threshold power headroom value for scheduling downlink transmissions from the second UE to the first UE over the sidelink communication link. In some examples, scheduling communications with the first UE may be based on comparing the received power headroom report to the threshold power headroom value.

In some examples of the method, apparatuses, and non-transitory computer-readable medium described herein, scheduling communications with the first UE may include operations, features, means, or instructions for determining to schedule downlink communications over the sidelink communication link or a direct communication link between the base station and the first UE based on comparing the received power headroom report to the threshold power headroom value.

In some examples of the method, apparatuses, and non-transitory computer-readable medium described herein, the scheduling communications with the first UE may include operations, features, means, or instructions for determining an MCS for downlink transmissions from the second UE to the first UE over the sidelink communication link based on the received power headroom report.

In some examples of the method, apparatuses, and non-transitory computer-readable medium described herein, the power headroom report (e.g., a first power headroom report) may be associated with transmission over a first transmission beam of the sidelink communication link. Some examples of the method, apparatuses, and non-transitory computer-readable medium described herein may further include operations, features, means, or instructions for receiving a second power headroom report associated with transmission over a second transmission beam of the sidelink communication link. In some examples, scheduling communications with the first UE may be based on receiving the first power headroom report and the second power headroom report.

Some examples of the method, apparatuses, and non-transitory computer-readable medium described herein may further include operations, features, means, or instructions for receiving, from the second UE, an indication of an MCS associated with the transmission from the second UE to the first UE over the sidelink communication link. In some examples, scheduling communications with the first UE may be based on receiving the indication of the MCS.

### BRIEF DESCRIPTION OF THE DRAWINGS

FIG. 1 illustrates an example of a wireless communications system that supports power headroom reporting for sidelink communications in accordance with one or more aspects of the present disclosure.

FIG. 2 illustrates an example of a wireless communications system that supports power headroom reporting for sidelink communications in accordance with one or more aspects of the present disclosure.

FIGS. 3 and 4 illustrate examples of process flow diagrams that support power headroom reporting for sidelink communications in accordance with one or more aspects of the present disclosure.

FIGS. 5 and 6 show block diagrams of devices that support power headroom reporting for sidelink with L2 relays in accordance with one or more aspects of the present disclosure.

FIG. 7 shows a block diagram of a communications manager that supports power headroom reporting for sidelink with L2 relays in accordance with one or more aspects of the present disclosure.

FIG. 8 shows a diagram of a system including a device that supports power headroom reporting for sidelink with L2 relays in accordance with one or more aspects of the present disclosure.

FIGS. 9 and 10 show block diagrams of devices that support power headroom reporting for sidelink with L2 relays in accordance with one or more aspects of the present disclosure.

FIG. 11 shows a block diagram of a communications manager that supports power headroom reporting for sidelink with L2 relays in accordance with one or more aspects of the present disclosure.

FIG. 12 shows a diagram of a system including a device that supports power headroom reporting for sidelink with L2 relays in accordance with one or more aspects of the present disclosure.

FIGS. 13 and 14 show block diagrams of devices that support power headroom reporting for sidelink communications in accordance with one or more aspects of the present disclosure.

FIG. 15 shows a block diagram of a communications manager that supports power headroom reporting for sidelink communications in accordance with one or more aspects of the present disclosure.

FIG. 16 shows a diagram of a system including a device that supports power headroom reporting for sidelink communications in accordance with one or more aspects of the present disclosure.

FIGS. 17 and 18 show block diagrams of devices that power headroom reporting for sidelink communications in accordance with one or more aspects of the present disclosure.

FIG. 19 shows a block diagram of a communications manager that supports power headroom reporting for sidelink communications in accordance with one or more aspects of the present disclosure.

FIG. 20 shows a diagram of a system including a device that supports power headroom reporting for sidelink communications in accordance with one or more aspects of the present disclosure.

FIGS. 21 through 33 show flowcharts illustrating methods that support power headroom reporting for sidelink communications in accordance with one or more aspects of the present disclosure.

### DETAILED DESCRIPTION

A wireless communications system may support various power control techniques to support signaling reliability and performance. Devices in the wireless communication system, such as a UE, may use power headroom reporting to indicate to a scheduling entity, such as a base station, how much transmission power is available for the device beyond the power used by a previous, ongoing, scheduled, or virtual transmission. Such power headroom reporting may allow the scheduling entity to determine communications scheduling for devices in a manner that does not exceed their associated threshold transmission power.

In some examples, a wireless communications system may support a communication link between a base station and a UE (e.g., an endpoint UE, a target UE) that includes one or more sidelink communication links (e.g., a “sidelink”), where a sidelink communication link may refer to a communication link between the UE and a relay device (e.g., a relay UE), or between relay devices that are in communication between the base station and the UE. In some examples, a sidelink communication link may refer to or otherwise include a layer 2 (L2) relay or an L2 relay device, associated with one or more layers of a communications protocol. To support various examples of power headroom reporting for a sidelink, a UE or a relay device may determine a power headroom for communications over the sidelink (e.g., power headroom corresponding to transmissions from a target or endpoint UE to a relay device, power headroom corresponding to transmissions from a relay device to a target or endpoint UE, power headroom corresponding to transmissions from a relay device to another relay device), and may convey the power headroom to a base station or other scheduling entity in a sidelink power headroom report (PHR). In various examples, a UE or relay device may communicate a sidelink PHR to the base station or other scheduling entity over a direct communication link (e.g., in a direct transmission from the UE or relay device to the base station) or via the sidelink communication link (e.g., in a communication from the UE or relay device that is relayed to the base station via another device). In some implementations, a UE or relay device may be configured (e.g., via configuration signaling from the base station) to generate a MAC CE that includes one or more indications of the sidelink PHR.

A base station or other scheduling entity may schedule transmissions for a target or endpoint UE, or one or more relay devices, or various combinations thereof, based at least in part on one or more received sidelink PHRs. In some examples, such scheduling may be associated with communications in an uplink direction (e.g., communications towards the base station, communications from a target or endpoint UE), and may include uplink power configuration, uplink MCS configuration, uplink transmission or reception beam selection, uplink communication link selection, and other aspects of uplink scheduling. Additionally or alternatively, in some examples, such scheduling may be associated with communications in an downlink direction (e.g., communications from the base station, communications towards a target or endpoint UE), and may include downlink power configuration, downlink MCS configuration, downlink transmission or reception beam selection, downlink communication link selection, and other aspects of downlink scheduling.

In some examples, the base station may identify a threshold power headroom value or a threshold transmission power for scheduling communications between or among a target UE and one or more relay UEs, such that scheduled sidelink communications do not exceed a transmission capability of a respective device, or some other transmission power threshold. For example, the base station may compare a reported sidelink power headroom from the sidelink PHR to a threshold power headroom, and may determine whether to schedule sidelink communications, direct communications, or various combinations thereof, based on the comparison. In some examples, if the base station determines that the sidelink power headroom is above or equal to a threshold, the base station may schedule sidelink communications that include transmission (e.g., in an uplink direction or downlink direction) between a target UE and a relay UE, or between multiple relay UEs. In some examples, if the base station determines that the sidelink power headroom is below or equal to a threshold, the base station may inhibit scheduling over a particular sidelink, which may include scheduling communications with a target or endpoint UE on a direct communication link (e.g., a direct uplink transmission from target UE to the base station, a direct transmission downlink from the base station to the target UE) or a different sidelink (e.g., an uplink communication from the target UE to the base station via a different relay UE or sidelink communication link, a downlink communication from the base station to the target UE via a different relay UE or sidelink communication link).

In some examples, communications in an uplink direction and a downlink direction may be considered together, such that uplink and downlink communications are scheduled to be conveyed along a same set of devices, or along a same set of communications links, between a base station and a target UE, which may be determined based on a combined consideration of uplink and downlink power headroom reporting by the target UE and one or more relay devices. In some examples, communications in an uplink direction and a downlink direction may be considered separately, such that uplink and downlink communications may or may not be conveyed along a same set of devices, or along a same set of communications links, between a base station and a target UE, which may be determined based on a separated consideration of uplink and downlink power headroom reporting by the target UE and one or more relay devices. In other words, in some examples, uplink power headroom reporting and downlink power headroom reporting may be included in separate determinations of communications links or relay devices for uplink communications and downlink communications with a target UE.

By supporting various aspects of sidelink power headroom reporting, a wireless communications system may support improved connectivity between devices of the wireless communications system, and improved allocation of communications resources and spectral efficiency of the wireless communications system. For example, by considering received sidelink power headroom reporting (e.g., in an uplink direction, in a downlink direction, in both an uplink direction and a downlink direction), a scheduling entity, such as a base station, may determine communications scheduling for UEs in a manner that does not exceed a threshold transmission power of respective devices, or in a manner that leverages various aspects of link diversity (e.g., scheduling communications over direct links, or over sidelinks, or over various combinations of direct links and sidelinks), or reduces occurrences of radio link failure between the UEs and base stations, or various combinations thereof.

Aspects of the disclosure are initially described in the context of wireless communications systems and examples of signaling between devices of wireless communications systems that may support power headroom reporting for sidelink communications. Aspects of the disclosure are further illustrated by and described with reference to apparatus diagrams, system diagrams, and flowcharts that relate to power headroom reporting for sidelink communications.

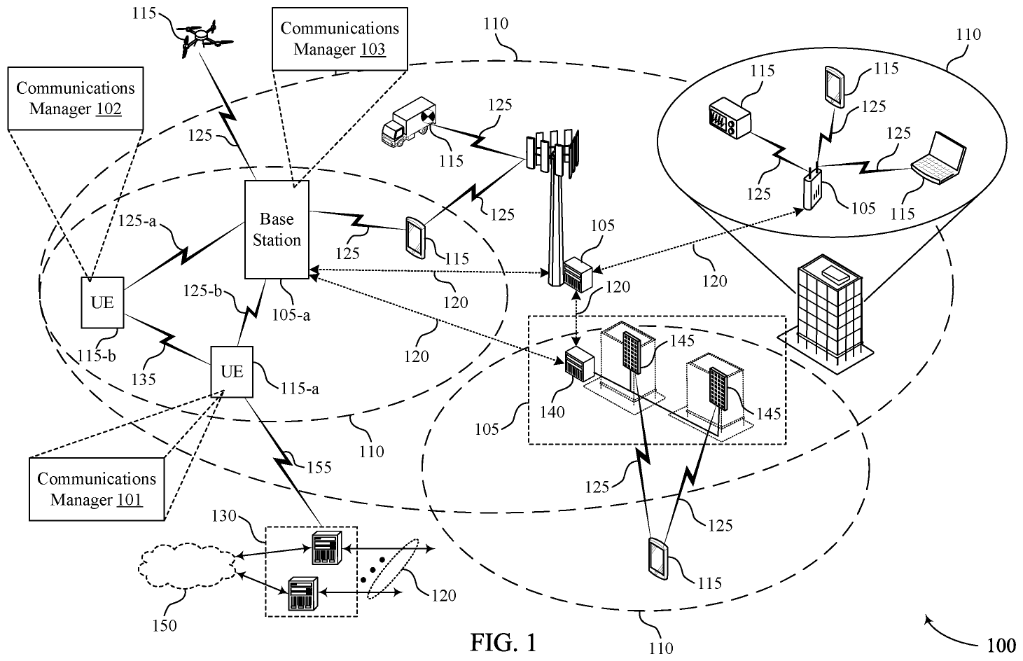

FIG. 1 illustrates an example of a wireless communications system 100 that supports power headroom reporting for sidelink communications in accordance with one or more aspects of the present disclosure. The wireless communications system 100 may include one or more base stations 105, one or more UEs 115, and a core network 130. In some examples, the wireless communications system 100 may be an LTE network, an LTE-A network, an LTE-A Pro network, or an NR network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. A UE 115 may communicate with the core network 130 through a communication link 155.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or DFT-S-OFDM). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

In some examples, a macro cell covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between UEs 115 (e.g., between vehicles). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example, in the range of 300 MHz to 300 gigahertz (GHz). For example, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports, or different transmission beams or reception beams, used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The wireless communications system 100 may support sidelink communication links for communications between base stations 105 and UEs 115, which may include uplink communications (e.g., communications in an uplink direction), downlink communications (e.g., communications in a downlink direction), or both uplink and downlink communications between a base station 105 and a UE 115 that are relayed by one or more relay devices. For example, a communication link may be established between the base station 105-a and the UE 115-a (e.g., a target device, an endpoint device), which may support communications relayed via the UE 115-b (e.g., a relay UE, a relay device, an L2 relay device). In various examples, the term “sidelink” may refer to the communication link 135 (e.g., a D2D communication link, a relay communication link), or a combination of the communication link 135 (e.g., a first relay communication link) and the communication link 125-a (e.g., a second relay communication link). In some examples, a combination of the communication link 135 (e.g., a sidelink) and the communication link 125-a (e.g., a direct link) may be referred to as a compound link. In some examples, a sidelink communication link may refer to or otherwise include an L2 relay, referring to a layer or other portion of a communications protocol or protocol stack. In various examples, sidelinks may refer to or otherwise include a PC5 interface, a D2D interface, or a vehicle-to-everything (V2X) interface, among other interfaces. In some examples, the wireless communications system 100 may additionally or alternatively support a direct communication link between the base station 105-a and the UE 115-a (e.g., via communication link 125-b), which may refer to or otherwise include a Uu interface, or a wide area network (WAN) interface, among other interfaces.

The wireless communications system 100 may support various power control techniques to support signaling reliability and performance, which may include various examples of sidelink power headroom reporting in accordance with examples as disclosed herein. For example, the UE 115-a may determine a power headroom associated with sidelink communications (e.g., an uplink power headroom associated with transmissions from the UE 115-a to the UE 115-b), and convey a sidelink PHR to indicate (e.g., to the base station 105-a) how much transmission power is available for the UE 115-a beyond a power associated with an uplink transmission on the sidelink (e.g., a transmission to the UE 115-b, a transmission towards the base station 105-a via the communication link 135). In another example, the UE 115-b may determine a power headroom associated with sidelink communications (e.g., a downlink power headroom associated with transmissions from the UE 115-b to the UE 115-a, an uplink power headroom associated with transmissions from the UE 115-b to the base station 105-a), and convey a sidelink PHR to indicate (e.g., to the base station 105-a) how much transmission power is available for the UE 115-b beyond a power associated with a transmission on the sidelink (e.g., a downlink transmission to the UE 115-a via the communication link 135, an uplink transmission to the base station 105-a via the communication link 125-a). Such power headroom reporting may allow the base station 105-a to determine communications scheduling for the UE 115-a and the UE 115-b, including scheduling of the UE 115-a and the UE 115-b, in a manner that does not exceed a threshold transmission power (e.g., of the UE 115-a, of the UE 115-b) over the sidelink communication link.

By supporting various aspects of sidelink power headroom reporting, the wireless communications system 100 may support improved connectivity between devices of the wireless communications system 100, and improved allocation of communications resources and spectral efficiency of the wireless communications system 100. For example, by considering received sidelink power headroom reporting (e.g., in an uplink direction, in a downlink direction, in both an uplink direction and a downlink direction), a scheduling entity, such as a base station 105, may determine communications scheduling for UEs 115 in a manner that does not exceed a threshold transmission power of respective devices, or in a manner that leverages various aspects of link diversity (e.g., scheduling communications over direct links, or over sidelinks, or over various combinations of direct links and sidelinks), or reduces occurrences of radio link failure between the UEs 115 and base stations 105, among other beneficial techniques.

In some examples, the UE 115-a may include a communications manager 101 configured to support various aspects of sidelink power headroom reporting as described herein. For example, the communications manager 101 may be configured to establish a sidelink communication link with the base station 105-a via the UE 115-b (e.g., one or more relay devices), and determine a power headroom associated with transmissions (e.g., uplink transmissions) from the UE 115-a to the UE 115-b using the sidelink communication link. In some examples, determining the power headroom may be based at least in part on a transmission power capability of the UE 115-a. The communications manager 101 may be configured to convey (e.g., to the base station 105-a) a sidelink power headroom report for the sidelink communication link based at least in part on the determined power headroom.

In some examples, the UE 115-b may include a communications manager 102 configured to support various aspects of sidelink power headroom reporting as described herein. For example, the communications manager 102 may be configured to establish a sidelink communication link for communications between the base station 105-a and the UE 115-a via the UE 115-b, and determine a power headroom associated with transmissions from the UE 115-b to the UE 115-a using the sidelink communication link. In some examples, determining the power headroom may be based at least in part on a transmission power capability of the UE 115-b. The communications manager 102 may be configured to convey (e.g., to the base station 105-a) a sidelink power headroom report for the sidelink communication link based at least in part on the determined power headroom.

In some examples, the UE 115-b may also include a communications manager 101, or the communications manager 102 may be configured to perform one or more operations described with reference to the communications manager 101. For example, according to one or more techniques described herein, the UE 115-b may be configured to determine a power headroom associated with uplink transmissions from the UE 115-b to another relay device (not shown), or to the base station 105-a, or a combination thereof, and convey such information in a sidelink or other power headroom report to the base station 105-a. In some examples, the UE 115-a may include a communications manager 102, which may support the UE 115-a performing various sidelink power headroom reporting techniques when performing relay communications (e.g., when the UE 115-a participates in communications as a relay device).

In some examples, the base station 105-a may include a communications manager 103 configured to support various aspects of sidelink power headroom reporting as described herein. For example, the communications manager 103 may be configured to establish a sidelink communication link with the UE 115-a via the UE 115-b, and receive one or more sidelink power headroom reports for the sidelink communication link. In some examples, a received sidelink power headroom report may be associated with transmissions (e.g., uplink transmissions) from the UE 115-a to the UE 115-b over the sidelink communication link, or from the UE 115-b to the base station 105-a or another relay device (not shown). Additionally or alternatively, a received sidelink power headroom report may be associated with transmissions (e.g., downlink transmissions) from the UE 115-b to the UE 115-a, or from another relay device to the UE 115-b, over the sidelink communication link. The communications manager 103 may be configured to schedule communications with the UE 115-a (e.g., uplink communications, downlink communications, or both uplink and downlink communications) based at least in part on receiving the one or more sidelink power headroom reports.

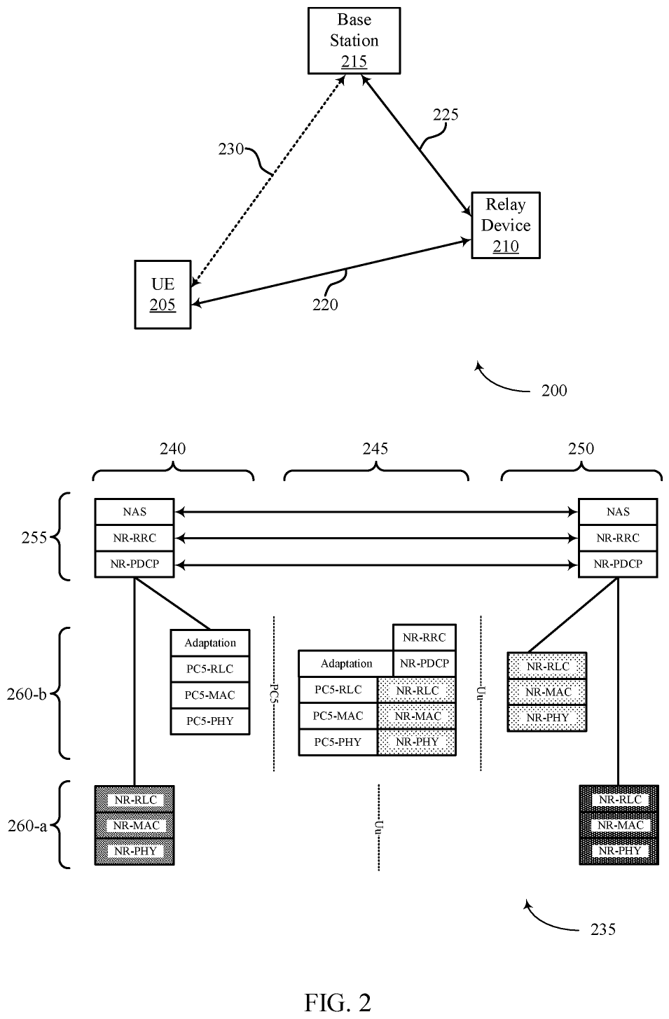

FIG. 2 illustrates an example of a wireless communications system 200 that supports power headroom reporting for sidelink communications in accordance with one or more aspects of the present disclosure. In some examples, wireless communications system 200 may implement aspects of wireless communications system 100. The wireless communications system 200 may support various examples of sidelink communications between a UE 205 and a base station 215 (e.g., via one or more relay devices, such as relay device 210), which may be examples of a UE 115 and a base station 105, respectively, as described with reference to FIG. 1. In some examples, the relay device 210 may be a relay UE (e.g., a second UE), and may also be an example of a UE 115 as described with reference to FIG. 1. In some examples, the relay device 210 may be an L2 relay device that supports relay communications according to an L2 portion of a communications protocol stack. Although the example of wireless communications system 200 illustrates a single relay device 210, the techniques described herein may be applicable to any quantity of relay devices between a UE 205 and a base station 215.

Wireless communications system 200 may implement various signaling techniques to support communications reliability and efficiency between devices in the system, including frequency signaling in relatively high frequency bands (e.g., in a radio frequency spectrum range, such as FR2). One such technique may include support of sidelink communications, where the UE 205 and base station 215 may establish a communication link including a sidelink via one or more relay devices, such as a relay device 210 or another relay node. Such a sidelink may refer to or otherwise include a communication link 220 (e.g., a D2D or other relay communication link between the UE 205 and the relay device 210, a PC5 link, a PC5 interface), or may refer to both a communication link 220 (e.g., a first relay communication link, a PC5 relay link, a PC5 interface) and a communication link 225 (e.g., second relay communication link, a Uu relay link, a Uu interface, a direct communication link between the relay device 210 and the base station 215). In some examples, a combination of a communication link 220 (e.g., a sidelink) and a communication link 225 (e.g., a direct link) may be referred to as a compound link. Additionally or alternatively, the UE 205 and base station 215 may establish a direct link via communication link 230 (e.g., a direct communication link between the UE 205 and the base station 215, a Uu direct link, a Uu interface).

In some examples, the wireless communications system 200 may support a dynamic selection or scheduling of communications via direct links and sidelinks (e.g., by the base station 215 or other scheduling entity). For example, in some cases, signal blockage, attenuation, or other interference may disrupt or impair a direct link (e.g., communication link 230) between the UE 205 and the base station 215, and the wireless communications system 200 may be configured to use a sidelink (e.g., communications via the relay device 210) to support communications between the UE 205 and the base station 215 (e.g., to maintain a link between the base station 215 and the UE 205). In such examples, for communication in an uplink direction, the UE 205 may transmit communications destined for the base station 215 to the relay device 210 (e.g., over the communication link 220), and the relay device 210 may forward the communications to the base station 215 (e.g., over the communication link 225). For communication in a downlink direction, the base station 215 may transmit communications destined for the UE 205 to the relay device 210 (e.g., over the communication link 225), and the relay device 210 may forward the communications to the UE 205 (e.g., over the communication link 220).

In some examples, sidelink communication techniques may be facilitated by the base station 215, or some other central scheduling entity, scheduling each of the communication link 220 and the communication link 230 (e.g., for uplink communications, downlink communications, or both uplink communications and downlink communications), and, in some cases, the communication link 225, which may include scheduling each communication link one-at-a-time (e.g., selecting one communication link or another for performing communications) or concurrently (e.g., allocating some communications to one communication link and other communications to another communication link). For example, based on its control of Uu interfaces, the base station 215 may have favorable insight on link selection, and thus may support relatively more-informed determinations related to sidelink or direct link scheduling.

In various examples, the base station 215 or other scheduling entity may schedule communications over the communication link 220 or the communication link 230 based on logical channel mapping, priority assignments for the communications, link quality, resource availability (e.g., TDD configurations, transmit and receive beam configuration, carrier frequencies), or various combinations thereof. In some examples, a sidelink, such as an L2 relay, may be associated with an adaptive MCS configuration and priority scheduling to adapt to changing channel conditions. In some examples, the base station 215 may perform a link selection or scheduling based on uplink and downlink considerations in aggregate, and select or schedule communications over the communication link 220 or the communication link 230 in a same or similar manner for both uplink and downlink communications (e.g., selecting one or the other of communication link 220 or communication link 230 for both uplink and downlink communications). In some examples, the base station 215 may perform a link selection or scheduling based on uplink and downlink considerations separately, which may include selecting different links for uplink and downlink communications, or otherwise configuring uplink communications and downlink communications in a different manner.

Thus, according to these and other examples, by supporting direct links and sidelinks, and reporting of conditions or characteristics thereof, the wireless communications system 200 may provide link diversity for communication link selection, communication link aggregation, or other techniques.

In some examples, the wireless communications system 200 may support a dual connectivity concept where the UE 205 and the base station 215 are each configured to support communications with two or more different nodes. For example, the UE 205 may be configured for communications with the base station 215 (e.g., via communication link 230) and the relay device 210 (e.g., via communication link 220), and the base station 215 may be configured for communications with the UE 205 (e.g., via communication link 230) and the relay device 210 (e.g., via communication link 225). In some examples, such dual connectivity may differ from certain carrier aggregation techniques because the dual connectivity between the UE and the base station 215 (e.g., via a direct link and a sidelink) may involve two simultaneous protocol stacks, or portions thereof.

The protocol map 235 illustrates an example of protocol stacks or layers that may be supported by the UE 205, the base station 215, and the relay device 210. For example, a protocol stack 240 may correspond to protocol layers of the UE 205, a protocol stack 245 may correspond to protocol layers of the relay device 210, and a protocol stack 250 may correspond to protocol layers of the base station 215. The protocol map 235 may apply to communications in an uplink direction, in a downlink direction, or both an uplink direction and a downlink direction.

In some examples, establishing a communication link between the base station 215 and the UE 205 may include establishing various protocol layer links between the devices. For example, upon or as part of establishing one or both of a direct link or a sidelink, the base station 215 and the UE 205 may establish upper layer links 255 (e.g., a network layer link, an L3 link) at each device, such as links between a NAS layer, an RRC layer (e.g., an NR-RRC layer), and a PDCP layer (e.g., an NR-PDCP layer) associated with each of the UE 205 (e.g., protocol stack 240) and the base station 215 (e.g., protocol stack 250). The upper layer links 255 between the UE 205 and the base station 215 may be supported by lower protocol layers (e.g., a data link layer or L2 layer, a physical layer or L1 layer), which may involve lower layer links 260 via a direct link, or a sidelink, or both a direct link and a sidelink. In some examples, an L2 portion of a lower layer link, or an L2 relay, may refer to a combination of a MAC layer and an RLC layer, or combination of a MAC layer, an RLC layer, and a PDCP layer.

In some examples, a lower layer link 260-a between the base station 215 and the UE 205 may be supported by a direct link (e.g., via communication link 230), which may refer to or include a Uu interface according to certain communication protocols. A lower layer link 260-a between the base station 215 and the UE 205 may include protocol layer links between an RLC layer (e.g., an NR-RLC layer), a MAC layer (e.g., an NR-MAC layer), and a physical (PHY) layer (e.g., an NR-PHY layer) associated with each of the UE 205 (e.g., protocol stack 240) and the base station 215 (e.g., protocol stack 250). Communications over the communication link 230 (e.g., the Uu interface between the UE 205 and the base station 215) may be supported by transmission and reception of wireless signaling associated with the NR-PHY layer (e.g., of the protocol stack 240 and the protocol stack 250).

In some examples, a lower layer link 260-b between the base station 215 and the UE 205 may be supported by a sidelink (e.g., via communication link 220, via communication link 220 and communication link 225), which may refer to or include a PC5 interface, or a combination of a PC5 interface and a Uu interface, according to certain communication protocols. For example, a first portion of a lower layer link 260-b between the base station 215 and the UE 205 (e.g., a portion supported by the communication link 220, a sidelink portion, a PC5 portion) may include protocol layer links between an RLC layer (e.g., a PC5-RLC layer), a MAC layer (e.g., a PC5-MAC layer), and a PHY layer (e.g., a PC5-PHY layer) associated with each of the UE 205 (e.g., protocol stack 240) and the relay device 210 (e.g., protocol stack 245). In some examples, the first portion may also include an adaptation layer link between the protocol stack 240 and the protocol stack 245. Communications over the communication link 220 (e.g., the PC5 interface between the UE 205 and the relay device 210) may be supported by transmission and reception of wireless signaling associated with the PC5-PHY layer (e.g., of the protocol stack 240 and the protocol stack 245). Although the lower layer link 260-b is illustrated and described in the context of a PC5 protocol, other protocols or interfaces may be implemented in a lower layer link 260-b such as a D2D interface, or a vehicle-to-everything (V2X) interface, among other interfaces

A second portion of a lower layer link 260-b between the base station 215 and the UE 205 (e.g., a portion supported by the communication link 225, a direct portion, a Uu portion) may include protocol layer links between an RLC layer (e.g., an NR-RLC layer), a MAC layer (e.g., an NR-MAC layer), and a PHY layer (e.g., an NR-PHY layer) associated with each of the relay device 210 (e.g., protocol stack 245) and the base station 215 (e.g., protocol stack 250). In some examples, the second portion may also include or be otherwise supported by one or both of an RRC layer link or a PDCP layer link between the protocol stack 245 and the protocol stack 250. Communications over the communication link 225 (e.g., the Uu interface between the relay device 210 and the base station 215) may be supported by transmission and reception of wireless signaling associated with the NR-PHY layer (e.g., of the protocol stack 245 and the protocol stack 250).

In some examples of uplink communications implementing an L2 relay configuration, the UE 205 may use PC5-PHY, PC5-MAC, and PC5-RLC layers to transmit packets through a PC5 interface to the relay device 210. In some examples, the adaptation layer of protocol stack 245 may relay the packets from the PC5-RLC, PC5-MAC, and PC5-PHY layers to the NR-RLC, NR-MAC, and NR-PHY layers, respectively, to support the relay device 210 transmitting the packets to the base station 215 over a Uu interface. In some implementations, the relay device 210 may receive a physical layer signal from the UE 205, and the relay device 210 may decode the physical layer signal in addition to MAC parameters and control signaling associated with the received signal. After decoding, the relay device 210 may re-encode the data and forward the signal to the base station 215.

In some examples of downlink communications implementing an L2 relay configuration, the base station 215 may use NR-PHY, NR-MAC, and NR-RLC layers to transmit packets through a Uu interface to the relay device 210. The packets may be relayed from the NR-RLC, NR-MAC, and NR-PHY layers to the PC5-RLC, PC5-MAC and PC5-PHY layers, respectively, to support the relay device 210 transmitting the packets to the UE 205 over a PC5 interface.

The wireless communications system 200, including the protocol map 235, may be configured to support various aspects of an L2 relay solution. For example, an NR-RRC layer may be configured as a controlling entity that configures both Uu and PC5 links (e.g., communication link 230, communication link 220, and communication link 225). In some examples, such a configuration may be supported by the base station 215 configuring both Uu and PC5 links (e.g., via the NR-RRC layer). In some examples, such techniques may support improvements to bearer-to-channel (e.g., logical channel) mapping and priority assignment, among other benefits.

In some examples, the wireless communications system 200 may be configured to support split-bearer PDCP functionality, which may be supported for both signaling and data bearers. For example, data transmissions may be split between carriers in the PDCP layer and additional layers of the protocol map 235. In some examples, such techniques may support improvements to link diversity or reliability, such as configuring various aspects of PDCP duplication.

In some examples, the wireless communications system 200 may support diverse techniques for radio link management. For example, the wireless communications system 200 may support radio link monitoring for each Uu interface and each PC5 interface (or other interface for a lower layer link 260-b). In some examples, a radio link failure between the base station 215 and the UE 205 may be declared when each link between the base station 215 and the UE 205 has failed, such as when the communication link 230 fails and when either the communication link 220 or the communication link 225 fails. In such examples, supporting a sidelink in a communication link between the base station 215 and the UE 205 (e.g., in a compound link) may increase link diversity and reduce radio link failure between the UE 205 and the base station 215, among other benefits.

According to some communications protocols, transmission configuration such as power control, MCS selection (e.g., from a configured range), or channel state information (CSI) reporting may be confined to those devices (e.g., UEs 115, UE 205 and relay device 210) that are engaged in sidelink or relayed communications, and power headroom reporting to a base station 105 or other central scheduling entity may not be provided. In other words, a base station 105 may not be provided with some information about sidelink communications, and may thus be limited in its ability to schedule communications between other devices (e.g., communications between the UE 205 and the relay device 210). However, to support the base station 215 providing enhanced control over sidelink management (e.g., for scheduling data to or from the UE 205 over a sidelink, or a direct link, or a combination thereof), it may be beneficial for sidelink PHRs (e.g., related to transmissions from the UE 205 to the relay device 210, related to transmissions from the relay device 210 to the UE 205 or another relay device 210, related to transmissions from a relay device 210 to the base station 215) to be provided to the base station 215. Accordingly, the wireless communications system 200 may support various techniques for sidelink power headroom reporting in accordance with examples as disclosed herein.

In some examples, the UE 205 may determine a power headroom associated with sidelink communications to the relay device 210 (e.g., communications in an uplink direction via the relay device 210, transmissions of the UE 205 via the communication link 220), and convey a sidelink PHR to indicate (e.g., to the base station 215) how much transmission power is available for the UE 205 beyond a power associated with an uplink transmission on the sidelink (e.g., a transmission to the relay device 210, a communication to the base station 215 via the communication link 220). Such power headroom reporting may allow the base station 215 to determine communications scheduling for the UE 205 in a manner that does not exceed a threshold transmission power of the UE 205, or in a manner that leverages various aspects of link diversity (e.g., scheduling communications over a direct link, over one or more sidelinks, or over various combinations of a direct link and one or more sidelinks), among other beneficial techniques.

In some examples, the relay device 210 may determine a power headroom associated with sidelink communications to the UE 205 (e.g., communications in a downlink direction to the UE 205, transmissions of the relay device 210 via the communication link 220), and convey a sidelink PHR to indicate (e.g., to the base station 215) how much transmission power is available for the relay device 210 beyond a power associated with downlink transmission on the sidelink (e.g., a transmission to the UE 205, a communication from the base station 215 via the communication link 220). Such power headroom reporting may allow the base station 215 to determine communications scheduling for the UE 205 or the relay device 210 in a manner that does not exceed a threshold transmission power of the relay device 210, or in a manner that leverages various aspects of link diversity (e.g., scheduling communications over a direct link, over one or more sidelinks, or over various combinations of a direct link and one or more sidelinks), among other beneficial techniques.

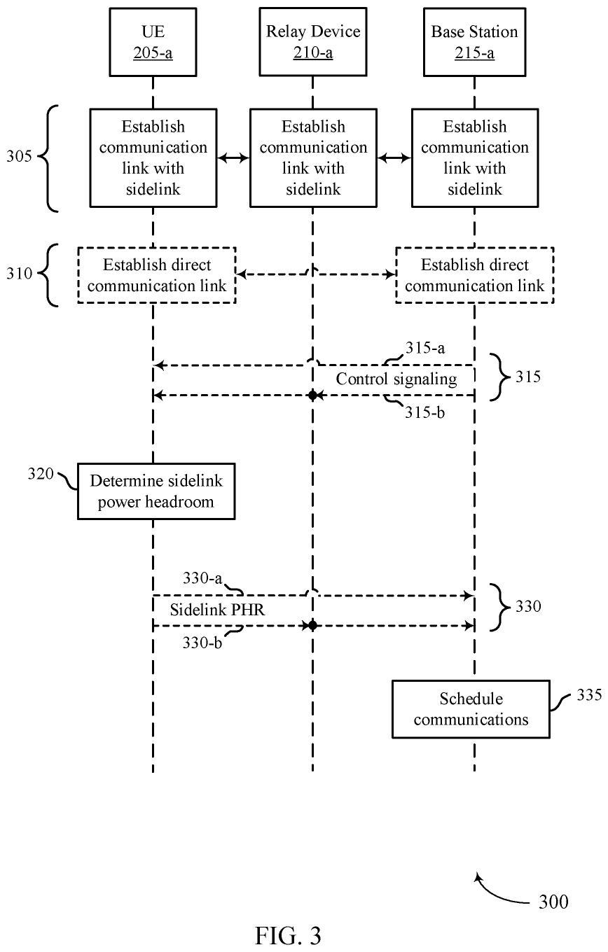

FIG. 3 illustrates an example of a process flow 300 that supports power headroom reporting for sidelink communications in accordance with one or more aspects of the present disclosure. In some examples, the process flow 300 may implement aspects of wireless communications systems 100 and 200. The process flow 300 may support various examples of power headroom reporting for sidelink communications between a UE 205-a (e.g., a target device, an endpoint device) and a base station 215-a via a relay device 210-a (e.g., an L2 relay, a relay UE 115). The UE 205-a, the relay device 210-a, and the base station 215-a may be examples of the respective devices described with reference to FIGS. 1 and 2.

The base station 215-a may schedule communications (e.g., uplink communications, or downlink communications, or uplink communications and downlink communications) of the UE 205-a and the relay device 210-a, including communications over direct links, sidelinks, or various combinations thereof. In some examples, the base station 215-a may schedule communications based on various factors such as channel conditions, resource availability, latency and reliability targets, transmission priority considerations, and others. In some examples, the base station 215-a may schedule communications based on transmission power considerations, such as transmission power capabilities or thresholds associated with the UE 205-a or the relay device 210-a, which may be supported by sidelink power headroom reporting from the UE 205-a in accordance with various examples as disclosed herein.

At 305, the UE 205-a and the base station 215-a may establish a communication link (e.g., a compound link) with a sidelink via the relay device 210-a (e.g., a sidelink between the UE 205-a and the relay device 210-a). In some examples, establishing the communication link may include establishing a PC5 link or interface, or other sidelink interface between the UE 205-a and the relay device 210-a. In some examples, establishing the communication link may include or accompany an establishment of a direct communication link (e.g., a Uu link or interface) between the relay device 210-a and the base station 215-a (e.g., where such a direct communication link was not previously established). In some examples, the relay device 210-a may be an L2 relay, and may support dual connectivity between the base station 215-a and the UE 205-a.

In some examples, at 310, the UE 205-a and the base station 215-a may establish a direct communication link (e.g., a Uu link or interface). Thus, in some examples, the UE 205-a and the base station 215-a may be simultaneously connected directly and via the relay device 210-a (e.g., through the sidelink) according to a dual connectivity configuration. Although illustrated as occurring after the establishment of a communication link with sidelink at 305, in various examples in accordance with the described techniques, the establishment of a direct communication link may occur before, after, or concurrently with the establishment of a communication link with sidelink between the UE 205-a and the base station 215-a, or the establishment of a direct communication link between the relay device 210-a and the base station 215-a.

In some examples, at 315, the base station 215-a may transmit control signaling (e.g., RRC signaling, RRC configuration signaling, an RRC configuration) to the UE 205-a. In various examples, such control signaling may be transmitted via the direct communication link (e.g., directly to the UE 205-a, according to 315-a), or via the communication link with sidelink (e.g., relayed through the relay device 210-a, according to 315-b), or some combination thereof. The control signaling may include an RRC message for configuring communications of the UE 205-a. In some cases, the control signaling may indicate information associated with power headroom reporting for sidelink communications of the UE 205-a. For example, the control signaling may configure various parameters used for determining a sidelink PHR, various indications for triggering generation of a sidelink PHR, various indications for reporting or indicating a sidelink PHR, and other PHR configuration information. In some examples, the base station 215-a may include a trigger in the control signaling of 315 that requests the UE 205-a to generate a sidelink PHR (e.g., based on the expiration of a timer, channel conditions, observer pathloss, MAC parameters, scheduled transmissions, or other criteria). Although illustrated as separate signaling, in some examples, the control signaling of 315 may accompany, or be included as part of communication link establishment (e.g., associated with the establishment of a communication link with sidelink at 305, associated with the establishment of a direct communication link at 310).

At 320, the UE 205-a may determine a sidelink power headroom, which may refer to a power headroom associated with transmissions from the UE 205-a to the relay device 210-a (e.g., uplink power headroom of the UE 205-a associated with transmissions over the established sidelink communication link). In some examples, the sidelink power headroom may be determined based at least in part on a transmission power capability of the UE 205-a, such as a difference between a power for transmitting an uplink transmission (e.g., a reference transmission) and a maximum transmission power capability of the UE 205-a (e.g., a UE maximum transmit power). For example, to determine a power headroom for the sidelink (e.g., how much power the UE 205-a has available in addition to the reference transmission), the UE 205-a may subtract a power associated with a reference transmission (e.g., to the relay device 210-a, in an uplink direction) from a total transmission power of the UE 205-a.

In some examples, a reference transmission for determining a power headroom may include a scheduled transmission (e.g., a transmission that has not yet been transmitted), such as an uplink or sidelink transmission from the UE 205-a to the relay device 210-a scheduled by the base station 215-a. In some examples, a reference transmission for determining a power headroom may include a previously-transmitted transmission, such as a last actual uplink or sidelink transmission from the UE 205-a to the relay device 210-a. In some examples, a reference transmission for determining a power headroom may include a virtual transmission (e.g., a calculated transmission that may or may not be transmitted), such as a hypothetical uplink or sidelink transmission from the UE 205-a to the relay device 210-a. For example, the UE 205-a may determine that no data transmission is scheduled to occur, or that no data transmission is ongoing, and a correspondence between a sidelink reference channel used for sidelink transmissions and the sidelink PHR may be established as a virtual reference. The UE 205-a may use accordingly use the virtual reference power value to determine the power headroom. In various examples, a reference transmission may include or refer to a physical channel transmission (e.g., a physical uplink shared channel (PUSCH) transmission), or a reference signal transmission (e.g., a sounding reference signal (SRS) transmission), or other types of transmission.

In some examples, the UE 205-a may determine power headroom on a per-beam basis. For example, the UE 205-a may determine a first sidelink power headroom associated with a first beam (e.g., a first transmission beam of the UE 205-a, a first reception beam of the relay device 210-a, or a combination thereof), and the UE 205-a may determine a second sidelink power headroom associated with a second beam (e.g., a second transmission beam of the UE 205-a, a second reception beam of the relay device 210-a, or a combination thereof). By reporting power headroom by beams, or combinations thereof, the UE 205-a may support enhanced control of beam selection, aggregation, or allocation by the base station 215-a.

The UE 205-a may generate a sidelink PHR based on the power headroom determined at 320. In some examples, a PHR may be included in or otherwise indicated by a MAC CE, which may, in some examples, be configured by way of control signaling from the base station 215-a (e.g., control signaling of 315, such as RRC configuration signaling). In some examples, such control signaling may allocate one or more fields of the MAC CE to power headroom reporting for the sidelink communication link. For example, one or more fields of a MAC CE for power headroom reporting may be designated by or allocated by serving cell, and a serving cell of the PHR MAC CE may be configured (e.g., via control signaling of 315) to be a serving cell that indicates the sidelink communication link between the UE 205-a and the relay device 210-a. Thus, the UE 205-a may identify (e.g., based on the control signaling of 315), a serving cell identifier associated with the sidelink communication link, and include indications of a sidelink PHR in one or more fields of the MAC CE that are associated with the identified serving cell identifier. In some examples, the UE 205-a may identify (e.g., based on control signaling of 315) a field of the MAC CE for identifying the sidelink communication link, and the UE 205-a may include an indicator of the sidelink communication link using the identified field. In some examples, a PHR MAC CE may be specific to or otherwise dedicated to transmitting the PHR for the sidelink communication link, or specific to uplink power headroom reporting, which may or may not be indicated by way of control signaling of 315. In some cases, the UE 205-a may generate separate PHR MAC CEs for the direct link power headroom reporting and the sidelink power headroom reporting based on the RRC configuration. In some cases, the UE 205-a may include power headroom reporting for a direct link (e.g., an uplink communications link with the base station 215-a) and one or more sidelinks in the same MAC CE.

In some examples, power headroom reporting may be included in a multiple entry PHR MAC CE, such as the example given in Table 1. The multiple entry PHR MAC CE may be identified by a MAC subheader, and may include a bitmap, a Type 2 power headroom field for a special cell (SpCell) and an octet containing the associated P_{CMAX,f,c} field (e.g., a configured maximum UE output power, if reported), a Type 1 power headroom field and an octet containing the associated P_{CMAX,f,c} field (e.g., if reported) for a primary cell (PCell). The multiple entry PHR MAC CE may also include, in ascending order based on serving cell index, one or multiple power headroom fields and octets containing the associated P_{CMAX,f,c} fields (e.g., if reported) for serving cells other than the primary cell indicated in the bitmap. In the example of Table 1, a Ci field may indicate a presence of a power headroom field, a V field may indicate whether the power headroom value is based on a real transmission or a reference format, a PH field may indicate a power headroom level, a P field may indicate whether power backoff is applied, a P_{CMAX,f,c} field may indicate a configured maximum power, and an R field may be reserved.

TABLE 1
Multiple entry PHR MAC CE for indicating power headroom

| | | | | | | | |
|---|---|---|---|---|---|---|---|
| C7 | C6 | C5 | C4 | C3 | C2 | C1 | R |

| | | |
|---|---|---|
| P | V | PH (Type 2, SpCell of the other MAC entity) |
| R | R | P_{CMAX, f, c} 1 |
| P | V | PH (Type 1, PCell) |
| R | R | P_{CMAX, f, c} 2 |
| P | V | PH (Type X, Serving Cell 1) |
| R | R | P_{CMAX, f, c} 3 |

. . .

| | | |
|---|---|---|
| P | V | PH (Type X, Serving Cell n) |
| R | R | P_{CMAX, f, c} m |

In some examples, the UE 205-a may configure or utilize a PHR MAC CE according to the RRC configuration to include a field that refers specifically to the sidelink communication link, or an uplink portion thereof. For example, a PHR MAC CE may include an additional field designated for the sidelink communication link, including an entry designated for the sidelink PHR (e.g., for an uplink PHR). In some cases, the configuration of the PHR MAC CE may specify a number of fields that refer to the direct link between the UE 205-a and the base station 215-a, and an additional number of fields that refer to the sidelink communication link between the UE 205-a and the relay device 210-a. In such cases, a sidelink PHR may have a designated location in the PHR MAC CE (e.g., according to a serving cell identifier associated with the sidelink communication link established at 305, such as one or more of Serving Cell 1 through Serving Cell n in Table 1). In some examples, the UE 205-a may configure a first entry of a MAC CE for power headroom reporting for a first beam, a second entry of the MAC CE for power headroom reporting for a second beam, and so on for a quantity of configured beams of beams (e.g., associating each beam with a respective serving cell identifier). In some examples, the UE 205-a may be configured to report an indicator of the sidelink communication link in a field of the MAC CE.

At 330, the UE 205-a may convey the PHR for the sidelink to the base station 215-a. In various examples, such PHR signaling may be transmitted via the direct communication link (e.g., directly to the UE 205-a, according to 330-a), or via the sidelink communication link (e.g., relayed through the relay device 210-a, according to 330-b), or some combination thereof.

In some examples, the UE 205-a may include a number of other signaling parameters in or otherwise accompanying the PHR, such as an MCS associated with transmissions from the UE 205-a to the relay device 210-a over the sidelink, or channel state information (e.g., a CSI report), among other control information. In some cases, if the PHR is provided to the base station 215-a along with an accompanying MCS, or if a reference MCS is used, sidelink CSI reports may not need to be provided to the base station 215-a (e.g., may be inhibited), which may improve spectral efficiency of the system. For example, based on a sidelink PHR, the base station 215-a may adjust the MCS, or a range of MCS, for a communication link between the UE 205-a and the relay device 210-a to use for transmission on the sidelink.

At 340, the base station 215-a may schedule communications for the UE 205-a based on the received PHR, among other parameters. In some examples, the base station 215-a may schedule uplink transmissions between the UE 205-a and the relay device 210-a, which may include uplink transmissions to be relayed by the relay device 210-a to the base station 215-a. In some examples, the scheduling at 340 may include determining whether to schedule communications on the communication link with sidelink established at 305, or on a direct communication link established at 310, or on a communication link with a sidelink established with another relay device 210 (not shown), or various combinations thereof (e.g., allocating communications to two or more communication links).

In some examples, to perform the scheduling at 335, the base station 215-a may identify a threshold power headroom value for scheduling communications (e.g., uplink communications) between the UE 205-a and the relay device 210-a. The base station 215-a may compare the reported power headroom from the PHR to the threshold power headroom, and determine how to configure communications, or whether to schedule communications, based on the comparison. For example, if the base station 215-a determines that the measured power headroom for the sidelink is above the threshold power headroom, the base station 215-a may schedule sidelink communications between the UE 205-a and the relay device 210-a (e.g., in an uplink direction) using the sidelink. In some examples, if the base station 215-a determines that the measured power headroom for the sidelink is below the threshold power headroom, the base station 215-a may schedule uplink communications for the UE 205-a on a direct communication link or another sidelink (e.g., with another relay device 210, not shown).

In some examples, the scheduling at 335 may include determining an MCS for transmissions using the sidelink communication link based at least in part on the PHR received at 330. In some examples, the scheduling at 335 may include scheduling or otherwise allocating communications to specific beams for communications on the sidelink established at 305, which may be based at least in part on receiving a PHR specific to one or more transmission beams of the UE 205-a. In some examples, the scheduling at 335 may be based at least in part on receiving an indication of an MCS associated with the transmission over the sidelink communication link, which may include a scheduling based on the indicated MCS that is in addition to, or as an alternative to, a determination based on a reported CSI (which may have been inhibited at the UE 205-a based on a reporting of accompanying MCS).

Although the techniques of the process flow 300 are illustrated in the context of a single relay device 210-a, the techniques may be applied to a communications system that includes more than one relay device 210 between the UE 205-a and the base station 215-a. For example, another relay device 210 may be configured between the UE 205-a and the relay device 210-a, and the other relay device may be configured to perform operations described with reference to the UE 205-a to support uplink power headroom reporting of the other relay device 210 (e.g., relative to transmissions in the uplink direction from the other relay device 210 to the relay device 210-a). In various examples, the base station 215-a may perform the communications scheduling of 335 base at least in part on uplink power headroom reporting by the relay device 210-a, one or more other relay devices 210, or various combinations thereof.

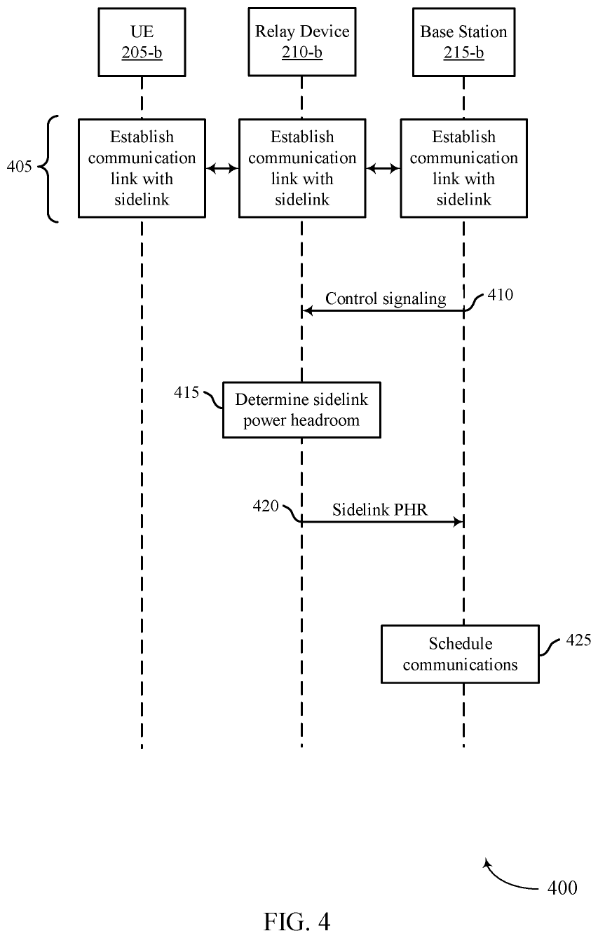

FIG. 4 illustrates an example of a process flow 400 that supports power headroom reporting for sidelink communications in accordance with one or more aspects of the present disclosure. In some examples, the process flow 400 may implement aspects of wireless communications systems 100 and 200. The process flow 400 may support various examples of power headroom reporting for sidelink communications between a UE 205-b (e.g., a target device, an endpoint device) and a base station 215-b via a relay device 210-b (e.g., an L2 relay, a relay UE 115). The UE 205-b, the relay device 210-b, and the base station 215-b may be examples of the respective devices described with reference to FIGS. 1 through 3.

The base station 215-b may schedule communications (e.g., uplink communications, or downlink communications, or uplink communications and downlink communications) of the UE 205-b and the relay device 210-b, including communications over direct links, sidelinks, or various combinations thereof. In some examples, the base station 215-b may schedule communications based on various factors such as channel conditions, resource availability, latency and reliability targets, transmission priority considerations, and others. In some examples, the base station 215-b may schedule communications based on transmission power considerations, such as transmission power capabilities or thresholds associated with the UE 205-b or the relay device 210-b, which may be supported by sidelink power headroom reporting from the relay device 210-b in accordance with various examples as disclosed herein.

At 405, the UE 205-b and the base station 215-b may establish a communication link (e.g., a compound link) with a sidelink via the relay device 210-b. In some examples, establishing the sidelink communication link may include establishing a PC5 link or interface, or other sidelink interface between the UE 205-b and the relay device 210-b. In some examples, establishing the communication link may include or accompany an establishment of a direct communication link (e.g., a Uu link or interface) between the relay device 210-b and the base station 215-b (e.g., where such a direct communication link was not previously established). In some examples, the relay device 210-b may be an L2 relay, and may support dual connectivity between the base station 215-b and the UE 205-b.

In some examples, at 410, the base station 215-b may transmit control signaling (e.g., RRC signaling, RRC configuration signaling, an RRC configuration) to the relay device 210-b. The control signaling may include an RRC message for configuring communications of the relay device 210-b. In some cases, the control signaling may indicate information associated with power headroom reporting for sidelink communications of the relay device 210-b. For example, the control signaling may configure various parameters used for determining a sidelink PHR, various indications for triggering generation of a sidelink PHR, various indications for reporting or indicating a sidelink PHR, and other PHR configuration information. In some examples, the base station 215-b may include a trigger in the control signaling of 410 that requests the relay device 210-b to generate a sidelink PHR (e.g., based on the expiration of a timer, channel conditions, observer pathloss, MAC parameters, scheduled transmissions, or other criteria). Although illustrated as separate signaling, in some examples, the control signaling of 410 may accompany, or be included as part of communication link establishment (e.g., associated with the establishment of a communication link with sidelink at 405).

At 415, the relay device 210-b may determine a sidelink power headroom, which may refer to a power headroom associated with transmissions from the relay device 210-b to the UE 205-b (e.g., downlink power headroom for the relay device 210-a associated with transmissions over the established sidelink communication link). In some examples, the sidelink power headroom may be determined based at least in part on a transmission power capability of the relay device 210-b, such as a difference between a power for transmitting a downlink transmission (e.g., a reference transmission) and a maximum transmission power capability of the relay device 210-b (e.g., a relay device maximum transmit power). For example, to determine a power headroom for the sidelink (e.g., how much power the relay device 210-b has available in addition to the reference transmission), the relay device 210-b may subtract a power associated with a reference transmission (e.g., to the UE 205-b) from a total transmission power of the relay device 210-b.

In some examples, a reference transmission for determining a power headroom may include a scheduled transmission (e.g., a transmission that has not yet been transmitted), such as a downlink or sidelink transmission from the relay device 210-b to the UE 205-b scheduled by the base station 215-b. In some examples, a reference transmission for determining a power headroom may include a previously-transmitted transmission, such as a last actual downlink or sidelink transmission from the relay device 210-b to the UE 205-b. In some examples, a reference transmission for determining a power headroom may include a virtual transmission (e.g., a calculated transmission that may or may not be transmitted), such as a hypothetical downlink or sidelink transmission from the relay device 210-b to the UE 205-b. For example, the relay device 210-b may determine that no data transmission is scheduled to occur, or that no data transmission is ongoing, and a correspondence between a sidelink reference channel used for sidelink transmissions and the sidelink PHR may be established as a virtual reference. The relay device 210-b may use accordingly use the virtual reference power value to determine the power headroom. In various examples, a reference transmission may include or refer to a physical channel transmission (e.g., a physical downlink shared channel (PDSCH) transmission), or a reference signal transmission (e.g., a cell-specific reference signal, a UE-specific reference signal, a synchronization reference signal), or other types of transmission.

In some examples, the relay device 210-b may determine power headroom on a per-beam basis. For example, the relay device 210-b may determine a first sidelink power headroom associated with a first beam (e.g., a first transmission beam of the relay device 210-b, a first reception beam of the UE 205-b, or a combination thereof), and the relay device 210-b may determine a second sidelink power headroom associated with a second beam (e.g., a second transmission beam of the relay device 210-b, a second reception beam of the UE 205-b, or a combination thereof). By reporting power headroom by beams, or combinations thereof, the relay device 210-b may support enhanced control of beam selection, aggregation, or allocation by the base station 215-b.

The relay device 210-b may generate a sidelink PHR based on the power headroom determined at 415. In some examples, a PHR may be included in or otherwise indicated by a MAC CE, which may, in some examples, be configured by way of control signaling from the base station 215-b (e.g., control signaling of 410, such as RRC configuration signaling). In some examples, such control signaling may allocate one or more fields of the MAC CE to power headroom reporting for the sidelink communication link. For example, one or more fields of a MAC CE for power headroom reporting may be designated by or allocated by serving cell, and a serving cell of the PHR MAC CE may be configured (e.g., via control signaling of 410) to be a serving cell that indicates the sidelink communication link between the relay device 210-b and the UE 205-b. Thus, the relay device 210-b may identify (e.g., based on the control signaling of 410), a serving cell identifier associated with the sidelink communication link, and include indications of a sidelink PHR in one or more fields of the MAC CE that are associated with the identified serving cell identifier. In some examples, the relay device 210-b may identify (e.g., based on control signaling of 410) a field of the MAC CE for identifying the sidelink communication link, and the relay device 210-b may include an indicator of the sidelink communication link using the identified field. In some examples, a PHR MAC CE may be specific to or otherwise dedicated to transmitting the PHR for the sidelink communication link, or specific to downlink power headroom reporting, which may or may not be indicated by way of control signaling of 410. In some cases, the relay device 210-b may generate separate PHR MAC CEs for the direct link power headroom reporting (e.g., power headroom reporting related to a direct or uplink connection with the base station 215-b) and the sidelink power headroom reporting (e.g., power headroom reporting related to a sidelink or downlink connection with the UE 205-b) based on the RRC configuration. In some cases, the relay device 210-b may include power headroom reporting for a direct link (e.g., an uplink connection with the base station 215-a) and one or more sidelinks (e.g., a downlink connection with the UE 205-b, an uplink or downlink connection with another relay device 210, not shown) in the same MAC CE. In some examples, power headroom reporting may be included in a multiple entry PHR MAC CE, such as the example given in Table 1.

In some examples, the relay device 210-b may configure or utilize a PHR MAC CE according to the RRC configuration to include a field that refers specifically to the sidelink communication link, or a downlink portion thereof. For example, a PHR MAC CE may include an additional field designated for the sidelink communication link, including an entry designated for the sidelink PHR (e.g., for a downlink PHR). In some cases, the configuration of the PHR MAC CE may specify a number of fields that refer to the direct link between the relay device 210-b and the base station 215-b, and an additional number of fields that refer to the sidelink communication link between the UE 205-b and the relay device 210-b. In such cases, a sidelink PHR may have a designated location in the PHR MAC CE (e.g., according to a serving cell identifier associated with the sidelink communication link established at 405). In some examples, the relay device 210-b may configure a first entry of a MAC CE for power headroom reporting for a first beam, a second entry of the MAC CE for power headroom reporting for a second beam, and so on for a quantity of configured beams of beams (e.g., associating each beam with a respective serving cell identifier). In some examples, the relay device 210-b may be configured to report an indicator of the sidelink communication link in a field of the MAC CE.

At 420, the relay device 210-b may convey the PHR for the sidelink to the base station 215-b. In some examples, the relay device 210-b may include a number of other signaling parameters in or otherwise accompanying the PHR, such as an MCS associated with transmissions from the relay device 210-b to the UE 205-b over the sidelink, or channel state information (e.g., a CSI report), among other control information. In some cases, if the PHR is provided to the base station 215-b along with an accompanying MCS, or if a reference MCS is used, sidelink CSI reports may not need to be provided to the base station 215-b (e.g., may be inhibited), which may improve spectral efficiency of the system. For example, based on a sidelink PHR, the base station 215-b may adjust the MCS, or a range of MCS, for a communication link between the UE 205-b and the relay device 210-b to use for transmission on the sidelink.

At 425, the base station 215-b may schedule communications for the UE 205-b or the relay device 210-b based on the received PHR, among other parameters. In some examples, the base station 215-b may schedule downlink transmissions between the base station 215-b and the relay device 210-b, which may include downlink transmissions to be relayed by the relay device 210-b to the UE 205-b. In some examples, the scheduling at 425 may include determining whether to schedule communications on the sidelink communication link established at 405, or on a direct communication link (not shown), or on a sidelink communication link established with another relay device 210 (not shown), or various combinations thereof (e.g., allocating communications to two or more communication links).

In some examples, to perform the scheduling at 425, the base station 215-b may identify a threshold power headroom value for scheduling communications (e.g., downlink communications) between the relay device 210-b and the UE 205-b. The base station 215-b may compare the reported power headroom from the PHR to the threshold power headroom, and determine how to configure communications, or whether to schedule communications, based on the comparison. For example, if the base station 215-b determines that the measured power headroom for the sidelink is above the threshold power headroom, the base station 215-b may schedule sidelink communications between the relay device 210-b and the UE 205-b using the sidelink (e.g., in a downlink direction). In some examples, if the base station 215-b determines that the measured power headroom for the sidelink is below the threshold power headroom, the base station 215-b may schedule downlink communications for the UE 205-b on a direct communication link or another sidelink (e.g., with another relay device 210, not shown).

In some examples, the scheduling at 425 may include determining an MCS for transmissions using the sidelink communication link based at least in part on the PHR received at 420. In some examples, the scheduling at 425 may include scheduling or otherwise allocating communications to specific beams for communications on the sidelink established at 405, which may be based at least in part on receiving a PHR specific to one or more transmission beams of the relay device 210-b. In some examples, the scheduling at 425 may be based at least in part on receiving an indication of an MCS associated with the transmission over the sidelink communication link, which may include a scheduling based on the indicated MCS that is in addition to, or as an alternative to, a determination based on a reported CSI (which may have been inhibited at the relay device 210-b based on a reporting of accompanying MCS).

Although the techniques of the process flow 400 are illustrated in the context of a single relay device 210-b, the techniques may be applied to a communications system that includes more than one relay device 210 between the base station 215-b and the UE 205-b. For example, another relay device 210 may be configured between the relay device 210-b and the UE 205-b, and the referred-to power headroom of 415 may refer to transmissions from the relay device 210-b to the other relay device 210. In various examples, the base station 215-b may perform the communications scheduling of 425 base at least in part on downlink power headroom reporting by the relay device 210-b, one or more other relay devices 210, or various combinations thereof.

Although the techniques of process flow 300 and process flow 400 are illustrated separately, such techniques may be applied in combination. For example, a base station 215 may receive uplink power headroom reporting from a UE 205 and one or more relay devices 210, and downlink power headroom reporting from one or more relay devices 210, and perform communications scheduling based at least in part on the received power headroom reporting. In some examples, a base station 215 may receive uplink power headroom reporting from multiple devices corresponding to one or more sidelink communication links with a UE 205, or a direct communication link with the UE 205, and the base station 215 may select one or more of the communication links for uplink communications, or otherwise configure one or more of the communication links for uplink communications, based on the uplink power headroom reporting. Additionally or alternatively, in some examples, a base station 215 may receive downlink power headroom reporting from multiple devices corresponding to one or more sidelink communication links with a UE 205, or a direct communication link with the UE 205, and the base station 215 may select one or more of the communication links for downlink communications, or otherwise configure one or more of the communication links for downlink communications, based on the downlink power headroom reporting. In some examples, a base station 215 may select one or more of the communication links, or otherwise configure one or more of the communication links, based on jointly considering uplink and downlink power headroom reporting.

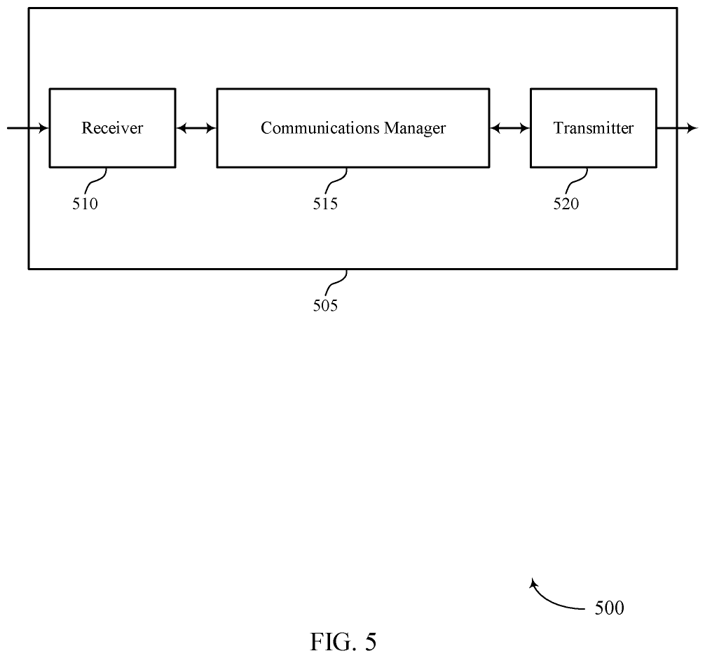

FIG. 5 shows a block diagram 500 of a device 505 that supports power headroom reporting for sidelink with L2 relays in accordance with one or more aspects of the present disclosure. The device 505 may be an example of aspects of a UE 115 as described herein. The device 505 may include a receiver 510, a communications manager 515, and a transmitter 520. The device 505 may also include a processor. Each of these components may be in communication with one another (e.g., via one or more buses).

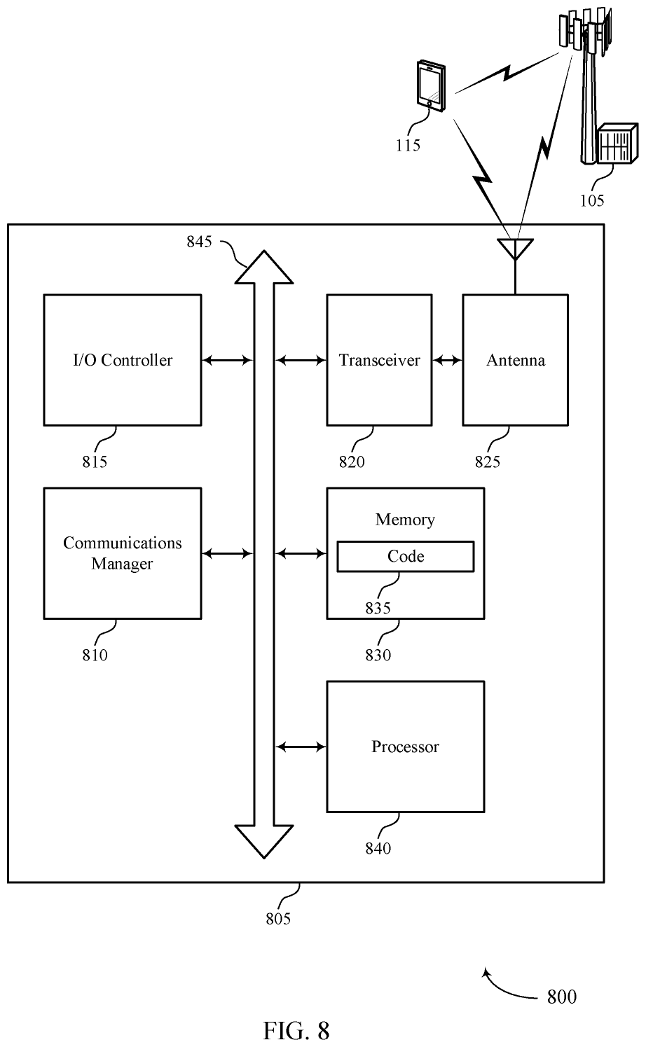

The receiver 510 may receive information such as packets, user data, or control information associated with various information channels (e.g., control channels, data channels, and information related to power headroom reporting for sidelink with L2 relays, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may establish, at a first UE, a sidelink communication link with a base station via a second UE, determine a power headroom associated with transmissions from the first UE to the second UE using the sidelink communication link, where determining the power headroom is based on a transmission power capability of the first UE, and convey, to the base station, a PHR for the sidelink communication link based on the determined power headroom associated with the transmissions from the first UE to the second UE over the sidelink communication link. The communications manager 515 may be an example of aspects of the communications manager 810 described herein.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

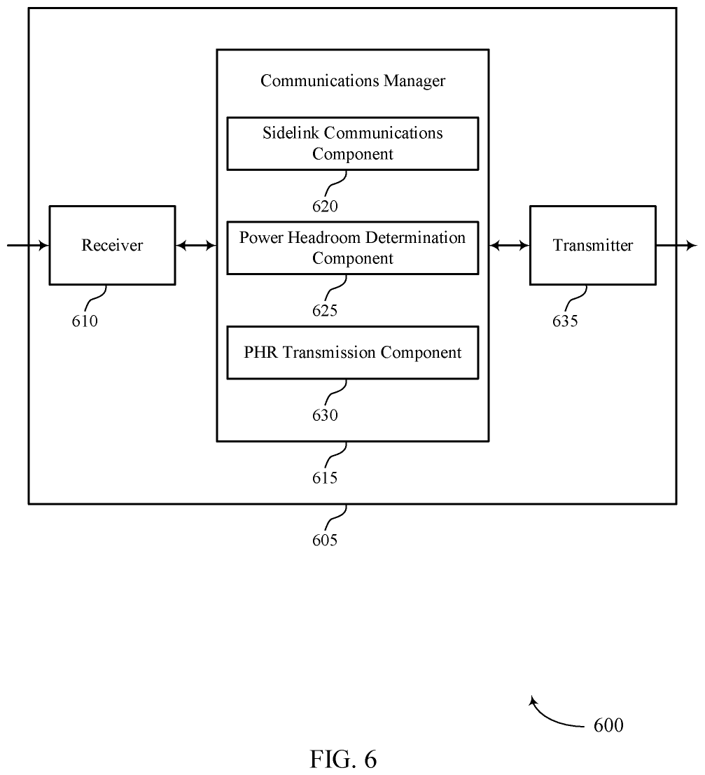

FIG. 6 shows a block diagram 600 of a device 605 that supports power headroom reporting for sidelink with L2 relays in accordance with one or more aspects of the present disclosure. The device 605 may be an example of aspects of a device 505, or a UE 115 as described herein. The device 605 may include a receiver 610, a communications manager 615, and a transmitter 635. The device 605 may also include a processor. Each of these components may be in communication with one another (e.g., via one or more buses).

The receiver 610 may receive information such as packets, user data, or control information associated with various information channels (e.g., control channels, data channels, and information related to power headroom reporting for sidelink with L2 relays, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include a sidelink communications component 620, a power headroom determination component 625, and a PHR transmission component 630. The communications manager 615 may be an example of aspects of the communications manager 810 described herein.

The sidelink communications component 620 may establish, at a first UE, a sidelink communication link with a base station via a second UE.

The power headroom determination component 625 may determine a power headroom associated with transmissions from the first UE to the second UE using the sidelink communication link, where determining the power headroom is based on a transmission power capability of the first UE.

The PHR transmission component 630 may convey, to the base station, a PHR for the sidelink communication link based on the determined power headroom associated with the transmissions from the first UE to the second UE over the sidelink communication link.

The transmitter 635 may transmit signals generated by other components of the device 605. In some examples, the transmitter 635 may be collocated with a receiver 610 in a transceiver module. For example, the transmitter 635 may be an example of aspects of the transceiver 820 described with reference to FIG. 8. The transmitter 635 may utilize a single antenna or a set of antennas.

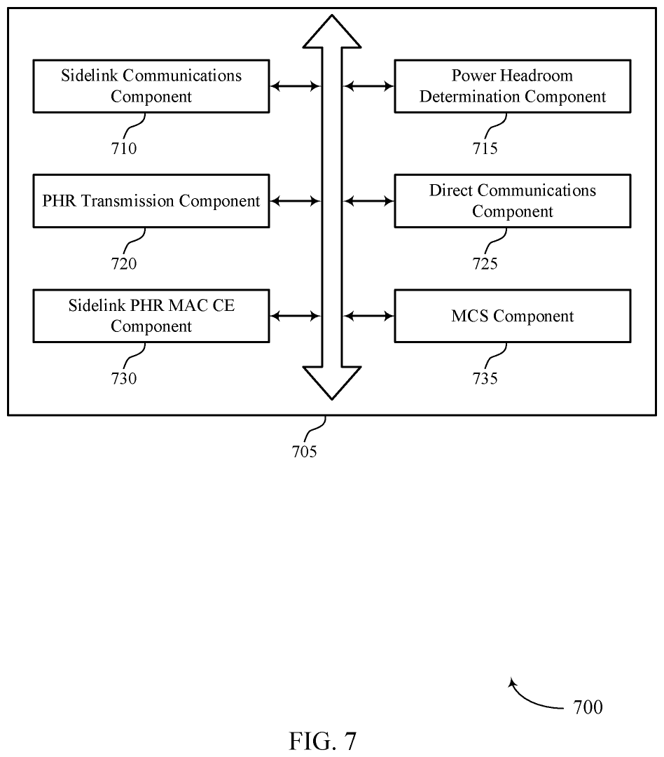

FIG. 7 shows a block diagram 700 of a communications manager 705 that supports power headroom reporting for sidelink with L2 relays in accordance with one or more aspects of the present disclosure. The communications manager 705 may be an example of aspects of a communications manager 515, a communications manager 615, or a communications manager 810 described herein. The communications manager 705 may include a sidelink communications component 710, a power headroom determination component 715, a PHR transmission component 720, a direct communications component 725, a sidelink PHR MAC CE component 730, and a MCS component 735. Each of these components may communicate, directly or indirectly, with one another (e.g., via one or more buses).

The sidelink communications component 710 may establish, at a first UE, a sidelink communication link with a base station via a second UE.

The power headroom determination component 715 may determine a power headroom associated with transmissions from the first UE to the second UE using the sidelink communication link, where determining the power headroom is based on a transmission power capability of the first UE.

In some examples, the power headroom determination component 715 may determine the power headroom based on a scheduled uplink transmission from the first UE to the second UE. In some examples, the power headroom determination component 715 may determine the power headroom based on a previously transmitted uplink transmission from the first UE to the second UE. In some other examples, the power headroom determination component 715 may determine the power headroom based on a virtual reference uplink transmission from the first UE to the second UE.

In some examples, the power headroom determination component 715 may determine the power headroom associated with transmissions over a first transmission beam of the sidelink communication link, and determine a second power headroom associated with the transmissions from the first UE to the second UE over a second transmission beam of the sidelink communication link.

The PHR transmission component 720 may convey, to the base station, a PHR for the sidelink communication link based on the determined power headroom associated with the transmissions from the first UE to the second UE over the sidelink communication link. In some examples, the sidelink communications component 710 may support transmitting the PHR for the sidelink communication link to the second UE using the sidelink communication link.

In some examples, the direct communications component 725 may establish, at the first UE, a direct communication link with the base station. In some examples, the direct communications component 725 may support transmitting the PHR for the sidelink communication link to the base station using the direct communication link.

In some examples, the PHR transmission component 720 may convey, to the base station, a first PHR for the sidelink communication link based on determining a first power headroom associated with transmissions over a first transmission beam of the sidelink communication link, and a second PHR for the sidelink communication link based on determining a second power headroom associated with the transmissions over a second transmission beam of the sidelink communication link.

In some examples, the sidelink PHR MAC CE component 730 may transmit the PHR for the sidelink communication link in a MAC CE. In some examples, the sidelink PHR MAC CE component 730 may receive an RRC configuration allocating a field of the MAC CE to power headroom reporting for the sidelink communication link, and transmit the PHR in the allocated field of the MAC CE. In some examples, the sidelink PHR MAC CE component 730 may identify, based on the RRC configuration, a serving cell identifier associated with the sidelink communication link, and transmit the PHR in the field of the MAC CE associated with the serving cell identifier. In some examples, the sidelink PHR MAC CE component 730 may identify, based on the RRC configuration, a second field of the MAC CE for identifying the sidelink communication link, and transmit an indicator of the sidelink communication link using the second field of the MAC CE. In some cases, the MAC CE may be dedicated for sidelink power headroom reporting. In some examples, the sidelink PHR MAC CE component 730 may transmit a PHR for a direct communication link with the base station in the same MAC CE as a sidelink PHR.

In some examples, the MCS component 735 may identify a MCS associated with the transmission from the first UE to the second UE using the sidelink communication link. In some examples, the PHR transmission component 720 may transmit, to the base station, an indication of the identified MCS with the PHR for the sidelink communication link.

FIG. 8 shows a diagram of a system 800 including a device 805 that supports power headroom reporting for sidelink with L2 relays in accordance with one or more aspects of the present disclosure. The device 805 may be an example of or include the components of device 505, device 605, or a UE 115 as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include random access memory (RAM), read-only memory (ROM), or a combination thereof. The memory 830 may store computer-readable, computer-executable code 835 including instructions that, when executed, cause the processor to perform various functions described herein. In some cases, the memory 830 may contain, among other things, a basic input/output system (BIOS) which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting power headroom reporting for sidelink with L2 relays).

The code 835 may include instructions to implement one or more aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

The communications manager 810 may be configured to support various aspects of sidelink power headroom reporting in accordance with examples as disclosed herein. For example, the communications manager 810 may establish a sidelink communication link with a base station (e.g., a base station 105) via a second UE (e.g., a UE 115, a relay device), determine a power headroom associated with transmissions from the device 805 to the second UE using the sidelink communication link, where determining the power headroom is based on a transmission power capability of the device 805, and convey, to the base station, a PHR for the sidelink communication link based on the determined power headroom associated with the transmissions from the device 805 to the second UE over the sidelink communication link.

By supporting various aspects of sidelink power headroom reporting, the device 805 may support improved connectivity within the system 800 (e.g., with a base station 105), and improved allocation of communications resources and spectral efficiency of the system 800. For example, by reporting sidelink power headroom, the device 805 may support determinations of the system 800 (e.g., of a base station 105) for scheduling communications of the device 805 in a manner that does not exceed a threshold transmission power of the device 805, or in a manner that leverages various aspects of link diversity (e.g., scheduling communications over a direct link, over one or more sidelinks, or over various combinations of a direct link and one or more sidelinks), or reduces occurrences of radio link failure between the device 805 and the system 800, among other beneficial techniques.

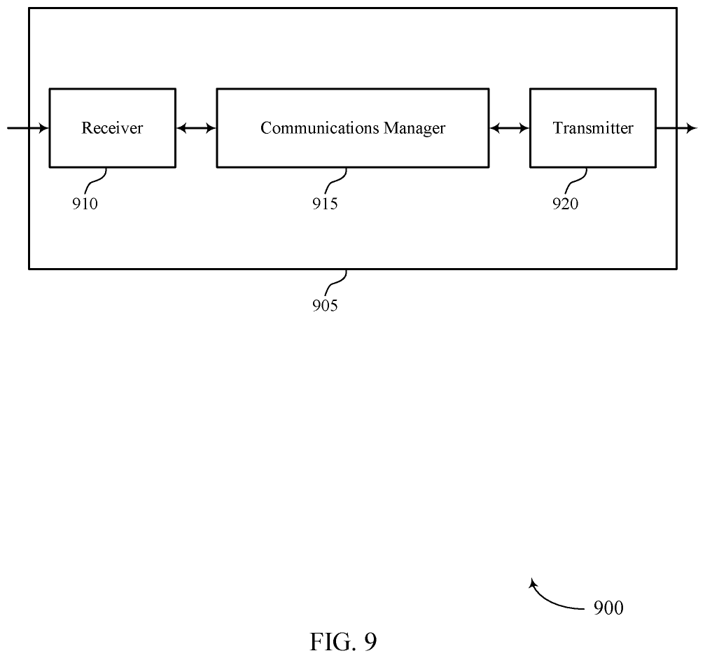

FIG. 9 shows a block diagram 900 of a device 905 that supports power headroom reporting for sidelink with L2 relays in accordance with one or more aspects of the present disclosure. The device 905 may be an example of aspects of a base station 105 as described herein. The device 905 may include a receiver 910, a communications manager 915, and a transmitter 920. The device 905 may also include a processor. Each of these components may be in communication with one another (e.g., via one or more buses).

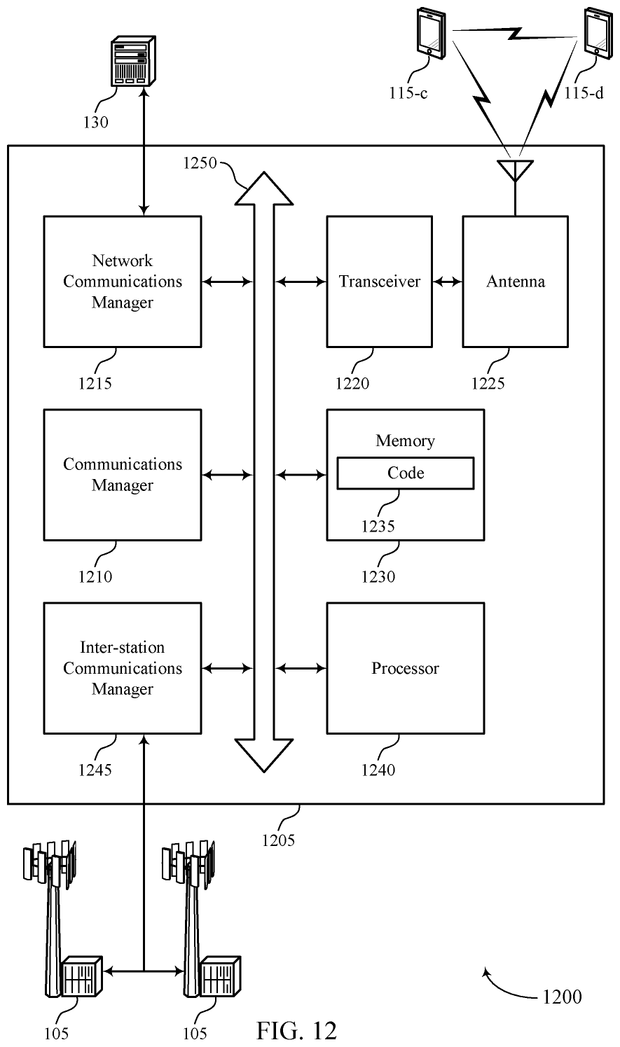

The receiver 910 may receive information such as packets, user data, or control information associated with various information channels (e.g., control channels, data channels, and information related to power headroom reporting for sidelink with L2 relays, etc.). Information may be passed on to other components of the device 905. The receiver 910 may be an example of aspects of the transceiver 1220 described with reference to FIG. 12. The receiver 910 may utilize a single antenna or a set of antennas.

The communications manager 915 may establish, at a base station, a sidelink communication link with a first UE via a second UE, receive, at the base station, a PHR for the sidelink communication link, the PHR associated with transmission from the first UE to the second UE over the sidelink communication link, and schedule communications with the first UE based on receiving the PHR for the sidelink communication link. The communications manager 915 may be an example of aspects of the communications manager 1210 described herein.

The communications manager 915, or its sub-components, may be implemented in hardware, code (e.g., software or firmware) executed by a processor, or any combination thereof. If implemented in code executed by a processor, the functions of the communications manager 915, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 915, or its sub-components, may be physically located at various positions, including being distributed such that portions of functions are implemented at different physical locations by one or more physical components. In some examples, the communications manager 915, or its sub-components, may be a separate and distinct component in accordance with various aspects of the present disclosure. In some examples, the communications manager 915, or its sub-components, may be combined with one or more other hardware components, including but not limited to an I/O component, a transceiver, a network server, another computing device, one or more other components described in the present disclosure, or a combination thereof in accordance with various aspects of the present disclosure.

The transmitter 920 may transmit signals generated by other components of the device 905. In some examples, the transmitter 920 may be collocated with a receiver 910 in a transceiver module. For example, the transmitter 920 may be an example of aspects of the transceiver 1220 described with reference to FIG. 12. The transmitter 920 may utilize a single antenna or a set of antennas.

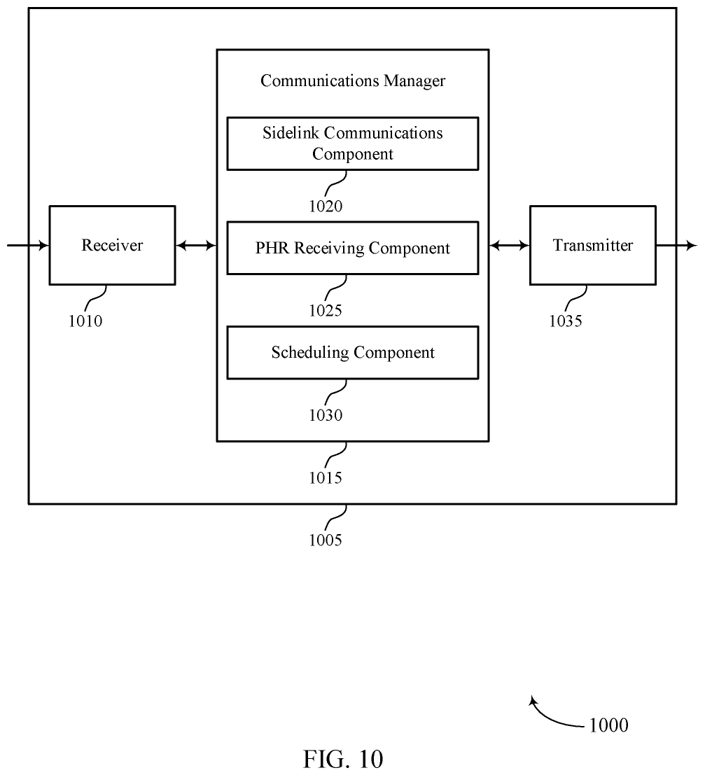

FIG. 10 shows a block diagram 1000 of a device 1005 that supports power headroom reporting for sidelink with L2 relays in accordance with one or more aspects of the present disclosure. The device 1005 may be an example of aspects of a device 905, or a base station 105 as described herein. The device 1005 may include a receiver 1010, a communications manager 1015, and a transmitter 1035. The device 1005 may also include a processor. Each of these components may be in communication with one another (e.g., via one or more buses).

The receiver 1010 may receive information such as packets, user data, or control information associated with various information channels (e.g., control channels, data channels, and information related to power headroom reporting for sidelink with L2 relays, etc.). Information may be passed on to other components of the device 1005. The receiver 1010 may be an example of aspects of the transceiver 1220 described with reference to FIG. 12. The receiver 1010 may utilize a single antenna or a set of antennas.

The communications manager 1015 may be an example of aspects of the communications manager 915 as described herein. The communications manager 1015 may include a sidelink communications component 1020, a PHR receiving component 1025, and a scheduling component 1030. The communications manager 1015 may be an example of aspects of the communications manager 1210 described herein.

The sidelink communications component 1020 may establish, at a base station, a sidelink communication link with a first UE via a second UE.

The PHR receiving component 1025 may receive, at the base station, a PHR for the sidelink communication link, the PHR associated with transmission from the first UE to the second UE over the sidelink communication link.

The scheduling component 1030 may schedule communications with the first UE based on receiving the PHR for the sidelink communication link.

The transmitter 1035 may transmit signals generated by other components of the device 1005. In some examples, the transmitter 1035 may be collocated with a receiver 1010 in a transceiver module. For example, the transmitter 1035 may be an example of aspects of the transceiver 1220 described with reference to FIG. 12. The transmitter 1035 may utilize a single antenna or a set of antennas.

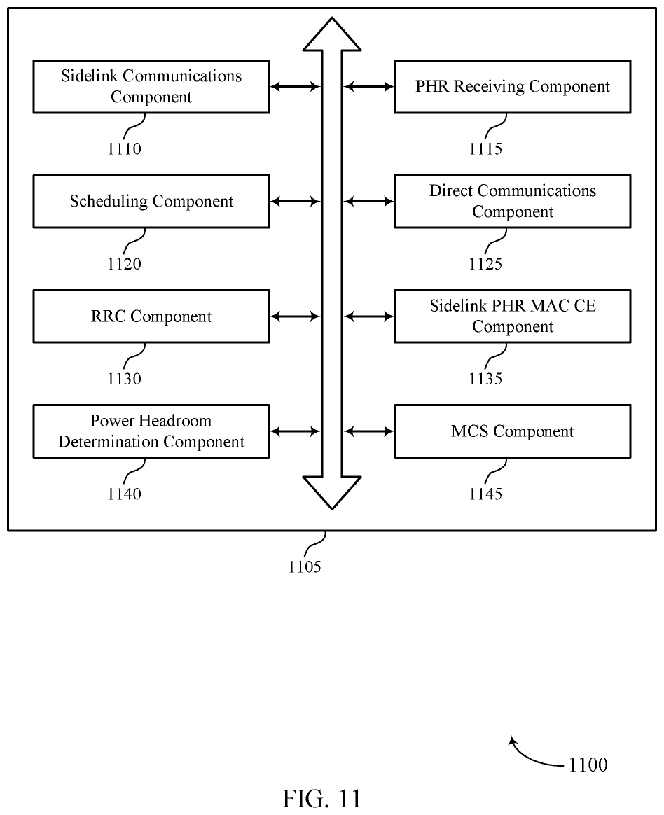

FIG. 11 shows a block diagram 1100 of a communications manager 1105 that supports power headroom reporting for sidelink with L2 relays in accordance with one or more aspects of the present disclosure. The communications manager 1105 may be an example of aspects of a communications manager 915, a communications manager 1015, or a communications manager 1210 described herein. The communications manager 1105 may include a sidelink communications component 1110, a PHR receiving component 1115, a scheduling component 1120, a direct communications component 1125, an RRC component 1130, a sidelink PHR MAC CE component 1135, a power headroom determination component 1140, and a MCS component 1145. Each of these components may communicate, directly or indirectly, with one another (e.g., via one or more buses).

The sidelink communications component 1110 may establish, at a base station, a sidelink communication link with a first UE via a second UE.

The PHR receiving component 1115 may receive, at the base station, a PHR for the sidelink communication link, the PHR associated with transmission from the first UE to the second UE over the sidelink communication link. In some examples, the sidelink communications component 1110 may support receiving the PHR for the sidelink communication link from the second UE using the sidelink communication link.

In some examples, the direct communications component 1125 may establish, at the base station, a direct communication link with the first UE. In some examples, the direct communications component 1125 may support receiving the PHR for the sidelink communication link using the direct communication link.

In some examples, the PHR receiving component 1115 may receive a first PHR associated with transmission over a first transmission beam of the sidelink communication link, and receive a second PHR associated with transmission over a second transmission beam of the sidelink communication link.

The scheduling component 1120 may schedule communications with the first UE based on receiving the PHR for the sidelink communication link. In some examples, the scheduling component 1120 may determine to schedule communications over the sidelink communication link or a direct communication link (e.g., a selection of one or the other, an allocation of communications between one of the other, or both) based on comparing the received PHR to the threshold power headroom value.

In some examples, the scheduling component 1120 may schedule communications with the first UE based on a first PHR associated with transmission over a first transmission beam of the sidelink communication link and a second PHR associated with transmission over a second transmission beam of the sidelink communication link.

In some examples, The RRC component 1130 may identify, based on establishing the sidelink communication link, an RRC configuration for configuring a MAC control CE for the PHR for the sidelink communication link. In some examples, the RRC component 1130 may transmit the identified RRC configuration to the first UE. In some examples, the sidelink PHR MAC CE component 1135 may receive the PHR for the sidelink communication link in the MAC CE based on the transmitting of the identified RRC configuration. In some examples, to receive the PHR for the sidelink communication link in the MAC CE, the sidelink PHR MAC CE component 1135 may receive an indicator of the sidelink communication link using a second field of the MAC CE.

In some examples, the sidelink PHR MAC CE component 1135 may allocate, based on identifying the RRC configuration, a field of the MAC CE for power headroom reporting for the sidelink communication link. In some examples, the RRC component 1130 may transmit an indication of the allocated field of the MAC CE based on allocating the field of the MAC CE, and the PHR receiving component 1115 may receive the PHR for the sidelink communication link based on the transmitting of the indication of the allocated field of the MAC CE. In some examples, to transmit the indication of the allocated field of the MAC CE, the sidelink PHR MAC CE component 1135 may transmit a serving cell identifier associated with the sidelink communication link. In some examples, to identify the RRC configuration, the sidelink PHR MAC CE component 1135 may identify a configuration for configuring a MAC CE dedicated for sidelink power headroom reporting. In some examples, the sidelink PHR MAC CE component 1135 may transmit an indication of a second field of the MAC CE allocated for identifying the sidelink communication link. In some examples, the sidelink PHR MAC CE component 1135 may receive a PHR for a direct communication link with the first UE in the same MAC CE as a sidelink PHR (e.g., based at least in part on transmitting the identified RRC configuration).

In some examples, the power headroom determination component 1140 may identify a threshold power headroom value for scheduling uplink transmissions from the first UE to the second UE over the sidelink communication link, and the scheduling component 1120 may schedule the communications with the first UE based on comparing the received PHR to the threshold power headroom value.

In some examples, the MCS component 1145 may determine an MCS for transmissions using the sidelink communication link based on the received PHR. In some examples, the MCS component 1145 may receive, at the base station, an indication of an MCS associated with the transmission from the first UE to the second UE over the sidelink communication link, and the scheduling component 1120 may schedule communications with the first UE is based on the receiving of the indication of the MCS.

FIG. 12 shows a diagram of a system 1200 including a device 1205 that supports power headroom reporting for sidelink with L2 relays in accordance with one or more aspects of the present disclosure. The device 1205 may be an example of or include the components of device 905, device 1005, or a base station 105 as described herein. The device 1205 may include components for bi-directional voice and data communications including components for transmitting and receiving communications, including a communications manager 1210, a network communications manager 1215, a transceiver 1220, an antenna 1225, memory 1230, a processor 1240, and an inter-station communications manager 1245. These components may be in electronic communication via one or more buses (e.g., bus 1250).

The network communications manager 1215 may manage communications with the core network (e.g., via one or more wired backhaul links). For example, the network communications manager 1215 may manage the transfer of data communications for client devices, such as one or more UEs 115.

The transceiver 1220 may communicate bi-directionally, via one or more antennas, wired, or wireless links. For example, the transceiver 1220 may represent a wireless transceiver and may communicate bi-directionally with another wireless transceiver. The transceiver 1220 may also include a modem to modulate the packets and provide the modulated packets to the antennas for transmission, and to demodulate packets received from the antennas.

In some cases, the wireless device may include a single antenna 1225. However, in some cases the device may have more than one antenna 1225, which may be capable of concurrently transmitting or receiving multiple wireless transmissions.

The memory 1230 may include RAM, ROM, or a combination thereof. The memory 1230 may store computer-readable code 1235 including instructions that, when executed by a processor (e.g., the processor 1240) cause the device to perform various functions described herein. In some cases, the memory 1230 may contain, among other things, a BIOS which may control basic hardware or software operation such as the interaction with peripheral components or devices.

The processor 1240 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some cases, a memory controller may be integrated into processor 1240. The processor 1240 may be configured to execute computer-readable instructions stored in a memory (e.g., the memory 1230) to cause the device 1205 to perform various functions (e.g., functions or tasks supporting power headroom reporting for sidelink with L2 relays).

The inter-station communications manager 1245 may manage communications with other base station 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communication network technology to provide communication between base stations 105.

The code 1235 may include instructions to implement one or more aspects of the present disclosure, including instructions to support wireless communications. The code 1235 may be stored in a non-transitory computer-readable medium such as system memory or other type of memory. In some cases, the code 1235 may not be directly executable by the processor 1240 but may cause a computer (e.g., when compiled and executed) to perform functions described herein.

The communications manager 1210 may be configured to support various aspects of sidelink power headroom reporting in accordance with examples as disclosed herein. For example, the communications manager 1210 may establish a sidelink communication link with a first UE (e.g., UE 115-c) via a second UE (e.g., UE 115-d), receive a PHR for the sidelink communication link, the PHR associated with transmission from the first UE to the second UE over the sidelink communication link, and schedule communications with the first UE based on receiving the PHR for the sidelink communication link.

By supporting various aspects of sidelink power headroom reporting, the device 1205 may support improved connectivity between devices of the system 1200, and improved allocation of communications resources and spectral efficiency of the system 1200. For example, by considering received sidelink power headroom reporting, the device 1205 may determine communications scheduling for UE 115-c, such as communications scheduling between the UE 115-c and a relay device (e.g., UE 115-d), in a manner that does not exceed a threshold transmission power of the UE 115-c, or in a manner that leverages various aspects of link diversity (e.g., scheduling communications over a direct link, over one or more sidelinks, or over various combinations of a direct link and one or more sidelinks), or reduces occurrences of radio link failure between the device 1205 and UEs 115, among other beneficial techniques.

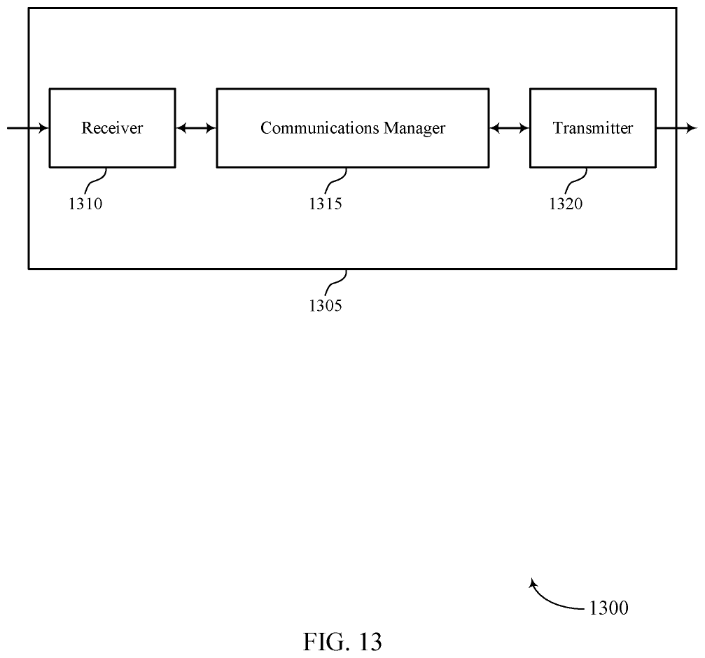

FIG. 13 shows a block diagram 1300 of a device 1305 that supports power headroom reporting for sidelink communications in accordance with one or more aspects of the present disclosure. The device 1305 may be an example of aspects of a UE 115 as described herein. The device 1305 may include a receiver 1310, a communications manager 1315, and a transmitter 1320. The device 1305 may also include a processor. Each of these components may be in communication with one another (e.g., via one or more buses).

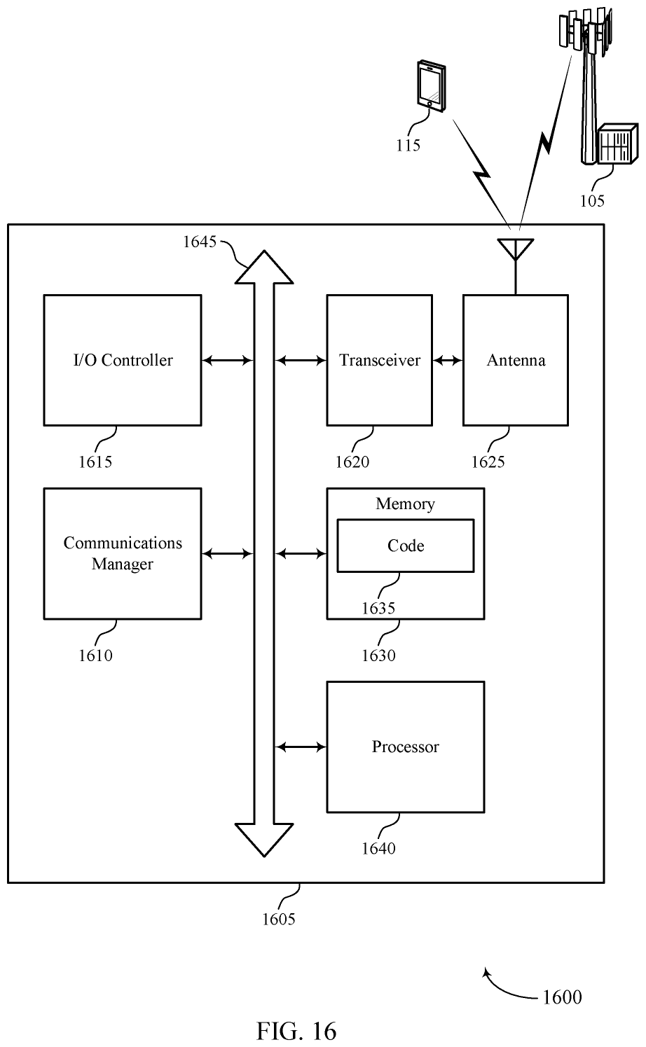

The receiver 1310 may receive information such as packets, user data, or control information associated with various information channels (e.g., control channels, data channels, and information related to power headroom reporting for sidelink communications, etc.). Information may be passed on to other components of the device 1305. The receiver 1310 may be an example of aspects of the transceiver 1620 described with reference to FIG. 16. The receiver 1310 may utilize a single antenna or a set of antennas.

The communications manager 1315 may establish, at a first UE, a sidelink communication link for communications between a base station and a second UE via the first UE, determine a power headroom associated with transmissions from the first UE to the second UE using the sidelink communication link, where determining the power headroom is based on a transmission power capability of the first UE, and transmit, to the base station, a PHR for the sidelink communication link based on the determined power headroom associated with the transmissions from the first UE to the second UE over the sidelink communication link. The communications manager 1315 may be an example of aspects of the communications manager 1610 described herein.

The communications manager 1315, or its sub-components, may be implemented in hardware, code (e.g., software or firmware) executed by a processor, or any combination thereof. If implemented in code executed by a processor, the functions of the communications manager 1315, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 1315, or its sub-components, may be physically located at various positions, including being distributed such that portions of functions are implemented at different physical locations by one or more physical components. In some examples, the communications manager 1315, or its sub-components, may be a separate and distinct component in accordance with various aspects of the present disclosure. In some examples, the communications manager 1315, or its sub-components, may be combined with one or more other hardware components, including but not limited to an I/O component, a transceiver, a network server, another computing device, one or more other components described in the present disclosure, or a combination thereof in accordance with various aspects of the present disclosure.

The transmitter 1320 may transmit signals generated by other components of the device 1305. In some examples, the transmitter 1320 may be collocated with a receiver 1310 in a transceiver module. For example, the transmitter 1320 may be an example of aspects of the transceiver 1620 described with reference to FIG. 16. The transmitter 1320 may utilize a single antenna or a set of antennas.

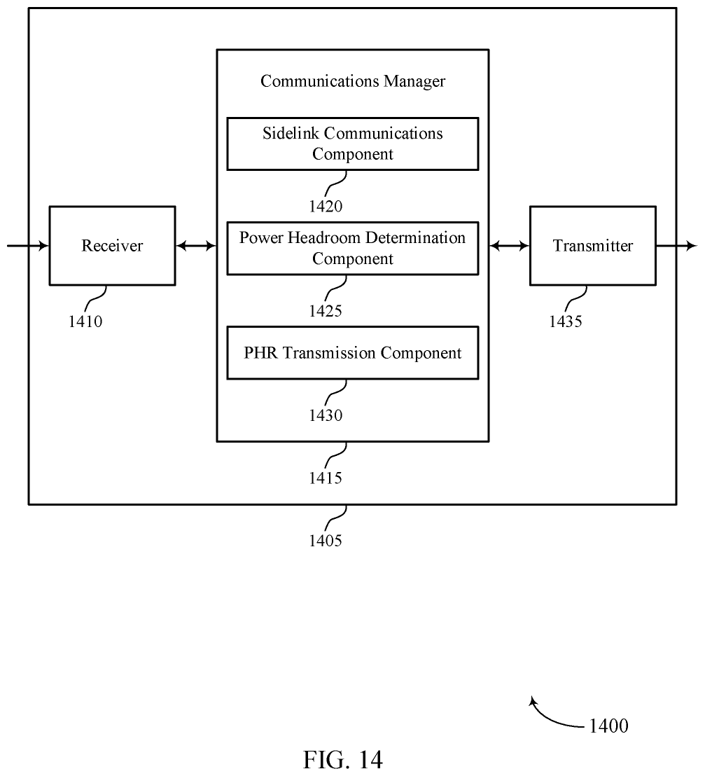

FIG. 14 shows a block diagram 1400 of a device 1405 that supports power headroom reporting for sidelink communications in accordance with one or more aspects of the present disclosure. The device 1405 may be an example of aspects of a device 1305, or a UE 115 as described herein. The device 1405 may include a receiver 1410, a communications manager 1415, and a transmitter 1435. The device 1405 may also include a processor. Each of these components may be in communication with one another (e.g., via one or more buses).

The receiver 1410 may receive information such as packets, user data, or control information associated with various information channels (e.g., control channels, data channels, and information related to power headroom reporting for sidelink communications, etc.). Information may be passed on to other components of the device 1405. The receiver 1410 may be an example of aspects of the transceiver 1620 described with reference to FIG. 16. The receiver 1410 may utilize a single antenna or a set of antennas.

The communications manager 1415 may be an example of aspects of the communications manager 1315 as described herein. The communications manager 1415 may include a sidelink communications component 1420, a power headroom determination component 1425, and a PHR transmission component 1430. The communications manager 1415 may be an example of aspects of the communications manager 1610 described herein.

The sidelink communications component 1420 may establish, at a first UE, a sidelink communication link for communications between a base station and a second UE via the first UE.

The power headroom determination component 1425 may determine a power headroom associated with transmissions from the first UE to the second UE using the sidelink communication link, where determining the power headroom is based on a transmission power capability of the first UE.

The PHR transmission component 1430 may transmit, to the base station, a PHR for the sidelink communication link based on the determined power headroom associated with the transmissions from the first UE to the second UE over the sidelink communication link.

The transmitter 1435 may transmit signals generated by other components of the device 1405. In some examples, the transmitter 1435 may be collocated with a receiver 1410 in a transceiver module. For example, the transmitter 1435 may be an example of aspects of the transceiver 1620 described with reference to FIG. 16. The transmitter 1435 may utilize a single antenna or a set of antennas.

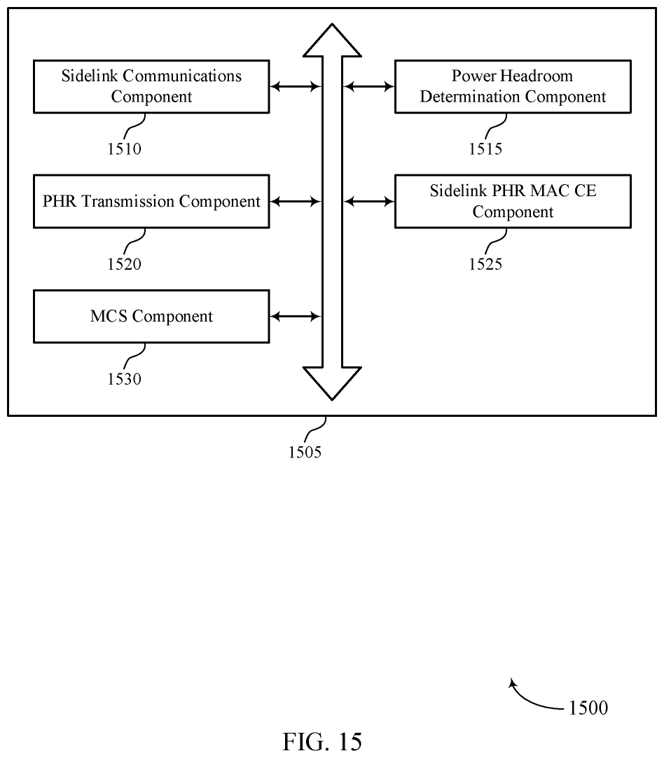

FIG. 15 shows a block diagram 1500 of a communications manager 1505 that supports power headroom reporting for sidelink communications in accordance with one or more aspects of the present disclosure. The communications manager 1505 may be an example of aspects of a communications manager 1315, a communications manager 1415, or a communications manager 1610 described herein. The communications manager 1505 may include a sidelink communications component 1510, a power headroom determination component 1515, a PHR transmission component 1520, a sidelink PHR MAC CE component 1525, and a MCS component 1530. Each of these modules may communicate, directly or indirectly, with one another (e.g., via one or more buses).

The sidelink communications component 1510 may establish, at a first UE, a sidelink communication link for communications between a base station and a second UE via the first UE.

The power headroom determination component 1515 may determine a power headroom associated with transmissions from the first UE to the second UE using the sidelink communication link, where determining the power headroom is based on a transmission power capability of the first UE.

In some examples, the power headroom determination component 1515 may determine the power headroom based on a scheduled downlink transmission from the first UE to the second UE. In some examples, the power headroom determination component 1515 may determine the power headroom based on a previously transmitted downlink transmission from the first UE to the second UE. In some examples, the power headroom determination component 1515 may determine the power headroom based on a virtual reference downlink transmission from the first UE to the second UE.

In some examples, the power headroom determination component 1515 may determine the power headroom associated with transmissions over a first transmission beam of the sidelink communication link, and determine a second power headroom associated with the transmissions from the first UE to the second UE over a second transmission beam of the sidelink communication link.

The PHR transmission component 1520 may transmit, to the base station, a PHR for the sidelink communication link based on the determined power headroom associated with the transmissions from the first UE to the second UE over the sidelink communication link.

In some examples, the PHR transmission component 1520 may transmit, to the base station, a first PHR for the sidelink communication link based on determining a first power headroom associated with transmissions over a first transmission beam of the sidelink communication link, and a second PHR for the sidelink communication link based on determining a second power headroom associated with the transmissions over a second transmission beam of the sidelink communication link.

In some examples, the sidelink PHR MAC CE component 1525 may transmit the PHR for the sidelink communication link in a MAC CE. In some examples, the sidelink PHR MAC CE component 1525 may receive an RRC configuration allocating a field of the MAC CE to power headroom reporting for the sidelink communication link, and transmit the PHR in the allocated field of the MAC CE. In some examples, the sidelink PHR MAC CE component 1525 may identify, based on the RRC configuration, a serving cell identifier associated with the sidelink communication link, and transmit the PHR in the field of the MAC CE associated with the serving cell identifier. In some examples, the sidelink PHR MAC CE component 1525 may identify, based on the RRC configuration, a second field of the MAC CE for identifying the sidelink communication link, and transmit an indicator of the sidelink communication link using the second field of the MAC CE. In some cases, the MAC CE may be dedicated for sidelink power headroom reporting. In some examples, the sidelink PHR MAC CE component 1525 may transmit a PHR for a direct communication link between the first UE and the base station in the MAC CE (e.g., in a same MAC CE as one or more sidelink PHRs)

The MCS component 1530 may identify an MCS associated with the transmissions from the first UE to the second UE using the sidelink communication link. In some examples, the MCS component 1530 may transmit, to the base station, an indication of the identified MCS with the PHR for the sidelink communication link.

FIG. 16 shows a diagram of a system 1600 including a device 1605 that supports power headroom reporting for sidelink communications in accordance with one or more aspects of the present disclosure. The device 1605 may be an example of or include the components of device 1305, device 1405, or a UE 115 as described herein. The device 1605 may include components for bi-directional voice and data communications including components for transmitting and receiving communications, including a communications manager 1610, an I/O controller 1615, a transceiver 1620, an antenna 1625, memory 1630, and a processor 1640. These components may be in electronic communication via one or more buses (e.g., bus 1645).

The I/O controller 1615 may manage input and output signals for the device 1605. The I/O controller 1615 may also manage peripherals not integrated into the device 1605. In some cases, the I/O controller 1615 may represent a physical connection or port to an external peripheral. In some cases, the I/O controller 1615 may utilize an operating system such as iOS®, ANDROID®, MS-DOS®, MS-WINDOWS®, OS/2®, UNIX®, LINUX®, or another known operating system. In other cases, the I/O controller 1615 may represent or interact with a modem, a keyboard, a mouse, a touchscreen, or a similar device. In some cases, the I/O controller 1615 may be implemented as part of a processor. In some cases, a user may interact with the device 1605 via the I/O controller 1615 or via hardware components controlled by the I/O controller 1615.

The transceiver 1620 may communicate bi-directionally, via one or more antennas, wired, or wireless links as described herein. For example, the transceiver 1620 may represent a wireless transceiver and may communicate bi-directionally with another wireless transceiver. The transceiver 1620 may also include a modem to modulate the packets and provide the modulated packets to the antennas for transmission, and to demodulate packets received from the antennas.

In some cases, the wireless device may include a single antenna 1625. However, in some cases the device may have more than one antenna 1625, which may be capable of concurrently transmitting or receiving multiple wireless transmissions.

The memory 1630 may include RAM, ROM, or a combination thereof. The memory 1630 may store computer-readable, computer-executable code 1635 including instructions that, when executed, cause the processor to perform various functions described herein. In some cases, the memory 1630 may contain, among other things, a BIOS which may control basic hardware or software operation such as the interaction with peripheral components or devices.

The processor 1640 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1640 may be configured to operate a memory array using a memory controller. In other cases, a memory controller may be integrated into the processor 1640. The processor 1640 may be configured to execute computer-readable instructions stored in a memory (e.g., the memory 1630) to cause the device 1605 to perform various functions (e.g., functions or tasks supporting power headroom reporting for sidelink communications).

The code 1635 may include instructions to implement aspects of the present disclosure, including instructions to support wireless communications. The code 1635 may be stored in a non-transitory computer-readable medium such as system memory or other type of memory. In some cases, the code 1635 may not be directly executable by the processor 1640 but may cause a computer (e.g., when compiled and executed) to perform functions described herein.

The communications manager 1610 may establish, at a first UE, a sidelink communication link for communications between a base station and a second UE via the first UE, determine a power headroom associated with transmissions from the first UE to the second UE using the sidelink communication link, where determining the power headroom is based on a transmission power capability of the first UE, and transmit, to the base station, a PHR for the sidelink communication link based on the determined power headroom associated with the transmissions from the first UE to the second UE over the sidelink communication link.

By supporting various aspects of sidelink power headroom reporting (e.g., downlink power headroom reporting, power headroom reporting by a relay device 210), the device 1605 may support improved connectivity within the system 1600 (e.g., connectivity between a base station 105 and a UE 115, which may include a sidelink via the device 1605), and improved allocation of communications resources and spectral efficiency of the system 1600. For example, by reporting sidelink power headroom in a downlink direction, the device 1605 may support determinations of the system 1600 (e.g., of a base station 105) for scheduling downlink communications with a UE 115 (e.g., a target device, an endpoint device) that are relayed by the device 1605 in a manner that does not exceed a threshold transmission power of the device 1605, or in a manner that leverages various aspects of link diversity (e.g., scheduling communications over a direct link, over one or more sidelinks, or over various combinations of a direct link and one or more sidelinks), or reduces occurrences of radio link failure between the UE 115 and the system 1600, among other beneficial techniques.

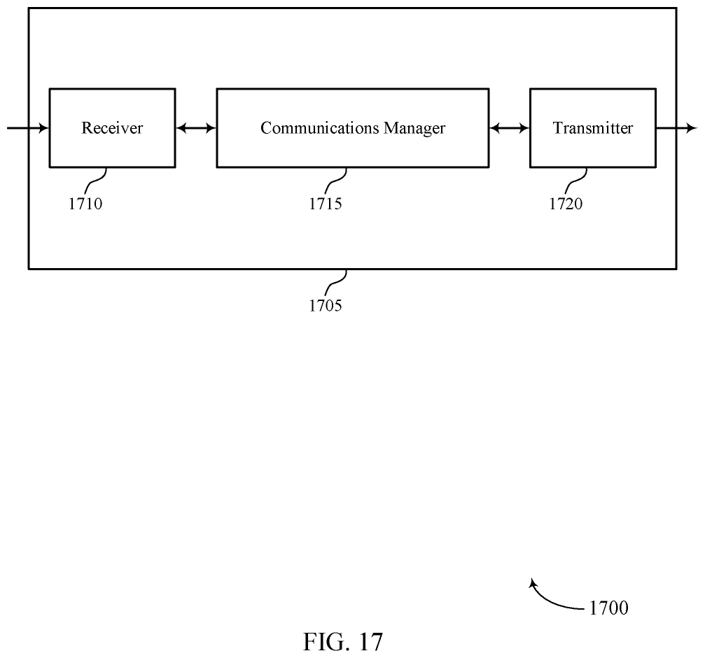

FIG. 17 shows a block diagram 1700 of a device 1705 that supports power headroom reporting for sidelink communications in accordance with one or more aspects of the present disclosure. The device 1705 may be an example of aspects of a base station 105 as described herein. The device 1705 may include a receiver 1710, a communications manager 1715, and a transmitter 1720. The device 1705 may also include a processor. Each of these components may be in communication with one another (e.g., via one or more buses).

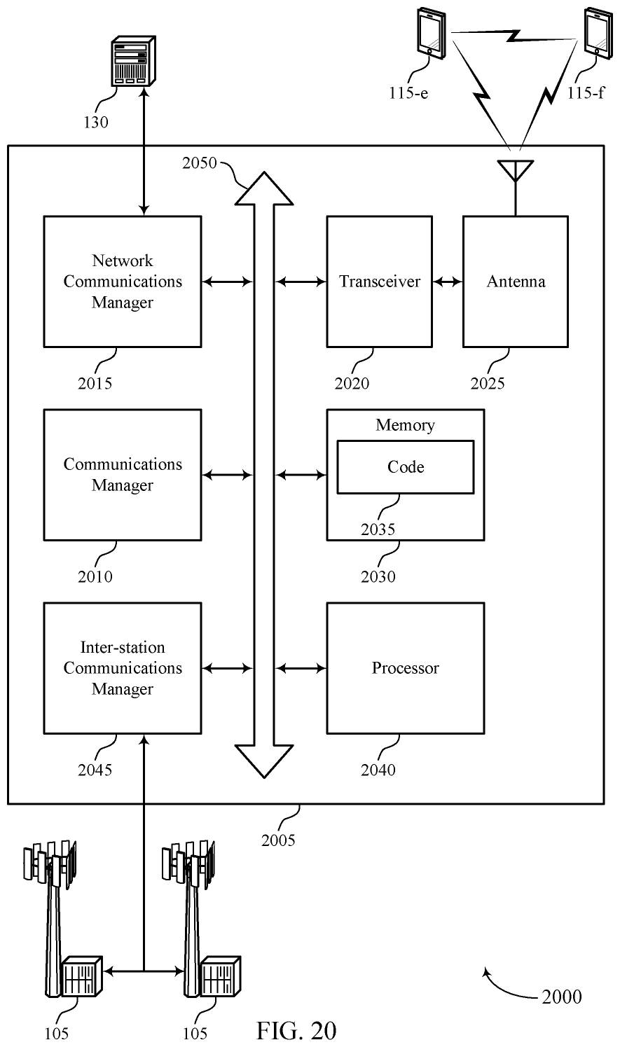

The receiver 1710 may receive information such as packets, user data, or control information associated with various information channels (e.g., control channels, data channels, and information related to power headroom reporting for sidelink communications, etc.). Information may be passed on to other components of the device 1705. The receiver 1710 may be an example of aspects of the transceiver 2020 described with reference to FIG. 20. The receiver 1710 may utilize a single antenna or a set of antennas.

The communications manager 1715 may establish, at a base station, a sidelink communication link for communications with a first UE via a second UE, receive, from the second UE, a PHR for the sidelink communication link, the PHR associated with transmission from the second UE to the first UE over the sidelink communication link, and schedule communications with the first UE based on receiving the PHR for the sidelink communication link. The communications manager 1715 may be an example of aspects of the communications manager 2010 described herein.

The communications manager 1715, or its sub-components, may be implemented in hardware, code (e.g., software or firmware) executed by a processor, or any combination thereof. If implemented in code executed by a processor, the functions of the communications manager 1715, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 1715, or its sub-components, may be physically located at various positions, including being distributed such that portions of functions are implemented at different physical locations by one or more physical components. In some examples, the communications manager 1715, or its sub-components, may be a separate and distinct component in accordance with various aspects of the present disclosure. In some examples, the communications manager 1715, or its sub-components, may be combined with one or more other hardware components, including but not limited to an I/O component, a transceiver, a network server, another computing device, one or more other components described in the present disclosure, or a combination thereof in accordance with various aspects of the present disclosure.

The transmitter 1720 may transmit signals generated by other components of the device 1705. In some examples, the transmitter 1720 may be collocated with a receiver 1710 in a transceiver module. For example, the transmitter 1720 may be an example of aspects of the transceiver 2020 described with reference to FIG. 20. The transmitter 1720 may utilize a single antenna or a set of antennas.

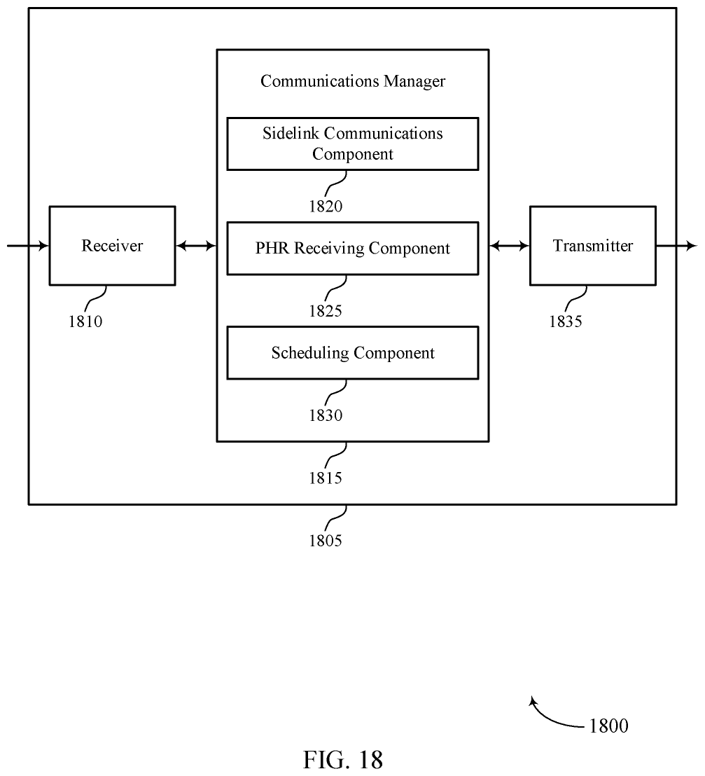

FIG. 18 shows a block diagram 1800 of a device 1805 that supports power headroom reporting for sidelink communications in accordance with one or more aspects of the present disclosure. The device 1805 may be an example of aspects of a device 1705, or a base station 105 as described herein. The device 1805 may include a receiver 1810, a communications manager 1815, and a transmitter 1835. The device 1805 may also include a processor. Each of these components may be in communication with one another (e.g., via one or more buses).

The receiver 1810 may receive information such as packets, user data, or control information associated with various information channels (e.g., control channels, data channels, and information related to power headroom reporting for sidelink communications, etc.). Information may be passed on to other components of the device 1805. The receiver 1810 may be an example of aspects of the transceiver 2020 described with reference to FIG. 20. The receiver 1810 may utilize a single antenna or a set of antennas.

The communications manager 1815 may be an example of aspects of the communications manager 1715 as described herein. The communications manager 1815 may include a sidelink communications component 1820, a PHR receiving component 1825, and a scheduling component 1830. The communications manager 1815 may be an example of aspects of the communications manager 2010 described herein.

The sidelink communications component 1820 may establish, at a base station, a sidelink communication link for communications with a first UE via a second UE.

The PHR receiving component 1825 may receive, from the second UE, a PHR for the sidelink communication link, the PHR associated with transmission from the second UE to the first UE over the sidelink communication link.

The scheduling component 1830 may schedule communications with the first UE based on receiving the PHR for the sidelink communication link.

The transmitter 1835 may transmit signals generated by other components of the device 1805. In some examples, the transmitter 1835 may be collocated with a receiver 1810 in a transceiver module. For example, the transmitter 1835 may be an example of aspects of the transceiver 2020 described with reference to FIG. 20. The transmitter 1835 may utilize a single antenna or a set of antennas.

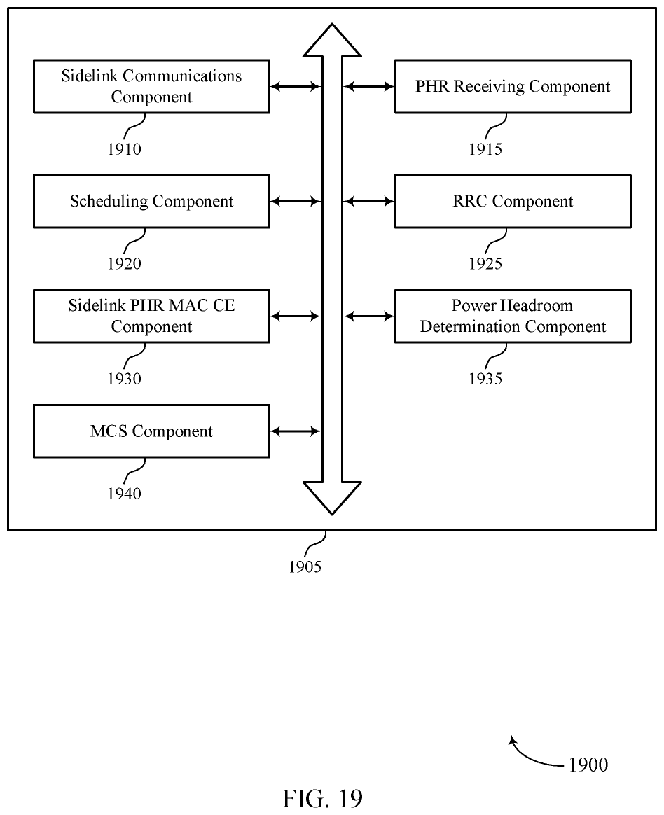

FIG. 19 shows a block diagram 1900 of a communications manager 1905 that supports power headroom reporting for sidelink communications in accordance with one or more aspects of the present disclosure. The communications manager 1905 may be an example of aspects of a communications manager 1715, a communications manager 1815, or a communications manager 2010 described herein. The communications manager 1905 may include a sidelink communications component 1910, a PHR receiving component 1915, a scheduling component 1920, an RRC component 1925, a sidelink PHR MAC CE component 1930, a power headroom determination component 1935, and a MCS component 1940. Each of these modules may communicate, directly or indirectly, with one another (e.g., via one or more buses).

The sidelink communications component 1910 may establish, at a base station, a sidelink communication link for communications with a first UE via a second UE.

The PHR receiving component 1915 may receive, from the second UE, a PHR for the sidelink communication link, the PHR associated with transmission from the second UE to the first UE over the sidelink communication link.

In some examples, the PHR receiving component 1915 may receive a first PHR associated with transmission over a first transmission beam of the sidelink communication link, and receive a second PHR associated with transmission over a second transmission beam of the sidelink communication link.

The scheduling component 1920 may schedule communications with the first UE based on receiving the PHR for the sidelink communication link. In some examples, the scheduling component 1920 may determine to schedule downlink communications over the sidelink communication link or a direct communication link between the base station and the first UE (e.g., a selection of one or the other, an allocation of communications between one of the other, or both) based on comparing the received PHR to the threshold power headroom value.

In some examples, the scheduling component 1920 may schedule communications with the first UE based on a first PHR associated with transmission over a first transmission beam of the second UE and a second PHR associated with transmission over a second transmission beam of the second UE.

In some examples, the RRC component 1925 may identify, based on establishing the sidelink communication link, an RRC configuration for configuring a MAC CE for the PHR for the sidelink communication link. In some examples, the RRC component 1925 may transmit the identified RRC configuration to the second UE. In some examples, the sidelink PHR MAC CE component 1930 may receive the PHR for the sidelink communication link in the MAC CE based on the transmitting of the identified RRC configuration. In some examples, to receive the PHR for the sidelink communication link in the MAC CE, the sidelink PHR MAC CE component 1930 may receive an indicator of the sidelink communication link using the second field of the MAC CE.

In some examples, the sidelink PHR MAC CE component 1930 may allocate, based on identifying the RRC configuration, a field of the MAC CE for power headroom reporting for the sidelink communication link. In some examples, the sidelink PHR MAC CE component 1930 may transmit an indication of the allocated field of the MAC CE based on allocating the field of the MAC CE, and the PHR receiving component 1915 may receive the PHR for the sidelink communication link is based on the transmitting of the indication of the allocated field of the MAC CE. In some examples, the sidelink PHR MAC CE component 1930 may transmit a serving cell identifier associated with the sidelink communication link. In some examples, to identify the RRC configuration, the sidelink PHR MAC CE component 1930 may identify a configuration for configuring a MAC CE dedicated for sidelink power headroom reporting. In some examples, the sidelink PHR MAC CE component 1930 may transmit an indication of a second field of the MAC CE allocated for identifying the sidelink communication link. In some examples, the PHR receiving component 1915 may receive a PHR for a direct communication link with the second UE in the same MAC CE as one or more sidelink PHRs (e.g., of or associated with the second UE), which may be based at least in part on the RRC component 1925 transmitting the identified RRC configuration.

In some examples, the power headroom determination component 1935 may identify a threshold power headroom value for scheduling downlink transmissions from the second UE to the first UE over the sidelink communication link, and the scheduling component 1920 may schedule communications with the first UE based on comparing the received PHR to the threshold power headroom value.

In some examples, the MCS component 1940 may determine an MCS for downlink transmissions from the second UE to the first UE over the sidelink communication link based on the received PHR. In some examples, the MCS component 1940 may receive, from the second UE, an indication of an MCS associated with the transmission from the second UE to the first UE over the sidelink communication link, and the scheduling component 1920 may schedule communications with the first UE based on receiving the indication of the MCS.

FIG. 20 shows a diagram of a system 2000 including a device 2005 that supports power headroom reporting for sidelink communications in accordance with one or more aspects of the present disclosure. The device 2005 may be an example of or include the components of device 1705, device 1805, or a base station 105 as described herein. The device 2005 may include components for bi-directional voice and data communications including components for transmitting and receiving communications, including a communications manager 2010, a network communications manager 2015, a transceiver 2020, an antenna 2025, memory 2030, a processor 2040, and an inter-station communications manager 2045. These components may be in electronic communication via one or more buses (e.g., bus 2050).

The network communications manager 2015 may manage communications with the core network (e.g., via one or more wired backhaul links). For example, the network communications manager 2015 may manage the transfer of data communications for client devices, such as one or more UEs 115.

The transceiver 2020 may communicate bi-directionally, via one or more antennas, wired, or wireless links as described herein. For example, the transceiver 2020 may represent a wireless transceiver and may communicate bi-directionally with another wireless transceiver. The transceiver 2020 may also include a modem to modulate the packets and provide the modulated packets to the antennas for transmission, and to demodulate packets received from the antennas.

In some cases, the wireless device may include a single antenna 2025. However, in some cases the device may have more than one antenna 2025, which may be capable of concurrently transmitting or receiving multiple wireless transmissions.

The memory 2030 may include RAM, ROM, or a combination thereof. The memory 2030 may store computer-readable code 2035 including instructions that, when executed by a processor (e.g., the processor 2040) cause the device to perform various functions described herein. In some cases, the memory 2030 may contain, among other things, a BIOS which may control basic hardware or software operation such as the interaction with peripheral components or devices.

The processor 2040 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 2040 may be configured to operate a memory array using a memory controller. In some cases, a memory controller may be integrated into processor 2040. The processor 2040 may be configured to execute computer-readable instructions stored in a memory (e.g., the memory 2030) to cause the device 2005 to perform various functions (e.g., functions or tasks supporting power headroom reporting for sidelink communications).

The inter-station communications manager 2045 may manage communications with other base station 105, and may include a controller or scheduler for controlling communications with UEs 115 in cooperation with other base stations 105. For example, the inter-station communications manager 2045 may coordinate scheduling for transmissions to UEs 115 for various interference mitigation techniques such as beamforming or joint transmission. In some examples, the inter-station communications manager 2045 may provide an X2 interface within an LTE/LTE-A wireless communication network technology to provide communication between base stations 105.

The code 2035 may include instructions to implement aspects of the present disclosure, including instructions to support wireless communications. The code 2035 may be stored in a non-transitory computer-readable medium such as system memory or other type of memory. In some cases, the code 2035 may not be directly executable by the processor 2040 but may cause a computer (e.g., when compiled and executed) to perform functions described herein.

The communications manager 2010 may be configured to support various aspects of sidelink power headroom reporting in accordance with examples as disclosed herein. For example, the communications manager 2010 may establish a sidelink communication link for communications with a first UE (e.g., UE 115-e) via a second UE (e.g., UE 115-f), receive, from the second UE, a PHR for the sidelink communication link, the PHR associated with transmission from the second UE to the first UE over the sidelink communication link, and schedule communications with the first UE based on receiving the PHR for the sidelink communication link.

By supporting various aspects of sidelink power headroom reporting (e.g., downlink power headroom reporting, power headroom reporting by a relay device 210), the device 2005 may support improved connectivity within the system 2000 (e.g., connectivity between the device 2005 and the UE 115-e, which may include a sidelink via the UE 115-f), and improved allocation of communications resources and spectral efficiency of the system 2000. For example, by considering received sidelink power headroom reporting in a downlink direction, the device 2005 may determine communications scheduling for the UE 115-e, which may include communications scheduling between the UE 115-f and the UE 115-e, in a manner that does not exceed a threshold transmission power of the UE 115-f, or in a manner that leverages various aspects of link diversity (e.g., scheduling communications over a direct link, over one or more sidelinks, or over various combinations of a direct link and one or more sidelinks), or reduces occurrences of radio link failure between the UE 115-e and the system 2000, among other beneficial techniques.

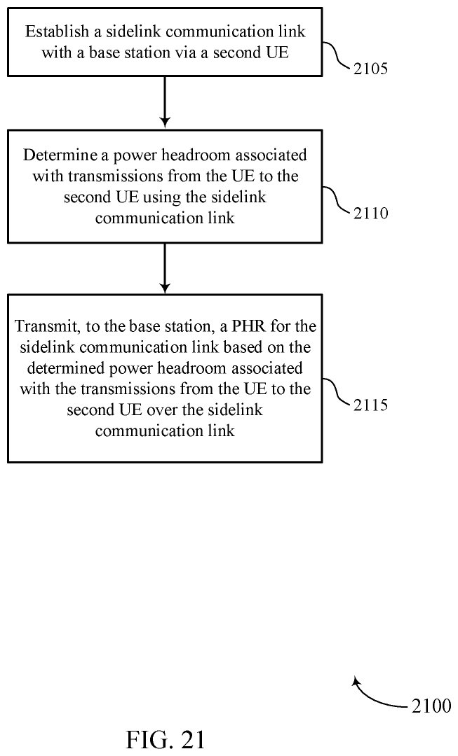

FIG. 21 shows a flowchart illustrating a method 2100 that supports power headroom reporting for sidelink with L2 relays in accordance with one or more aspects of the present disclosure. The operations of method 2100 may be implemented by a UE 115 or its components as described herein. For example, the operations of method 2100 may be performed by a communications manager as described with reference to FIGS. 5 through 8. In some examples, a UE may execute a set of instructions to control the functional elements of the UE to perform the described functions. Additionally or alternatively, a UE may perform aspects of the described functions using special-purpose hardware.

At 2105, the UE may establish a sidelink communication link with a base station via a second UE. The operations of 2105 may be performed according to the methods described herein. In some examples, aspects of the operations of 2105 may be performed by a sidelink communications component as described with reference to FIGS. 5 through 8.

At 2110, the UE may determine a power headroom associated with transmissions from the UE to the second UE using the sidelink communication link. In some examples, determining the power headroom may be based on a transmission power capability of the UE. The operations of 2110 may be performed according to the methods described herein. In some examples, aspects of the operations of 2110 may be performed by a power headroom determination component as described with reference to FIGS. 5 through 8.

At 2115, the UE may convey, to the base station, a PHR for the sidelink communication link based on the determined power headroom associated with the transmissions from the UE to the second UE over the sidelink communication link. The operations of 2115 may be performed according to the methods described herein. In some examples, aspects of the operations of 2115 may be performed by a PHR transmission component as described with reference to FIGS. 5 through 8.

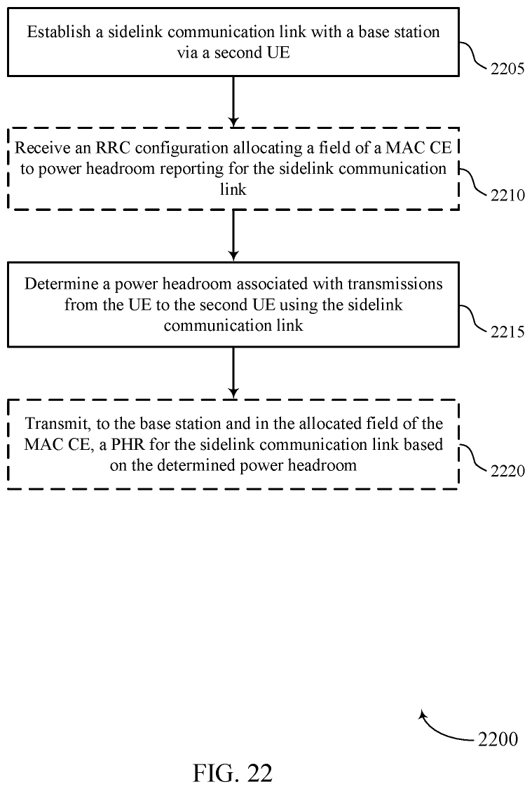

FIG. 22 shows a flowchart illustrating a method 2200 that supports power headroom reporting for sidelink with L2 relays in accordance with one or more aspects of the present disclosure. The operations of method 2200 may be implemented by a UE 115 or its components as described herein. For example, the operations of method 2200 may be performed by a communications manager as described with reference to FIGS. 5 through 8. In some examples, a UE may execute a set of instructions to control the functional elements of the UE to perform the described functions. Additionally or alternatively, a UE may perform aspects of the described functions using special-purpose hardware.

At 2205, the UE may establish a sidelink communication link with a base station via a second UE. The operations of 2205 may be performed according to the methods described herein. In some examples, aspects of the operations of 2205 may be performed by a sidelink communications component as described with reference to FIGS. 5 through 8.

At 2210, the UE may receive an RRC configuration allocating a field of a MAC CE to power headroom reporting for the sidelink communication link. The operations of 2210 may be performed according to the methods described herein. In some examples, aspects of the operations of 2210 may be performed by a sidelink PHR MAC CE component as described with reference to FIGS. 5 through 8.

At 2215, the UE may determine a power headroom associated with transmissions from the UE to the second UE using the sidelink communication link. In some examples, determining the power headroom may be based on a transmission power capability of the UE. In various examples, the determining may be based on a scheduled uplink transmission from the UE to the second UE, or a previously transmitted uplink transmission from the UE to the second UE, or a virtual reference uplink transmission from the UE to the second UE. The operations of 2215 may be performed according to the methods described herein. In some examples, aspects of the operations of 2215 may be performed by a power headroom determination component as described with reference to FIGS. 5 through 8.

At 2220, the UE may convey, to the base station and in the allocated field of the MAC CE, a PHR for the sidelink communication link based on the determined power headroom. In some examples, the UE may identify, based on the RRC configuration, a serving cell identifier associated with the sidelink communication link, and transmit the PHR in the field of the MAC CE associated with the serving cell identifier. In some examples, the UE may identify, based on the RRC configuration, a second field of the MAC CE for identifying the sidelink communication link, and transmit an indicator of the sidelink communication link using the second field. The operations of 2220 may be performed according to the methods described herein. In some examples, aspects of the operations of 2220 may be performed by a PHR transmission component as described with reference to FIGS. 5 through 8.

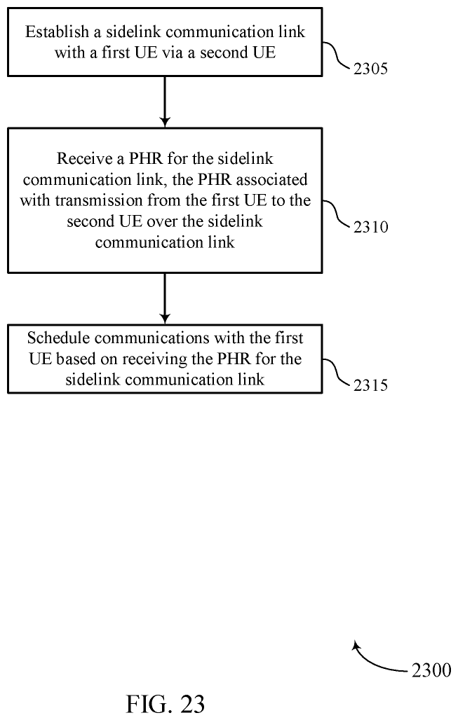

FIG. 23 shows a flowchart illustrating a method 2300 that supports power headroom reporting for sidelink with L2 relays in accordance with one or more aspects of the present disclosure. The operations of method 2300 may be implemented by a base station 105 or its components as described herein. For example, the operations of method 2300 may be performed by a communications manager as described with reference to FIGS. 9 through 12. In some examples, a base station may execute a set of instructions to control the functional elements of the base station to perform the described functions. Additionally or alternatively, a base station may perform aspects of the described functions using special-purpose hardware.

At 2305, the base station may establish, at a base station, a sidelink communication link with a first UE via a second UE. The operations of 2305 may be performed according to the methods described herein. In some examples, aspects of the operations of 2305 may be performed by a sidelink communications component as described with reference to FIGS. 9 through 12.

At 2310, the base station may receive a PHR for the sidelink communication link, the PHR associated with transmission from the first UE to the second UE over the sidelink communication link. The operations of 2310 may be performed according to the methods described herein. In some examples, aspects of the operations of 2310 may be performed by a PHR receiving component as described with reference to FIGS. 9 through 12.

At 2315, the base station may schedule communications with the first UE based on receiving the PHR for the sidelink communication link. The operations of 2315 may be performed according to the methods described herein. In some examples, aspects of the operations of 2315 may be performed by a scheduling component as described with reference to FIGS. 9 through 12.

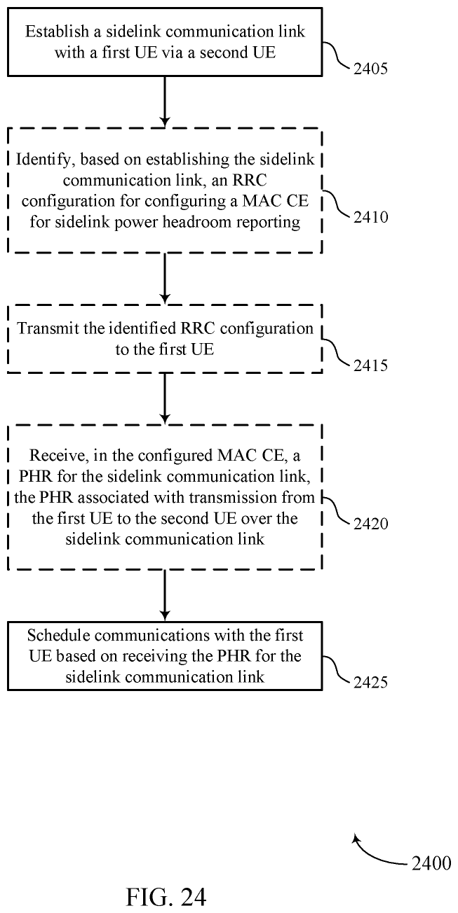

FIG. 24 shows a flowchart illustrating a method 2400 that supports power headroom reporting for sidelink with L2 relays in accordance with one or more aspects of the present disclosure. The operations of method 2400 may be implemented by a base station 105 or its components as described herein. For example, the operations of method 2400 may be performed by a communications manager as described with reference to FIGS. 9 through 12. In some examples, a base station may execute a set of instructions to control the functional elements of the base station to perform the described functions. Additionally or alternatively, a base station may perform aspects of the described functions using special-purpose hardware.

At 2405, the base station may establish a sidelink communication link with a first UE via a second UE. The operations of 2405 may be performed according to the methods described herein. In some examples, aspects of the operations of 2405 may be performed by a sidelink communications component as described with reference to FIGS. 9 through 12.

At 2410, the base station may identify, based on establishing the sidelink communication link, an RRC configuration for configuring a MAC CE for sidelink power headroom reporting. The operations of 2410 may be performed according to the methods described herein. In some examples, aspects of the operations of 2410 may be performed by an RRC component as described with reference to FIGS. 9 through 12.

At 2415, the base station may transmit the identified RRC configuration to the first UE. The operations of 2415 may be performed according to the methods described herein. In some examples, aspects of the operations of 2415 may be performed by an RRC component as described with reference to FIGS. 9 through 12.

At 2420, the base station may receive, in the configured MAC CE, a PHR for the sidelink communication link, the PHR associated with transmission from the first UE to the second UE over the sidelink communication link. The operations of 2420 may be performed according to the methods described herein. In some examples, aspects of the operations of 2420 may be performed by a PHR receiving component as described with reference to FIGS. 9 through 12.

At 2425, the base station may schedule communications with the first UE based on receiving the PHR for the sidelink communication link. The operations of 2425 may be performed according to the methods described herein. In some examples, aspects of the operations of 2425 may be performed by a scheduling component as described with reference to FIGS. 9 through 12.

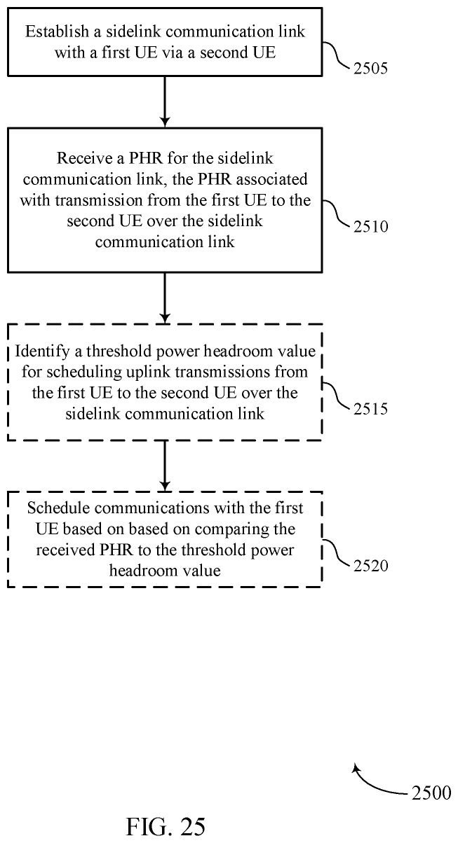

FIG. 25 shows a flowchart illustrating a method 2500 that supports power headroom reporting for sidelink with L2 relays in accordance with one or more aspects of the present disclosure. The operations of method 2500 may be implemented by a base station 105 or its components as described herein. For example, the operations of method 2500 may be performed by a communications manager as described with reference to FIGS. 9 through 12. In some examples, a base station may execute a set of instructions to control the functional elements of the base station to perform the described functions. Additionally or alternatively, a base station may perform aspects of the described functions using special-purpose hardware.

At 2505, the base station may establish a sidelink communication link with a first UE via a second UE. The operations of 2505 may be performed according to the methods described herein. In some examples, aspects of the operations of 2505 may be performed by a sidelink communications component as described with reference to FIGS. 9 through 12.

At 2510, the base station may receive a PHR for the sidelink communication link, the PHR associated with transmission from the first UE to the second UE over the sidelink communication link. The operations of 2510 may be performed according to the methods described herein. In some examples, aspects of the operations of 2510 may be performed by a PHR receiving component as described with reference to FIGS. 9 through 12.

At 2515, the base station may identify a threshold power headroom value for scheduling uplink transmissions from the first UE to the second UE over the sidelink communication link. The operations of 2515 may be performed according to the methods described herein. In some examples, aspects of the operations of 2515 may be performed by a power headroom determination component as described with reference to FIGS. 9 through 12.

At 2520, the base station may schedule communications with the first UE based on comparing the received PHR to the threshold power headroom value. The operations of 2520 may be performed according to the methods described herein. In some examples, aspects of the operations of 2520 may be performed by a scheduling component as described with reference to FIGS. 9 through 12.

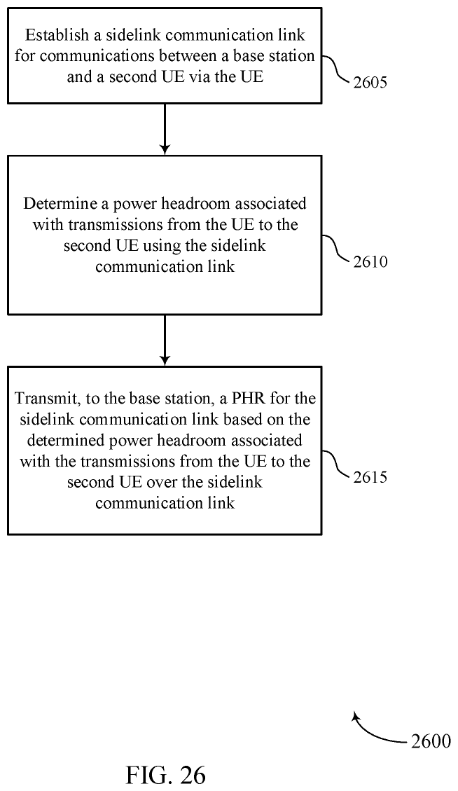

FIG. 26 shows a flowchart illustrating a method 2600 that supports power headroom reporting for sidelink communications in accordance with one or more aspects of the present disclosure. The operations of method 2600 may be implemented by a UE 115 or its components as described herein. For example, the operations of method 2600 may be performed by a communications manager as described with reference to FIGS. 18 through 21. In some examples, a UE may execute a set of instructions to control the functional elements of the UE to perform the described functions. Additionally or alternatively, a UE may perform aspects of the described functions using special-purpose hardware.

At 2605, the UE may establish a sidelink communication link for communications between a base station and a second UE via the UE. The operations of 2605 may be performed according to the methods described herein. In some examples, aspects of the operations of 2605 may be performed by a sidelink communications component as described with reference to FIGS. 18 through 21.

At 2610, the UE may determine a power headroom associated with transmissions from the first UE to the second UE using the sidelink communication link. In some examples, determining the power headroom may be based on a transmission power capability of the UE. The operations of 2610 may be performed according to the methods described herein. In some examples, aspects of the operations of 2610 may be performed by a power headroom determination component as described with reference to FIGS. 18 through 21.

At 2615, the UE may transmit, to the base station, a PHR for the sidelink communication link based on the determined power headroom associated with the transmissions from the UE to the second UE over the sidelink communication link. The operations of 2615 may be performed according to the methods described herein. In some examples, aspects of the operations of 2615 may be performed by a PHR transmission component as described with reference to FIGS. 18 through 21.

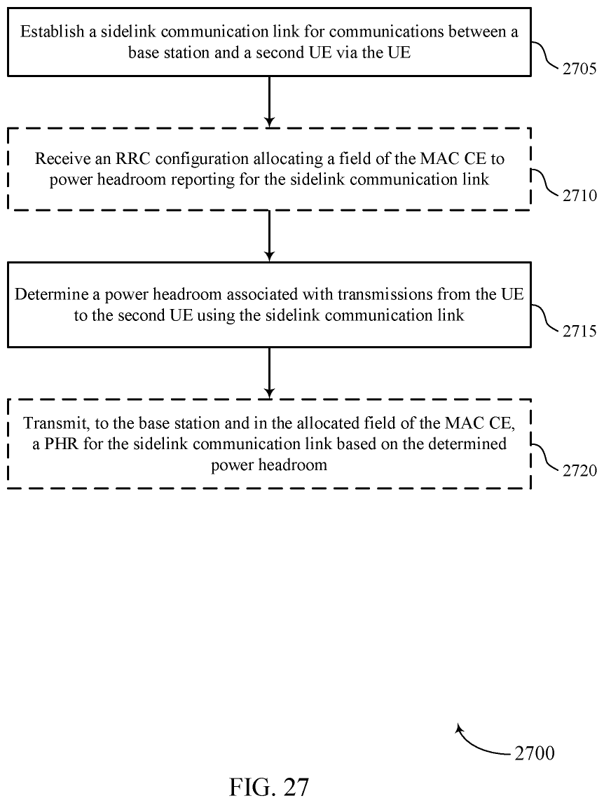

FIG. 27 shows a flowchart illustrating a method 2700 that supports power headroom reporting for sidelink communications in accordance with one or more aspects of the present disclosure. The operations of method 2700 may be implemented by a UE 115 or its components as described herein. For example, the operations of method 2700 may be performed by a communications manager as described with reference to FIGS. 18 through 21. In some examples, a UE may execute a set of instructions to control the functional elements of the UE to perform the described functions. Additionally or alternatively, a UE may perform aspects of the described functions using special-purpose hardware.

At 2705, the UE may establish a sidelink communication link for communications between a base station and a second UE via the UE. The operations of 2705 may be performed according to the methods described herein. In some examples, aspects of the operations of 2705 may be performed by a sidelink communications component as described with reference to FIGS. 18 through 21.

At 2710, the UE may receive an RRC configuration allocating a field of the MAC CE to power headroom reporting for the sidelink communication link, The operations of 2710 may be performed according to the methods described herein. In some examples, aspects of the operations of 2710 may be performed by a sidelink PHR MAC CE component as described with reference to FIGS. 18 through 21.

At 2715, the UE may determine a power headroom associated with transmissions from the UE to the second UE using the sidelink communication link. In some examples, determining the power headroom may be based on a transmission power capability of the first UE. The operations of 2715 may be performed according to the methods described herein. In some examples, aspects of the operations of 2715 may be performed by a power headroom determination component as described with reference to FIGS. 18 through 21.

At 2720, the UE may transmit, to the base station and in the allocated field of the MAC CE, a PHR for the sidelink communication link based on the determined power headroom. In some examples, the UE may identify, based on the RRC configuration, a serving cell identifier associated with the sidelink communication link, and transmit the PHR in the field of the MAC CE associated with the serving cell identifier. In some examples, the UE may identify, based on the RRC configuration, a second field of the MAC CE for identifying the sidelink communication link, and transmit an indicator of the sidelink communication link using the second field. The operations of 2720 may be performed according to the methods described herein. In some examples, aspects of the operations of 2720 may be performed by a PHR transmission component as described with reference to FIGS. 18 through 21.

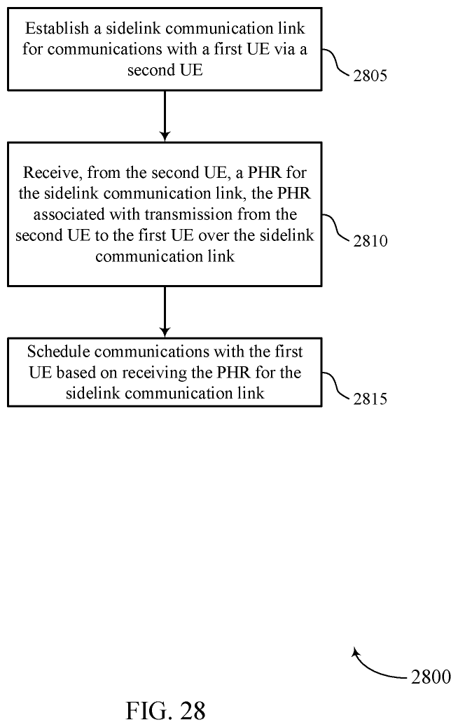

FIG. 28 shows a flowchart illustrating a method 2800 that supports power headroom reporting for sidelink communications in accordance with one or more aspects of the present disclosure. The operations of method 2800 may be implemented by a base station 105 or its components as described herein. For example, the operations of method 2800 may be performed by a communications manager as described with reference to FIGS. 22 through 25. In some examples, a base station may execute a set of instructions to control the functional elements of the base station to perform the described functions. Additionally or alternatively, a base station may perform aspects of the described functions using special-purpose hardware.

At 2805, the base station may establish a sidelink communication link for communications with a first UE via a second UE. The operations of 2805 may be performed according to the methods described herein. In some examples, aspects of the operations of 2805 may be performed by a sidelink communications component as described with reference to FIGS. 22 through 25.

At 2810, the base station may receive, from the second UE, a PHR for the sidelink communication link, the PHR associated with transmission from the second UE to the first UE over the sidelink communication link. The operations of 2810 may be performed according to the methods described herein. In some examples, aspects of the operations of 2810 may be performed by a PHR receiving component as described with reference to FIGS. 22 through 25.

At 2815, the base station may schedule communications with the first UE based on receiving the PHR for the sidelink communication link. The operations of 2815 may be performed according to the methods described herein. In some examples, aspects of the operations of 2815 may be performed by a scheduling component as described with reference to FIGS. 22 through 25.

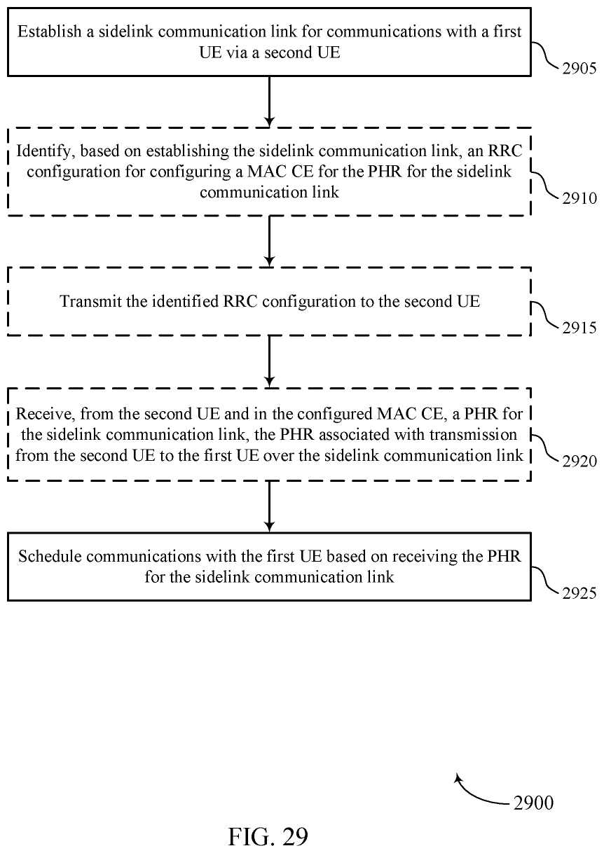

FIG. 29 shows a flowchart illustrating a method 2900 that supports power headroom reporting for sidelink communications in accordance with one or more aspects of the present disclosure. The operations of method 2900 may be implemented by a base station 105 or its components as described herein. For example, the operations of method 2900 may be performed by a communications manager as described with reference to FIGS. 22 through 25. In some examples, a base station may execute a set of instructions to control the functional elements of the base station to perform the described functions. Additionally or alternatively, a base station may perform aspects of the described functions using special-purpose hardware.

At 2905, the base station may establish a sidelink communication link for communications with a first UE via a second UE. The operations of 2905 may be performed according to the methods described herein. In some examples, aspects of the operations of 2905 may be performed by a sidelink communications component as described with reference to FIGS. 22 through 25.

At 2910, the base station may identify, based on establishing the sidelink communication link, an RRC configuration for configuring a MAC CE for sidelink power headroom reporting. The operations of 2910 may be performed according to the methods described herein. In some examples, aspects of the operations of 2910 may be performed by an RRC component as described with reference to FIGS. 22 through 25.

At 2915, the base station may transmit the identified RRC configuration to the second UE. The operations of 2915 may be performed according to the methods described herein. In some examples, aspects of the operations of 2915 may be performed by an RRC component as described with reference to FIGS. 22 through 25.

At 2920, the base station may receive, from the second UE and in the configured MAC CE, a PHR for the sidelink communication link, the PHR associated with transmission from the second UE to the first UE over the sidelink communication link. The operations of 2920 may be performed according to the methods described herein. In some examples, aspects of the operations of 2920 may be performed by a PHR receiving component as described with reference to FIGS. 22 through 25.

At 2925, the base station may schedule communications with the first UE based on receiving the PHR for the sidelink communication link. The operations of 2925 may be performed according to the methods described herein. In some examples, aspects of the operations of 2925 may be performed by a scheduling component as described with reference to FIGS. 22 through 25.

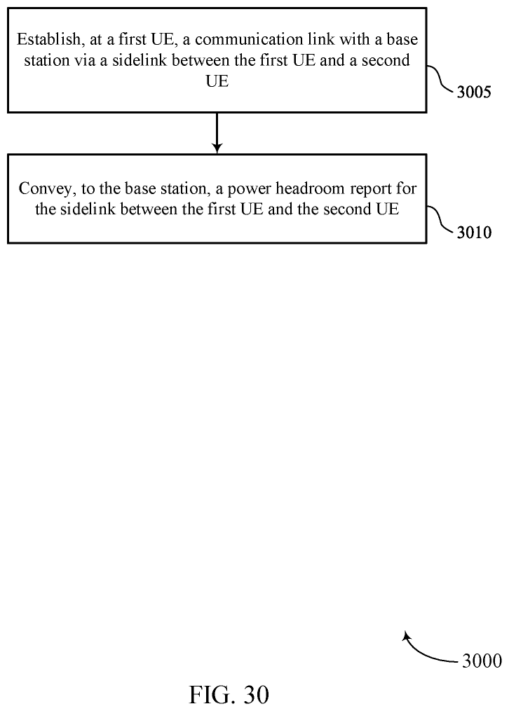

FIG. 30 shows a flowchart illustrating a method 3000 that supports power headroom reporting for sidelink communications in accordance with aspects of the present disclosure. The operations of method 3000 may be implemented by a UE 115 or its components as described herein. For example, the operations of method 3000 may be performed by a communications manager as described with reference to FIGS. 5 through 8. In some examples, a UE may execute a set of instructions to control the functional elements of the UE to perform the described functions. Additionally or alternatively, a UE may perform aspects of the described functions using special-purpose hardware.

At 3005, the method may include establishing, at a first UE, a communication link with a base station via a sidelink between the first UE and a second UE. The operations of 3005 may be performed in accordance with examples as disclosed herein. In some examples, aspects of the operations of 3005 may be performed by a sidelink communications component 620 as described with reference to FIG. 6.

At 3010, the method may include conveying, to the base station, a power headroom report for the sidelink between the first UE and the second UE. In some examples, the power headroom report may be based on a power headroom associated with transmissions from the first UE to the second UE (e.g., using the sidelink between the first UE and the second UE). In some examples, the power headroom may be based on a transmission power capability of the first UE. The operations of 3010 may be performed in accordance with examples as disclosed herein. In some examples, aspects of the operations of 3010 may be performed by an PHR transmission component 630 as described with reference to FIG. 6.

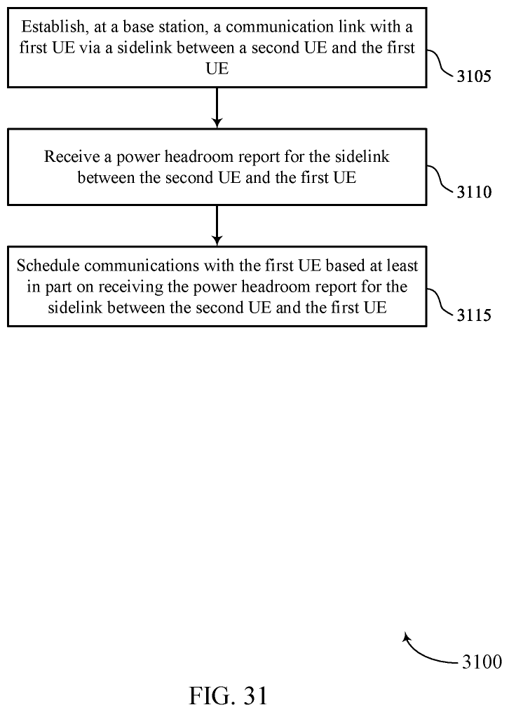

FIG. 31 shows a flowchart illustrating a method 3100 that supports power headroom reporting for sidelink communications in accordance with aspects of the present disclosure. The operations of method 3100 may be implemented by a base station or its components as described herein. For example, the operations of method 3100 may be performed by a communications manager as described with reference to FIGS. 9 through 12. In some examples, a base station may execute a set of instructions to control the functional elements of the base station to perform the described functions. Additionally or alternatively, a base station may perform aspects of the described functions using special-purpose hardware.

At 3105, the method may include establishing, at a base station, a communication link with a first UE via a sidelink between a second UE and the first UE. The operations of 3105 may be performed in accordance with examples as disclosed herein. In some examples, aspects of the operations of 3105 may be performed by a sidelink communications component 1020 as described with reference to FIG. 10.

At 3110, the method may include receiving a power headroom report for the sidelink between the second UE and the first UE. In some examples, the power headroom report may be associated with transmission from the first UE to the second UE (e.g., over the sidelink between the second UE and the first UE). The operations of 3110 may be performed in accordance with examples as disclosed herein. In some examples, aspects of the operations of 3110 may be performed by an PHR receiving component 1025 as described with reference to FIG. 10.

At 3115, the method may include scheduling communications with the first UE based on receiving the power headroom report for the sidelink between the second UE and the first UE. The operations of 3115 may be performed in accordance with examples as disclosed herein. In some examples, aspects of the operations of 3115 may be performed by a scheduling component 1030 as described with reference to FIG. 10.

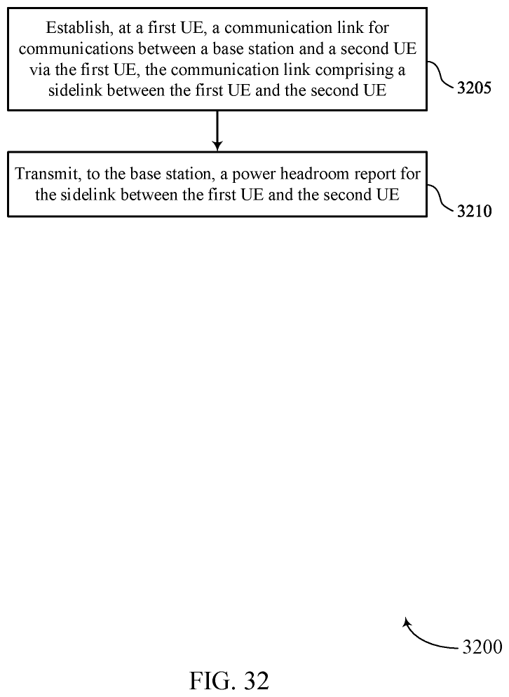

FIG. 32 shows a flowchart illustrating a method 3200 that supports power headroom reporting for sidelink communications in accordance with aspects of the present disclosure. The operations of method 3200 may be implemented by a UE 115 or its components as described herein. For example, the operations of method 3200 may be performed by a communications manager as described with reference to FIGS. 13 through 16. In some examples, a UE may execute a set of instructions to control the functional elements of the UE to perform the described functions. Additionally or alternatively, a UE may perform aspects of the described functions using special-purpose hardware.

At 3205, the method may include establishing, at a first UE, a communication link for communications between a base station and a second UE via the first UE, the communication link including a sidelink between the first UE and the second UE. The operations of 3205 may be performed in accordance with examples as disclosed herein. In some examples, aspects of the operations of 3205 may be performed by a sidelink communications component 1420 as described with reference to FIG. 14.

At 3210, the method may include transmitting, to the base station, a power headroom report for the sidelink between the first UE and the second UE. In some examples, the power headroom report may be based on a power headroom associated with transmissions from the first UE to the second UE (e.g., using the sidelink between the first UE and the second UE). In some examples, the power headroom may be based on a transmission power capability of the first UE. The operations of 3210 may be performed in accordance with examples as disclosed herein. In some examples, aspects of the operations of 3210 may be performed by an PHR transmission component 1430 as described with reference to FIG. 14.

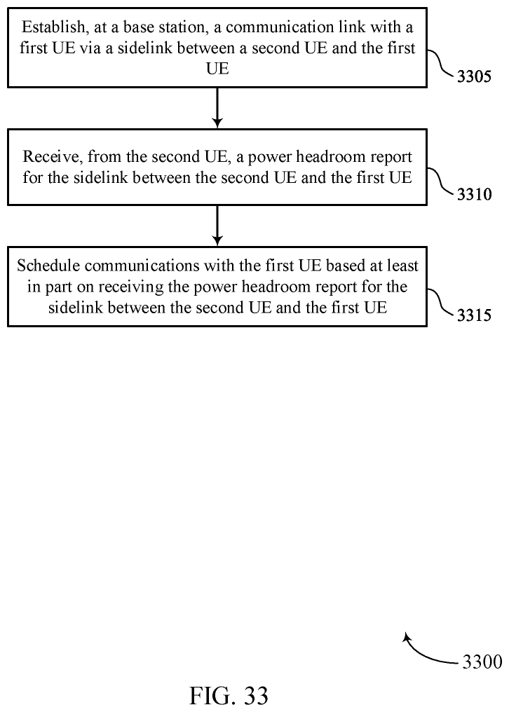

FIG. 33 shows a flowchart illustrating a method 3300 that supports power headroom reporting for sidelink communications in accordance with aspects of the present disclosure. The operations of method 3300 may be implemented by a base station or its components as described herein. For example, the operations of method 3300 may be performed by a communications manager as described with reference to FIGS. 17 through 20. In some examples, a base station may execute a set of instructions to control the functional elements of the base station to perform the described functions. Additionally or alternatively, a base station may perform aspects of the described functions using special-purpose hardware.

At 3305, the method may include establishing, at a base station, a communication link with a first UE via a sidelink between a second UE and the first UE. The operations of 3305 may be performed in accordance with examples as disclosed herein. In some examples, aspects of the operations of 3305 may be performed by a sidelink communications component 1820 as described with reference to FIG. 18.

At 3310, the method may include receiving, from the second UE, a power headroom report for the sidelink between the second UE and the first UE. In some examples, the power headroom report may be associated with transmission from the second UE to the first UE (e.g., over the sidelink between the second UE and the first UE). The operations of 3310 may be performed in accordance with examples as disclosed herein. In some examples, aspects of the operations of 3310 may be performed by an PHR receiving component 1825 as described with reference to FIG. 18.

At 3315, the method may include scheduling communications with the first UE based on receiving the power headroom report for the sidelink between the second UE and the first UE. The operations of 3315 may be performed in accordance with examples as disclosed herein. In some examples, aspects of the operations of 3315 may be performed by a scheduling component 1830 as described with reference to FIG. 18.

It should be noted that the methods described herein describe possible implementations, and that the operations and the steps may be rearranged or otherwise modified and that other implementations are possible. Further, aspects from two or more of the methods may be combined.

The following provides an overview of aspects of the present invention:

Aspect 1: A method for wireless communication, comprising: establishing, at a first UE, a sidelink communication link with a base station via a second UE; determining a power headroom associated with transmissions from the first UE to the second UE using the sidelink communication link, wherein determining the power headroom is based at least in part on a transmission power capability of the first UE; and conveying, to the base station, a power headroom report for the sidelink communication link based at least in part on the determined power headroom associated with the transmissions from the first UE to the second UE over the sidelink communication link.

Aspect 2: The method of aspect 1, further comprising: establishing, at the first UE, a direct communication link with the base station, wherein conveying the power headroom report for the sidelink communication link comprises transmitting the power headroom report for the sidelink communication link to the base station using the direct communication link.

Aspect 3: The method of aspect 1, wherein conveying the power headroom report for the sidelink communication link comprises: transmitting the power headroom report for the sidelink communication link to the second UE using the sidelink communication link.

Aspect 4: The method of any one of aspects 1 through 3, wherein conveying the power headroom report for the sidelink communication link comprises: transmitting the power headroom report for the sidelink communication link in a MAC CE.

Aspect 5: The method of aspect 4, further comprising: receiving an RRC configuration allocating a field of the MAC CE to power headroom reporting for the sidelink communication link, wherein transmitting the power headroom report comprises transmitting the power headroom report in the allocated field of the MAC CE.

Aspect 6: The method of aspect 5, further comprising: identifying, based at least in part on the RRC configuration, a serving cell identifier associated with the sidelink communication link, wherein transmitting the power headroom report in the MAC CE comprises transmitting the power headroom report in the field of the MAC CE associated with the serving cell identifier.

Aspect 7: The method of aspect 5, further comprising: identifying, based at least in part on the RRC configuration, a second field of the MAC CE for identifying the sidelink communication link, wherein transmitting the power headroom report in the MAC CE comprises transmitting an indicator of the sidelink communication link using the second field of the MAC CE.

Aspect 8: The method of any one of aspects 4 through 7, wherein the MAC CE is dedicated for sidelink power headroom reporting.

Aspect 9: The method of any one of aspects 4 through 7, further comprising transmitting a power headroom report for a direct communication link between the first UE and the base station in the MAC CE.

Aspect 10: The method of any one of aspects 1 through 9, wherein determining the power headroom comprises: determining the power headroom based at least in part on a scheduled uplink transmission from the first UE to the second UE.

Aspect 11: The method of any one of aspects 1 through 9, wherein determining the power headroom comprises: determining the power headroom based at least in part on a previously transmitted uplink transmission from the first UE to the second UE.

Aspect 12: The method of any one of aspects 1 through 9, wherein determining the power headroom comprises: determining the power headroom based at least in part on a virtual reference uplink transmission from the first UE to the second UE.

Aspect 13: The method of any one of aspects 1 through 12, wherein determining the power headroom comprises determining the power headroom associated with transmissions over a first transmission beam of the sidelink communication link, the method further comprising: determining a second power headroom associated with transmissions from the first UE to the second UE over a second transmission beam of the sidelink communication link; and conveying, to the base station, a second power headroom report for the sidelink communication link based at least in part on the determined second power headroom associated with the transmissions over the second transmission beam of the sidelink communication link.

Aspect 14: The method of any one of aspects 1 through 13, further comprising identifying an MCS associated with the transmissions from the first UE to the second UE using the sidelink communication link conveying, to the base station, an indication of the identified MCS with the power headroom report for the sidelink communication link.

Aspect 15: A method for wireless communication, comprising: establishing, at a base station, a sidelink communication link with a first UE via a second UE; receiving, at the base station, a power headroom report for the sidelink communication link, the power headroom report associated with transmission from the first UE to the second UE over the sidelink communication link; and scheduling communications with the first UE based at least in part on receiving the power headroom report for the sidelink communication link.

Aspect 16: The method of aspect 15, further comprising: establishing, at the base station, a direct communication link with the first UE, wherein receiving the power headroom report for the sidelink communication link comprises receiving the power headroom report for the sidelink communication link using the direct communication link.

Aspect 17: The method of aspect 15, wherein receiving the power headroom report for the sidelink communication link comprises: receiving the power headroom report for the sidelink communication link from the second UE using the sidelink communication link.

Aspect 18: The method of any one of aspects 15 through 17, further comprising: identifying, based at least in part on establishing the sidelink communication link, an RRC configuration for configuring a MAC CE for the power headroom report for the sidelink communication link; transmitting the identified RRC configuration to the first UE; and receiving the power headroom report for the sidelink communication link in the MAC CE based at least in part on transmitting the identified RRC configuration.

Aspect 19: The method of aspect 18, further comprising: allocating, based at least in part on identifying the RRC configuration, a field of the MAC CE for power headroom reporting for the sidelink communication link; and transmitting an indication of the allocated field of the MAC CE based at least in part on allocating the field of the MAC CE, wherein receiving the power headroom report for the sidelink communication link is based at least in part on transmitting the indication of the allocated field of the MAC CE.

Aspect 20: The method of aspect 19, wherein transmitting the indication of the allocated field of the MAC CE comprises: transmitting a serving cell identifier associated with the sidelink communication link.

Aspect 21: The method of aspect 19, further comprising transmitting an indication of a second field of the MAC CE allocated for identifying the sidelink communication link, wherein receiving the power headroom report for the sidelink communication link in the MAC CE comprises receiving an indicator of the sidelink communication link using the second field of the MAC CE.

Aspect 22: The method of aspect 19, wherein identifying the RRC configuration comprises: identifying a configuration for configuring a MAC CE dedicated for sidelink power headroom reporting.

Aspect 23: The method of any one of aspects 18 through 21, further comprising: receiving a power headroom report for a direct communication link with the first UE in the MAC CE based at least in part on transmitting the identified RRC configuration.

Aspect 24: The method of any one of aspects 15 through 23, further comprising: identifying a threshold power headroom value for scheduling uplink transmissions from the first UE to the second UE over the sidelink communication link, wherein the scheduling communications with the first UE is based at least in part on comparing the received power headroom report to the threshold power headroom value.

Aspect 25: The method of aspect 24, wherein the scheduling communications with the first UE comprises: determining to schedule communications over the sidelink communication link or a direct communication link based at least in part on comparing the received power headroom report to the threshold power headroom value.

Aspect 26: The method of any one of aspects 15 through 25, wherein the scheduling communications with the first UE comprises: determining an MCS for transmissions using the sidelink communication link based at least in part on the received power headroom report.

Aspect 27: The method of any one of aspects 15 through 26, wherein the power headroom report is associated with transmission over a first transmission beam of the sidelink communication link, the method further comprising: receiving, at the base station, a second power headroom report associated with transmission over a second transmission beam of the sidelink communication link, wherein the scheduling communications with the first UE is based at least in part on receiving the power headroom report and the second power headroom report.

Aspect 28: The method of any one of aspects 15 through 27, further comprising: receiving, at the base station, an indication of an MCS associated with the transmission from the first UE to the second UE over the sidelink communication link, wherein the scheduling communications with the first UE is based at least in part on receiving the indication of the MCS.

Aspect 29: An apparatus for wireless communication comprising at least one means for performing a method of any one of aspects 1 through 14.

Aspect 30: An apparatus for wireless communication comprising a processor and memory coupled to the processor, the processor and memory configured to perform a method of any one of aspects 1 through 14.

Aspect 31: A non-transitory computer-readable medium storing code for wireless communication, the code comprising instructions executable by a processor to perform a method of any one of aspects 1 through 14.

Aspect 32: An apparatus for wireless communication comprising at least one means for performing a method of any one of aspects 15 through 28.

Aspect 33: An apparatus for wireless communication comprising a processor and memory coupled to the processor, the processor and memory configured to perform a method of any one of aspects 15 through 28.

Aspect 34: A non-transitory computer-readable medium storing code for wireless communication, the code comprising instructions executable by a processor to perform a method of any one of aspects 15 through 28.

Aspect 35: A method for wireless communication, comprising: establishing, at a first UE, a sidelink communication link for communications between a base station and a second UE via the first UE; determining a power headroom associated with transmissions from the first UE to the second UE using the sidelink communication link, wherein determining the power headroom is based at least in part on a transmission power capability of the first UE; and transmitting, to the base station, a power headroom report for the sidelink communication link based at least in part on the determined power headroom associated with the transmissions from the first UE to the second UE over the sidelink communication link.

Aspect 36: The method of aspect 35, wherein transmitting the power headroom report for the sidelink communication link comprises transmitting the power headroom report for the sidelink communication link in a MAC CE.

Aspect 37: The method of aspect 36, further comprising receiving an RRC configuration allocating a field of the MAC CE to power headroom reporting for the sidelink communication link, wherein transmitting the power headroom report comprises transmitting the power headroom report in the allocated field of the MAC CE.

Aspect 38: The method of aspect 37, further comprising identifying, based at least in part on the RRC configuration, a serving cell identifier associated with the sidelink communication link, wherein transmitting the power headroom report in the MAC CE comprises transmitting the power headroom report in the field of the MAC CE associated with the serving cell identifier.

Aspect 39: The method of aspect 37, further comprising identifying, based at least in part on the RRC configuration, a second field of the MAC CE for identifying the sidelink communication link, wherein transmitting the power headroom report in the MAC CE comprises transmitting an indicator of the sidelink communication link using the second field of the MAC CE.

Aspect 40: The method of any one of aspects 36 through 39, wherein the MAC CE is dedicated for sidelink power headroom reporting.

Aspect 41: The method of any one of aspects 36 through 39, further comprising transmitting a power headroom report for a direct communication link between the first UE and the base station in the MAC CE.

Aspect 42: The method of any one of aspects 35 through 41, wherein determining the power headroom comprises determining the power headroom based at least in part on a scheduled downlink transmission from the first UE to the second UE.

Aspect 43: The method of any one of aspects 35 through 41, wherein determining the power headroom comprises determining the power headroom based at least in part on a previously transmitted downlink transmission from the first UE to the second UE.

Aspect 44: The method of any one of aspects 35 through 41, wherein determining the power headroom comprises determining the power headroom based at least in part on a virtual reference downlink transmission from the first UE to the second UE.

Aspect 45: The method of any one of aspects 35 through 44, wherein determining the power headroom comprises determining the power headroom associated with transmissions over a first transmission beam of the sidelink communication link, the method further comprising determining a second power headroom associated with transmissions from the first UE to the second UE over a second transmission beam of the sidelink communication link, and transmitting, to the base station, a second power headroom report for the sidelink communication link based at least in part on the determined second power headroom associated with the transmissions over the second transmission beam of the sidelink communication link.

Aspect 46: The method of any one of aspects 35 through 45, further comprising identifying an MCS associated with the transmissions from the first UE to the second UE using the sidelink communication link transmitting, to the base station, an indication of the identified MCS with the power headroom report for the sidelink communication link.

Aspect 47: A method for wireless communication, comprising establishing, at a base station, a sidelink communication link for communications with a first UE via a second UE receiving, from the second UE, a power headroom report for the sidelink communication link, the power headroom report associated with transmission from the second UE to the first UE over the sidelink communication link scheduling communications with the first UE based at least in part on receiving the power headroom report for the sidelink communication link.

Aspect 48: The method of aspect 47, further comprising identifying, based at least in part on establishing the sidelink communication link, an RRC configuration for configuring a MAC CE for the power headroom report for the sidelink communication link, transmitting the identified RRC configuration to the second UE, and receiving the power headroom report for the sidelink communication link in the MAC CE based at least in part on transmitting the identified RRC configuration.

Aspect 49: The method of aspect 48, further comprising allocating, based at least in part on identifying the RRC configuration, a field of the MAC CE for power headroom reporting for the sidelink communication link, and transmitting an indication of the allocated field of the MAC CE based at least in part on allocating the field of the MAC CE, wherein receiving the power headroom report for the sidelink communication link is based at least in part on transmitting the indication of the allocated field of the MAC CE.

Aspect 50: The method of aspect 49, wherein transmitting the indication of the allocated field of the MAC CE comprises transmitting a serving cell identifier associated with the sidelink communication link.

Aspect 51: The method of aspect 49, further comprising transmitting an indication of a second field of the MAC CE allocated for identifying the sidelink communication link, wherein receiving the power headroom report for the sidelink communication link in the MAC CE comprises receiving an indicator of the sidelink communication link using the second field of the MAC CE.

Aspect 52: The method of aspect 49, wherein identifying the RRC configuration comprises identifying a configuration for configuring a MAC CE dedicated for sidelink power headroom reporting.

Aspect 53: The method of any one of aspects 48 through 51, further comprising receiving a power headroom report for a direct communication link with the second UE in the MAC CE based at least in part on transmitting the identified RRC configuration.

Aspect 54: The method of any one of aspects 47 through 53, further comprising identifying a threshold power headroom value for scheduling downlink transmissions from the second UE to the first UE over the sidelink communication link, wherein the scheduling communications with the first UE is based at least in part on comparing the received power headroom report to the threshold power headroom value.

Aspect 55: The method of aspect 54, wherein scheduling communications with the first UE comprises determining to schedule downlink communications over the sidelink communication link or a direct communication link between the base station and the first UE based at least in part on comparing the received power headroom report to the threshold power headroom value.

Aspect 56: The method of any one of aspects 47 through 55, wherein the scheduling communications with the first UE comprises: determining an MCS for downlink transmissions from the second UE to the first UE over the sidelink communication link based at least in part on the received power headroom report.

Aspect 57: The method of any one of aspects 47 through 56, wherein the power headroom report is associated with transmission over a first transmission beam of the sidelink communication link, the method further comprising receiving, at the base station, a second power headroom report associated with transmission over a second transmission beam of the sidelink communication link, wherein the scheduling communications with the first UE is based at least in part on receiving the power headroom report and the second power headroom report.

Aspect 58: The method of any one of aspects 47 through 57, further comprising receiving, from the second UE, an indication of an MCS associated with the transmission from the second UE to the first UE over the sidelink communication link, wherein the scheduling communications with the first UE is based at least in part on receiving the indication of the MCS.

Aspect 59: A method of wireless communication, comprising: establishing, at a first UE, a communication link with a base station via a sidelink between the first UE and a second UE; and conveying, to the base station, a power headroom report for the sidelink between the first UE and the second UE, the power headroom report based at least in part on a power headroom associated with transmissions from the first UE to the second UE using the sidelink between the first UE and the second UE, the power headroom based at least in part on a transmission power capability of the first UE.

Aspect 60: The method of aspect 59, further comprising: establishing a direct communication link with the base station, wherein conveying the power headroom report for the sidelink between the first UE and the second UE comprises transmitting the power headroom report to the base station using the direct communication link.

Aspect 61: The method of aspect 59, wherein conveying the power headroom report for the sidelink between the first UE and the second UE comprises: transmitting the power headroom report to the UE using the sidelink between the first UE and the second UE.

Aspect 62: The method of any of aspects 59 through 61, further comprising: receiving an RRC configuration allocating a field of a MAC CE to power headroom reporting for the sidelink between the first UE and the second UE; identifying, based at least in part on the RRC configuration, a serving cell identifier associated with the sidelink between the first UE and the second UE; and conveying the power headroom report for the sidelink between the first UE and the second UE in the field of the MAC CE that is associated with the serving cell identifier.

Aspect 63: The method of any of aspects 59 through 61, further comprising: receiving an RRC configuration allocating a first field of a MAC CE to power headroom reporting for the sidelink between the first UE and the second UE and a second field of the MAC CE for identifying the sidelink between the first UE and the second UE; and transmitting the power headroom report for the sidelink between the first UE and the second UE in the first field of the MAC CE and an indicator of the sidelink between the first UE and the second UE in the second field of the MAC CE.

Aspect 64: The method of any of aspects 59 through 61, further comprising: receiving an RRC configuration allocating a field of a MAC CE to power headroom reporting for the sidelink between the first UE and the second UE, wherein the MAC CE is dedicated for sidelink power headroom reporting; and conveying the power headroom report for the sidelink between the first UE and the second UE in the allocated field of the MAC CE.

Aspect 65: The method of any of aspects 59 through 64, further comprising: determining the power headroom based at least in part on a scheduled transmission to the second UE, or a previously transmitted transmission to the second UE, or a virtual reference transmission to the second UE.

Aspect 66: The method of any of aspects 59 through 65, further comprising: determining the power headroom associated with transmissions to the second UE over a first transmission beam of the sidelink between the first UE and the second UE; determining a second power headroom associated with transmissions to the second UE over a second transmission beam of the sidelink between the first UE and the second UE; and conveying, to the base station, a second power headroom report for the sidelink between the first UE and the second UE, the second power headroom report based at least in part on the second power headroom.

Aspect 67: The method of any of aspects 59 through 66, further comprising: identifying an MCS associated with the transmissions from the first UE to the second UE using the sidelink between the first UE and the second UE; and conveying, to the base station, an indication of the identified MCS with the power headroom report for the sidelink between the first UE and the second UE.

Aspect 68: A method for wireless communication, comprising: establishing, at a base station, a communication link with a first UE via a sidelink between a second UE and the first UE; receiving a power headroom report for the sidelink between the second UE and the first UE, the power headroom report associated with transmission from the first UE to the second UE over the sidelink between the second UE and the first UE; and scheduling communications with the first UE based at least in part on receiving the power headroom report for the sidelink between the second UE and the first UE.

Aspect 69: The method of aspect 68, further comprising: establishing a direct communication link with the first UE, wherein receiving the power headroom report for the sidelink between the second UE and the first UE comprises receiving the power headroom report using the direct communication link.

Aspect 70: The method of aspect 68, wherein receiving the power headroom report for the sidelink between the second UE and the first UE comprises: receiving the power headroom report from the second UE.

Aspect 71: The method of any of aspects 68 through 70, further comprising: identifying, based at least in part on establishing the communication link, an RRC configuration for configuring a MAC CE for the power headroom report for the sidelink between the second UE and the first UE; allocating, based at least in part on identifying the RRC configuration, a field of the MAC CE for power headroom reporting for the sidelink between the second UE and the first UE; and transmitting an indication of the allocated field of the MAC CE based at least in part on allocating the field of the MAC CE, wherein receiving the power headroom report is based at least in part on transmitting the indication of the allocated field of the MAC CE.

Aspect 72: The method of any of aspects 68 through 71, further comprising: identifying a threshold power headroom value for scheduling transmissions from the first UE to the second UE over the sidelink between the second UE and the first UE; and determining to schedule communications over the sidelink between the second UE and the first UE, or a direct communication link with the first UE, based at least in part on comparing the power headroom report to the threshold power headroom value.

Aspect 73: The method of any of aspects 68 through 72, wherein the power headroom report is associated with transmission over a first transmission beam of the sidelink between the second UE and the first UE, the method further comprising: receiving a second power headroom report associated with transmission over a second transmission beam of the sidelink between the second UE and the first UE, wherein scheduling the communications with the first UE is based at least in part on receiving the power headroom report and the second power headroom report.

Aspect 74: The method of any of aspects 68 through 73, further comprising: receiving an indication of an MCS associated with the transmission from the first UE to the second UE over the sidelink between the second UE and the first UE, scheduling the communications with the first UE is based at least in part on receiving the indication of the MCS.

Aspect 75: A method for wireless communication, comprising: establishing, at a first UE, a communication link for communications between a base station and a second UE via the first UE, the communication link comprising a sidelink between the first UE and the second UE; and transmitting, to the base station, a power headroom report for the sidelink between the first UE and the second UE, the power headroom report based at least in part on a power headroom associated with transmissions from the first UE to the second UE using the sidelink between the first UE and the second UE, the power headroom based at least in part on a transmission power capability of the first UE.

Aspect 76: The method of aspect 75, further comprising: receiving an RRC configuration allocating a field of a MAC CE to power headroom reporting for the sidelink between the first UE and the second UE; identifying, based at least in part on the RRC configuration, a serving cell identifier associated with the sidelink between the first UE and the second UE; and transmitting the power headroom report for the sidelink between the first UE and the second UE in the field of the MAC CE that is associated with the serving cell identifier.

Aspect 77: The method of aspect 75, further comprising: receiving an RRC configuration allocating a first field of a MAC CE to power headroom reporting for the sidelink between the first UE and the second UE and a second field of the MAC CE for identifying the sidelink between the first UE and the second UE; and transmitting the power headroom report for the sidelink between the first UE and the second UE in the first field of the MAC CE and an indicator of the sidelink between the first UE and the second UE in the second field of the MAC CE.

Aspect 78: The method of aspect 75, further comprising: receiving an RRC configuration allocating a field of a MAC CE to power headroom reporting for the sidelink between the first UE and the second UE; transmitting the power headroom report for the sidelink between the first UE and the second UE in the allocated field of the MAC CE; and transmitting a power headroom report for a direct communication link between the first UE and the base station in the MAC CE.

Aspect 79: The method of any of aspects 75 through 78, wherein transmitting the power headroom report for the sidelink between the first UE and the second UE comprises: transmitting the power headroom report in a MAC CE that is dedicated for sidelink power headroom reporting.

Aspect 80: The method of any of aspects 75 through 79, wherein determining the power headroom is based at least in part on a scheduled downlink transmission to the second UE, or a previously transmitted downlink transmission to the second UE, or a virtual reference downlink transmission to the second UE.

Aspect 81: The method of any of aspects 75 through 80, further comprising: determining the power headroom associated with transmissions over a first transmission beam of the sidelink between the first UE and the second UE; determining a second power headroom associated with transmissions from the first UE to the UE over a second transmission beam of the sidelink between the first UE and the second UE; and transmitting, to the base station, a second power headroom report for the sidelink between the first UE and the second UE, the second power headroom report based at least in part on the second power headroom.

Aspect 82: The method of any of aspects 75 through 81, further comprising: identifying an MCS associated with the transmissions from the first UE to the second UE using the sidelink between the first UE and the second UE; and transmitting, to the base station, an indication of the identified MCS with the power headroom report for the sidelink between the first UE and the second UE.

Aspect 83: A method for wireless communications, comprising: establishing, at a base station, a communication link with a first UE via a sidelink between a second UE and the first UE; receiving, from the second UE, a power headroom report for the sidelink between the second UE and the first UE, the power headroom report associated with transmission from the second UE to the first UE over the sidelink between the second UE and the first UE; and scheduling communications with the first UE based at least in part on receiving the power headroom report for the sidelink between the second UE and the first UE.

Aspect 84: The apparatus of aspect 83, further comprising: identifying, based at least in part on establishing the communication link, an RRC configuration for configuring a MAC CE for the power headroom report for the sidelink between the second UE and the first UE; allocating, based at least in part on identifying the RRC configuration, a first field of the MAC CE for power headroom reporting for the sidelink between the second UE and the first UE, and a second field for identifying the sidelink between the second UE and the first UE; and transmitting an indication of the first field of the MAC CE and the second field of the MAC CE based at least in part on the allocating; wherein receiving the power headroom report comprises receiving the power headroom report based at least in part on transmitting the indication of the first field of the MAC CE and the second field of the MAC CE.

Aspect 85: The apparatus of aspect 83, further comprising: identifying, based at least in part on establishing the communication link, an RRC configuration for configuring a MAC CE for the power headroom report for the sidelink between the second UE and the first UE; allocating, based at least in part on identifying the RRC configuration, a field of the MAC CE for power headroom reporting for the sidelink between the second UE and the first UE; and transmitting an indication of the allocated field of the MAC CE based at least in part on allocating the field of the MAC CE, wherein receiving the power headroom report for the sidelink between the second UE and the first UE is based at least in part on transmitting the indication of the allocated field of the MAC CE, the method further comprising: receiving a power headroom report for a direct communication link with the second UE in the MAC CE based at least in part on transmitting the identified RRC configuration.

Aspect 86: The apparatus of any of aspects 83 through 85, further comprising: identifying a threshold power headroom value for scheduling transmissions from the second UE to the first UE over the sidelink between the second UE and the first UE; and determining to schedule communications over the sidelink between the second UE and the first UE, or a direct communication link between the apparatus and the first UE, based at least in part on comparing the power headroom report to the threshold power headroom value.

Aspect 87: The apparatus of any of aspects 83 through 86, wherein the power headroom report is associated with transmission over a first transmission beam of the sidelink between the second UE and the first UE, the method further comprising: receiving a second power headroom report associated with transmission over a second transmission beam of the sidelink between the second UE and the first UE, wherein scheduling the communications with the first UE based at least in part on receiving the power headroom report and the second power headroom report.

Aspect 88: The apparatus of any of aspects 83 through 87, further comprising: receiving, from the second UE, an indication of an MCS associated with the transmission from the second UE to the first UE over the sidelink between the second UE and the first UE, wherein the processor and memory are configured to schedule communications with the first UE based at least in part on receiving the indication of the MCS.

Aspect 89: An apparatus for wireless communication comprising at least one means for performing a method of any one of aspects 35 through 46.

Aspect 90: An apparatus for wireless communication comprising a processor and memory coupled to the processor, the processor and memory configured to perform a method of any one of aspects 35 through 46.

Aspect 91: A non-transitory computer-readable medium storing code for wireless communication, the code comprising instructions executable by a processor to perform a method of any one of aspects 35 through 46.

Aspect 92: An apparatus for wireless communication comprising at least one means for performing a method of any one of aspects 47 through 58.

Aspect 93: An apparatus for wireless communication comprising a processor and memory coupled to the processor, the processor and memory configured to perform a method of any one of aspects 47 through 58.

Aspect 94: A non-transitory computer-readable medium storing code for wireless communication, the code comprising instructions executable by a processor to perform a method of any one of aspects 47 through 58.

Aspect 95: An apparatus comprising at least one means for performing a method of any of aspects 59 through 67.

Aspect 96: An apparatus for wireless communication comprising a processor and memory coupled to the processor, the processor and memory configured to perform a method of any one of aspects 59 through 67.

Aspect 97: A non-transitory computer-readable medium storing code the code comprising instructions executable by a processor to perform a method of any of aspects 59 through 67.

Aspect 98: An apparatus for wireless communication, comprising at least one means for performing a method of any of aspects 68 through 74.

Aspect 99: An apparatus for wireless communication comprising a processor and memory coupled to the processor, the processor and memory configured to perform a method of any one of aspects 68 through 74.

Aspect 100: A non-transitory computer-readable medium storing code for wireless communication, the code comprising instructions executable by a processor to perform a method of any of aspects 68 through 74.

Aspect 101: An apparatus for wireless communication, comprising at least one means for performing a method of any of aspects 75 through 82.

Aspect 102: An apparatus for wireless communication comprising a processor and memory coupled to the processor, the processor and memory configured to perform a method of any one of aspects 75 through 82.

Aspect 103: A non-transitory computer-readable medium storing code for wireless communication, the code comprising instructions executable by a processor to perform a method of any of aspects 75 through 82.

Aspect 104: An apparatus for wireless communications, comprising at least one means for performing a method of any of aspects 83 through 88.

Aspect 105: An apparatus for wireless communication comprising a processor and memory coupled to the processor, the processor and memory configured to perform a method of any one of aspects 83 through 88.

Aspect 106: A non-transitory computer-readable medium storing code for wireless communications, the code comprising instructions executable by a processor to perform a method of any of aspects 83 through 88.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication, comprising:
a processor; and
memory coupled to the processor, the processor and memory configured to:
establish a communication link with a base station via a sidelink between the apparatus and a UE; and
convey, to the base station, a power headroom report for the sidelink between the apparatus and the UE, the power headroom report based at least in part on a power headroom associated with transmissions from the apparatus to the UE using the sidelink between the apparatus and the UE, the power headroom based at least in part on a transmission power capability of the apparatus.

2. The apparatus of claim 1, wherein the processor and memory are further configured to:
establish a direct communication link with the base station, wherein, to convey the power headroom report for the sidelink between the apparatus and the UE, the processor and memory are configured to transmit the power headroom report to the base station using the direct communication link.

3. The apparatus of claim 1, wherein, to convey the power headroom report for the sidelink between the apparatus and the UE, the processor and memory are configured to:
transmit the power headroom report to the UE using the sidelink between the apparatus and the UE.

4. The apparatus of claim 1, wherein the processor and memory are further configured to:
receive a radio resource control (RRC) configuration allocating a field of a medium access control (MAC) control element (CE) to power headroom reporting for the sidelink between the apparatus and the UE;
identify, based at least in part on the RRC configuration, a serving cell identifier associated with the sidelink between the apparatus and the UE; and
convey the power headroom report for the sidelink between the apparatus and the UE in the field of the MAC CE that is associated with the serving cell identifier.

5. The apparatus of claim 1, wherein the processor and memory are further configured to:
receive a radio resource control (RRC) configuration allocating a first field of a medium access control (MAC) control element (CE) to power headroom reporting for the sidelink between the apparatus and the UE and a second field of the MAC CE for identifying the sidelink between the apparatus and the UE; and
convey the power headroom report for the sidelink between the apparatus and the UE in the first field of the MAC CE and an indicator of the sidelink between the apparatus and the UE in the second field of the MAC CE.

6. The apparatus of claim 1, wherein the processor and memory are further configured to:
receive a radio resource control (RRC) configuration allocating a field of a medium access control (MAC) control element (CE) to power headroom reporting for the sidelink between the apparatus and the UE, wherein the MAC CE is dedicated for sidelink power headroom reporting; and
convey the power headroom report for the sidelink between the apparatus and the UE in the allocated field of the MAC CE.

7. The apparatus of claim 1, wherein the processor and memory are further configured to:
determine the power headroom based at least in part on a scheduled transmission to the UE, or a previously transmitted transmission to the UE, or a virtual reference transmission to the UE.

8. The apparatus of claim 1, wherein the processor and memory are further configured to:
determine the power headroom associated with transmissions to the UE over a first transmission beam of the sidelink between the apparatus and the UE;
determine a second power headroom associated with transmissions to the UE over a second transmission beam of the sidelink between the apparatus and the UE; and
convey, to the base station, a second power headroom report for the sidelink between the apparatus and the UE, the second power headroom report based at least in part on the second power headroom.

9. The apparatus of claim 1, wherein the processor and memory are further configured to:
identify a modulation and coding scheme (MCS) associated with the transmissions from the apparatus to the UE using the sidelink between the apparatus and the UE; and
convey, to the base station, an indication of the identified MCS with the power headroom report for the sidelink between the apparatus and the UE.

10. An apparatus for wireless communication, comprising:
a processor; and
memory coupled to the processor, the processor and memory configured to:
establish a communication link with a first user equipment (UE) via a sidelink between a second UE and the first UE;
receive a power headroom report for the sidelink between the second UE and the first UE, the power headroom report associated with transmission from the first UE to the second UE over the sidelink between the second UE and the first UE; and
schedule communications with the first UE based at least in part on receiving the power headroom report for the sidelink between the second UE and the first UE.

11. The apparatus of claim 10, wherein the processor and memory are further configured to:
establish a direct communication link with the first UE, wherein, to receive the power headroom report for the sidelink between the second UE and the first UE, the processor and memory are configured to receive the power headroom report using the direct communication link.

12. The apparatus of claim 10, wherein, to receive the power headroom report for the sidelink between the second UE and the first UE, the processor and memory are configured to:
receive the power headroom report from the second UE.

13. The apparatus of claim 10, wherein the processor and memory are further configured to:
identify, based at least in part on establishing the communication link, a radio resource control (RRC) configuration for configuring a medium access control (MAC) control element (CE) for the power headroom report for the sidelink between the second UE and the first UE;
allocate, based at least in part on identifying the RRC configuration, a field of the MAC CE for power headroom reporting for the sidelink between the second UE and the first UE; and
transmit an indication of the allocated field of the MAC CE based at least in part on allocating the field of the MAC CE,
wherein, to receive the power headroom report, the processor and memory are configured to receive the power headroom report for the sidelink between the second UE and the first UE based at least in part on transmitting the indication of the allocated field of the MAC CE.

14. The apparatus of claim 10, wherein the processor and memory are further configured to:
identify a threshold power headroom value for scheduling transmissions from the first UE to the second UE over the sidelink between the second UE and the first UE; and
determine to schedule communications over the sidelink between the second UE and the first UE, or a direct communication link with the first UE, based at least in part on comparing the power headroom report to the threshold power headroom value.

15. The apparatus of claim 10, wherein the power headroom report is associated with transmission over a first transmission beam of the sidelink between the second UE and the first UE, and wherein the processor and memory are further configured to:
receive a second power headroom report associated with transmission over a second transmission beam of the sidelink between the second UE and the first UE, wherein the processor and memory are configured to schedule the communications with the first UE is based at least in part on receiving the power headroom report and the second power headroom report.

16. The apparatus of claim 10, wherein the processor and memory are further configured to:
receive an indication of an MCS associated with the transmission from the first UE to the second UE over the sidelink between the second UE and the first UE, wherein the processor and memory are configured to schedule communications with the first UE is based at least in part on receiving the indication of the MCS.

17. An apparatus for wireless communication, comprising:
a processor,
memory coupled to the processor, the processor and memory configured to:
establish a communication link for communications between a base station and a UE via the apparatus, the communication link comprising a sidelink between the apparatus and the UE; and
transmit, to the base station, a power headroom report for the sidelink between the apparatus and the UE, the power headroom report based at least in part on a power headroom associated with transmissions from the apparatus to the UE using the sidelink between the apparatus and the UE, the power headroom based at least in part on a transmission power capability of the apparatus.

18. The apparatus of claim 17, wherein the processor and memory are configured to:
receive a radio resource control (RRC) configuration allocating a field of a medium access control (MAC) control element (CE) to power headroom reporting for the sidelink between the apparatus and the UE;
identify, based at least in part on the RRC configuration, a serving cell identifier associated with the sidelink between the apparatus and the UE; and
transmit the power headroom report for the sidelink between the apparatus and the UE in the field of the MAC CE that is associated with the serving cell identifier.

19. The apparatus of claim 17, wherein the processor and memory are configured to:
receive a radio resource control (RRC) configuration allocating a first field of a medium access control (MAC) control element (CE) to power headroom reporting for the sidelink between the apparatus and the UE and a second field of the MAC CE for identifying the sidelink between the apparatus and the UE; and
transmit the power headroom report for the sidelink between the apparatus and the UE in the first field of the MAC CE and an indicator of the sidelink between the apparatus and the UE in the second field of the MAC CE.

20. The apparatus of claim 17, wherein the processor and memory are configured to:
receive a radio resource control (RRC) configuration allocating a field of a medium access control (MAC) control element (CE) to power headroom reporting for the sidelink between the apparatus and the UE;
transmit the power headroom report for the sidelink between the apparatus and the UE in the allocated field of the MAC CE; and
transmit a power headroom report for a direct communication link between the first UE and the base station in the MAC CE.

21. The apparatus of claim 17, wherein, to transmit the power headroom report for the sidelink between the apparatus and the UE, the processor and memory are configured to:
transmit the power headroom report in a medium access control (MAC) control element (CE) that is dedicated for sidelink power headroom reporting.

22. The apparatus of claim 17, wherein the processor and memory are configured to determine the power headroom based at least in part on a scheduled downlink transmission to the UE, or a previously transmitted downlink transmission to the UE, or a virtual reference downlink transmission to the UE.

23. The apparatus of claim 17, wherein the processor and memory are configured to:
determine the power headroom associated with transmissions over a first transmission beam of the sidelink between the apparatus and the UE;
determine a second power headroom associated with transmissions from the apparatus to the UE over a second transmission beam of the sidelink between the apparatus and the UE; and
transmit, to the base station, a second power headroom report for the sidelink between the apparatus and the UE, the second power headroom report based at least in part on the second power headroom.

24. The apparatus of claim 17, wherein the processor and memory are further configured to:
identify a modulation and coding scheme (MCS) associated with the transmissions from the apparatus to the UE using the sidelink between the apparatus and the UE; and
transmit, to the base station, an indication of the identified MCS with the power headroom report for the sidelink between the apparatus and the UE.

25. An apparatus for wireless communication, comprising:
a processor; and
memory coupled to the processor, the processor and memory configured to:
establish a communication link with a first user equipment (UE) via a sidelink between a second UE and the first UE;
receive, from the second UE, a power headroom report for the sidelink between the second UE and the first UE, the power headroom report associated with transmission from the second UE to the first UE over the sidelink between the second UE and the first UE; and
schedule communications with the first UE based at least in part on receiving the power headroom report for the sidelink between the second UE and the first UE.

26. The apparatus of claim 25, wherein the processor and memory are further configured to:
identify, based at least in part on establishing the communication link, a radio resource control (RRC) configuration for configuring a medium access control (MAC) control element (CE) for the power headroom report for the sidelink between the second UE and the first UE;
allocate, based at least in part on identifying the RRC configuration, a first field of the MAC CE for power headroom reporting for the sidelink between the second UE and the first UE, and a second field for identifying the sidelink between the second UE and the first UE; and
transmit an indication of the first field of the MAC CE and the second field of the MAC CE based at least in part on the allocating;
wherein, to receive the power headroom report, the processor and memory are configured to receive the power headroom report based at least in part on transmitting the indication of the first field of the MAC CE and the second field of the MAC CE.

27. The apparatus of claim 25, wherein the processor and memory are further configured to:
identify, based at least in part on establishing the communication link, a radio resource control (RRC) configuration for configuring a medium access control (MAC) control element (CE) for the power headroom report for the sidelink between the second UE and the first UE;
allocate, based at least in part on identifying the RRC configuration, a field of the MAC CE for power headroom reporting for the sidelink between the second UE and the first UE; and
transmit an indication of the allocated field of the MAC CE based at least in part on allocating the field of the MAC CE,
wherein receiving the power headroom report for the sidelink between the second UE and the first UE is based at least in part on transmitting the indication of the allocated field of the MAC CE, and the processor and memory are further configured to receive a power headroom report for a direct communication link with the second UE in the MAC CE based at least in part on transmitting the identified RRC configuration.

28. The apparatus of claim 25, wherein the processor and memory are further configured to:
identify a threshold power headroom value for scheduling transmissions from the second UE to the first UE over the sidelink between the second UE and the first UE; and
determine to schedule communications over the sidelink between the second UE and the first UE, or a direct communication link between the apparatus and the first UE, based at least in part on comparing the power headroom report to the threshold power headroom value.

29. The apparatus of claim 25, wherein the power headroom report is associated with transmission over a first transmission beam of the sidelink between the second UE and the first UE, and wherein the processor and memory are further configured to:
receive a second power headroom report associated with transmission over a second transmission beam of the sidelink between the second UE and the first UE, wherein the processor and memory are configured to schedule the communications with the first UE based at least in part on receiving the power headroom report and the second power headroom report.

30. The apparatus of claim 25, wherein the processor and memory are further configured to:
receive, from the second UE, an indication of an MCS associated with the transmission from the second UE to the first UE over the sidelink between the second UE and the first UE, wherein the processor and memory are configured to schedule communications with the first UE based at least in part on receiving the indication of the MCS.
